(19) United States
(12) Patent Application Publication
(10) Pub. No.: US 2014/0034745 A1
(43) Pub. Date: Feb. 6, 2014

(54) VORTEX SPRAY GENERATION SYSTEMS

(71) Applicants: Geoff BRACE, Columbus, NC (US); John B. FORE, Travelers Rest, SC (US); John K. WEBB, Taylors, SC (US)

(72) Inventors: Geoff BRACE, Columbus, NC (US); John B. FORE, Travelers Rest, SC (US); John K. WEBB, Taylors, SC (US)

(73) Assignee: PRECISION VALVE CORPORATION, Rye Brook, NY (US)

(21) Appl. No.: 13/902,520

(22) Filed: May 24, 2013

Related U.S. Application Data
(60) Provisional application No. 61/652,027, filed on May 25, 2012.
(60) Provisional application No. 61/661,440, filed on Jun. 19, 2012.

(51) Int. Cl. B05B 1/34

(52) U.S. Cl. CPC B05B 1/3426
USPC 239/1; 239/468

(57) ABSTRACT

A vortex spray generating system that comprises a discharge channel and at least one inlet channel. The discharge channel and the at least one inlet channel are disposed with respect to one another such that the at least one inlet channel is capable of providing a tangential feed of fluid into the discharge channel sufficient to generate a vortex and spray pattern. A method of generating a vortex in a pressurized fluid so as to deliver the pressurized fluid as a spray. The method comprises providing a vortex spray generating apparatus comprising a discharge channel and at least one inlet channel, and introducing a tangential feed of fluid through the at least one inlet channel into the discharge channel sufficient to generate a vortex and spray pattern. The at least one inlet channel is disposed such that it is perpendicular to the discharge channel or angled with respect to the discharge channel.

### RELATED APPLICATIONS

This application claims the benefit of provisional U.S. Patent Application Ser. No. 61/652,027, filed May 25, 2012, and provisional U.S. Patent Application Ser. No. 61/661,440, filed Jun. 19, 2012, both of which are incorporated herein by reference in their entirety.

### BACKGROUND OF THE DISCLOSURE

1. Field of the Disclosure

The present disclosure is related to the field of pressurized fluids and dispensing apparatus for pressurized fluids. More particularly, the present disclosure is related to systems that generate a vortex in a pressurized fluid so as to deliver the fluid as a spray.

2. Description of Related Art

Many fluids or liquid products are packaged in containers that include means for dispensing the fluid or liquid product in the form of a spray. Such containers typically dispense the fluid or liquid product, under pressure, through a dispensing valve. For example, the fluid or liquid product may be stored under pressure in a sealed container fitted with a dispensing valve. Alternatively, the fluid or liquid product may be stored in a container fitted with a dispensing valve that includes pump means for urging the fluid or liquid product though the dispensing valve under pressure.

In any case, however, some form of actuator is usually fitted to the container, often as a cap. The actuator includes means for operating the dispensing valve and any associated pump means, and an outlet through which the fluid or product is dispensed as a spray. Conventional actuators generally comprise a conduit leading to an outlet, the conduit being in fluid communication with the dispensing valve. Generally, the user depresses the actuator to actuate the valve and any associated pump means, and hence dispense the fluid or product through the outlet of the actuator in the form of a spray.

It is very often desirable to form a spray comprising a fine mist of liquid droplets. Conventionally, therefore, dispensing apparatus includes means for atomizing the fluid or liquid product into small droplets before it is dispensed as a spray. A preferred method of atomizing the fluid or liquid product is by means of a flow-modifying insert or nozzle that is fitted within the outlet of the actuator during manufacture. In use, the fluid or liquid product flows through the flow-modifying insert or nozzle before exiting the outlet of the actuator as a spray. Typically, flow-modifying inserts or nozzles act to form a vortex within the fluid or liquid product, which causes atomization of the fluid or liquid product and forms a spray comprising a fine mist of liquid droplets. The pattern of the spray is typically provided by the separate insert or nozzle positioned within the actuator button.

However, since the flow-modifying insert or nozzle is generally of relatively complex structure, actuator caps including such flow-modifying inserts or nozzles are conventionally manufactured as two components that are then assembled together on an assembly line. The presence of a flow-modifying insert or nozzle therefore increases the cost of manufacture significantly.

There is a need to reduce capital investment and manufacturing unit cost without sacrificing spray performance. There is also a need to reduce the complexity of the components required to create spray break-up and to reduce the number of components required to create spray break-up.

Further, there is a need to improve the spray performance of water based formulations in tradionally simple non mechanical break-up spray systems without adding components or manufacturing cost, while reducing the propensity for the spray system to clog.

### SUMMARY OF THE DISCLOSURE

Spray actuators are provided that have fluid flow channels that induce vortex flow in the outlet of the spray actuator with a single simple component.

In some embodiments, the fluid flow channels are created between the valve stem and actuator without the need of an additional component.

Both of these embodiments reduce the capital investment required to manufacture the design and also reduce the cost to manufacture. With a more simple flow and larger than conventional flow channels, the various embodiments of the present disclosure reduce the propensity of the flow channels to clog due to, for example, undissolved formulation ingredients or contamination due to poor house keeping practices.

The present disclosure finds use in spray actuators in conjunction with pressurized aerosol cans/valves and/or mist or trigger pumps and/or pressurized sprayers. Alternatively, the present disclosure can be incorporated into an aerosol valve stem which may preclude the need of an actuator to create a spray or significantly reduce the complexity and therefor the investment and manufacturing costs of the associated actuator.

The above-described and other features and advantages of the present disclosure will be appreciated and understood by those skilled in the art from the following detailed description, drawings, and appended claims.

### BRIEF DESCRIPTION OF THE DRAWINGS

FIG. 1 illustrates an exemplary embodiment of a vortex generating stem according to the present disclosure having a discharge channel that is perpendicular to an inlet channel, where the inlet channel provides tangential feed to generate a vortex and a spray pattern.

FIG. 2 illustrates an exemplary embodiment of a stem having a tangential feed hole.

FIG. 3 illustrates a spray pattern of the stem of FIG. 2.

FIG. 4 illustrates a spray pattern of the stem (with extended discharge channel) of FIG. 2. The extended discharge channel extracts rotational energy from the spray stream and narrows the spray cone angle.

FIG. 5 illustrates a spray pattern of the stem of FIG. 4 with a tapered insert to reduce the discharge outlet diameter. The effect is an increase in velocity which widens the spray cone angle to nearly that of the shorter discharge channel.

FIG. 6 illustrates a spray pattern of the stem (with a curved discharge channel) of FIG. 2.

FIGS. 7A and 7B illustrate spray patterns of the stem (with curved discharge channels) of FIG. 2.

FIG. 8 illustrates another exemplary embodiment of a vortex generating system according to the present disclosure.

FIGS. 9A, 9B, 9C, 9D and 9E illustrate another exemplary embodiment of a vortex generating system according to the present disclosure illustrated in a dome cap. FIGS. 9A, 9B, 9C, 9D and 9E illustrate side, front and top views of a fan vortex geometry in a dome cap.

FIGS. 10A and 10B illustrate another exemplary embodiment of a vortex generating system according to the present disclosure illustrated in a dome cap. FIG. 10A is an isometric view of the internal volume of a fan vortex geometry with four inlets/outlets and ramps. FIG. 10B is a perspective side view of FIG. 10A in a dome cap.

FIGS. 11A and 11B illustrate another exemplary embodiment of a vortex generating system according to the present disclosure illustrated in a dome cap. FIG. 11A is a front view of the internal volume of a fan vortex geometry showing the four outlets, ramps and center post. The gaps between the four fan blades is created by overlapping the steel from the two halves of the mold, above and below the molding split line. FIG. 11B is a perspective top view of FIG. 11A in a dome cap.

FIGS. 12A and 12B illustrate another exemplary embodiment of a vortex generating system according to the present disclosure illustrated in a dome cap. FIG. 12A is a bottom view of the internal volume of a fan vortex geometry showing the four inlets, ramps and center post. FIG. 12B is a perspective top view of FIG. 12A in a dome cap.

FIGS. 13A and 13B illustrate another exemplary embodiment of a vortex generating system according to the present disclosure illustrated in a dome cap. FIG. 13A is a side view of the internal volume of a fan vortex geometry showing the inlet, ramp and center post. FIG. 13B is a perspective side view of FIG. 13A in a dome cap.

FIGS. 14A and 14B illustrate another exemplary embodiment of a vortex generating system according to the present disclosure illustrated in a dome cap. FIG. 14A is a highlighted model view of the fan vortex geometry showing the front view with the four outlets, ramps and center post. FIG. 14B is a perspective front view of FIG. 14A in a dome cap.

FIGS. 15A and 15B illustrate another exemplary embodiment of a vortex generating system according to the present disclosure illustrated in a dome cap. FIG. 15A is a side view showing the internal volume of the fan vortex in a Computational Fluid Dynamics (CFD) study. FIG. 15 shows how fluid is directed. FIG. 15B is a perspective side view of FIG. 15A in a dome cap.

FIGS. 16A and 16B illustrate another exemplary embodiment of a vortex generating system according to the present disclosure illustrated in a dome cap. FIG. 16A is a transparent side view showing the flow of fluid of the fan vortex in a CFD study. FIG. 16B is a perspective side view of FIG. 16A in a dome cap.

FIGS. 17A and 17B illustrate another exemplary embodiment of a vortex generating system according to the present disclosure illustrated in a dome cap. FIG. 17A is a wire frame side view showing the flow of fluid of the fan vortex in a CFD study. FIG. 17B is a perspective side view of FIG. 17A in a dome cap.

FIGS. 18A, 18B, 18C, 18D and 18E illustrate another exemplary embodiment of a dual vortex generating system according to the present disclosure illustrated in a dome cap. FIGS. 18A, 18B, 18C, 18D and 18E illustrate side, front and top views of a duel vortex geometry in a dome cap.

FIGS. 19A and 19B illustrate another exemplary embodiment of a dual vortex generating system according to the present disclosure illustrated in a dome cap. FIG. 19A is an isometric view of the internal volume of dual ramps vortex geometry with two inlets/outlets and ramps. This is similar to the vortex generating system described herein except with two blades and more clearly shows the helix angle of the blade to direct fluid flow. FIG. 19B is a perspective front view of FIG. 19A in a dome cap.

FIGS. 20A and 20B illustrate another exemplary embodiment of a dual vortex generating system according to the present disclosure illustrated in a dome cap. FIG. 20A is a front view of the internal volume of a dual ramps vortex geometry showing the two outlets, ramps and center post. FIG. 20B is a perspective front view of FIG. 20A in a dome cap.

FIGS. 21A and 21B illustrate another exemplary embodiment of a dual vortex generating system according to the present disclosure illustrated in a dome cap. FIG. 21A is a bottom view of the internal volume of a dual ramps vortex geometry showing the two inlets, ramps and center post. FIG. 21B is a perspective top view of FIG. 21A in a dome cap.

FIGS. 22A and 22B illustrate another exemplary embodiment of a dual vortex generating system according to the present disclosure illustrated in a dome cap. FIG. 22A is a side view of the internal volume of a dual ramps vortex geometry showing the inlet, ramp and center post. FIG. 22B is a perspective front view of FIG. 22A in a dome cap.

FIGS. 23A and 23B illustrate another exemplary embodiment of a dual vortex generating system according to the present disclosure illustrated in a dome cap. FIG. 23A is a highlighted model view of the dual ramps vortex geometry showing the front view with two outlets, ramps and center post. FIG. 23B is a perspective top view of FIG. 23A in a dome cap.

FIGS. 24A and 24B illustrate another exemplary embodiment of a dual vortex generating system according to the present disclosure illustrated in a dome cap. FIG. 24A is a side view showing the internal volume of the dual ramps vortex in a CFD study. FIG. 24B is a perspective side view of FIG. 24A in a dome cap.

FIGS. 25A and 25B illustrate another exemplary embodiment of a dual vortex generating system according to the present disclosure illustrated in a dome cap. FIG. 25A is a transparent side view showing the flow of fluid of the dual ramps vortex in a CFD study. FIG. 25B is a perspective side view of FIG. 25A in a dome cap.

FIGS. 26A and 26B illustrate another exemplary embodiment of a dual vortex generating system according to the present disclosure illustrated in a dome cap. FIG. 26A is a wire frame side view showing the flow of fluid of the dual ramps vortex in a CFD study. FIG. 26B is a perspective side view of FIG. 26A in a dome cap.

FIGS. 27A, 27B, 27C, 27D and 27E illustrate an alternate exemplary embodiment of a vortex generating system according to the present disclosure. FIGS. 27A, 27B, 27C, 27D and 27E show perspective and cross section views of offset vortex geometry in a stem example.

FIGS. 28A and 28B illustrate another alternate exemplary embodiment of a vortex generating system according to the present disclosure. FIG. 28A is an isometric view of the internal volume of S90 stem vortex geometry with two inlets. The geometry below the side holes is influential in fluid rotational behavior. FIG. 28B is a perspective front view of FIG. 28A in a stem example.

FIGS. 29A and 29B illustrate another alternate exemplary embodiment of a vortex generating system according to the present disclosure. FIG. 29A is a side view of the internal volume of S90 stem vortex geometry with two inlets at offset opposing locations. FIG. 29B is a perspective front view of FIG. 29A in a stem example.

FIGS. 30A and 30B illustrate another alternate exemplary embodiment of a vortex generating system according to the present disclosure. FIG. 30A is a bottom view of the internal volume of S90 stem vortex geometry showing the two inlets at offset opposing locations. FIG. 30B is a perspective bottom view of FIG. 30A in a stem example.

FIGS. 31A and 31B illustrate another alternate exemplary embodiment of a vortex generating system according to the present disclosure. FIG. 31A is an isometric view of the internal volume of S90 stem vortex in a CFD study with an attached housing. FIG. 31B is a perspective front view of FIG. 31A in a stem example.

FIGS. 32A and 32B illustrate another alternate exemplary embodiment of a vortex generating system according to the present disclosure. FIG. 32A is a transparent view of the flow of fluid of the S90 stem vortex in a CFD study. FIG. 32B is a perspective front view of FIG. 32A in a stem example.

FIGS. 33A and 33B illustrate another alternate exemplary embodiment of a vortex generating system according to the present disclosure. FIG. 33A is a wire frame view of the flow of fluid of the S90 stem vortex in a CFD study. FIG. 33B is a perspective front view of FIG. 33A in a stem example.

FIGS. 34A, 34B, 34C, 34D and 34E illustrate another alternate exemplary embodiment of a vortex generating system according to the present disclosure. FIGS. 34A, 34B, 34C, 34D and 34E show perspective front, side and bottom views of horizontal or slightly angled vortex geometry in a button example.

FIGS. 35A and 35B illustrate another alternate exemplary embodiment of a vortex generating system according to the present disclosure. FIG. 35A is an isometric view of the internal volume of horizontal or slightly angled button vortex geometry. FIG. 35B is a perspective front view of FIG. 35A in a button example.

FIGS. 36A and 36B illustrate another alternate exemplary embodiment of a vortex generating system according to the present disclosure. FIG. 36A is a side view of the internal volume of horizontal or slightly angled button vortex geometry. FIG. 36B is a perspective side view of FIG. 36A in a button example.

FIGS. 37A and 37B illustrate another alternate exemplary embodiment of a vortex generating system according to the present disclosure. FIG. 37A is a bottom view of the internal volume of horizontal or slightly angled button vortex geometry. FIG. 37B is a perspective bottom view of FIG. 37A in a button example.

FIGS. 38A and 38B illustrate another alternate exemplary embodiment of a vortex generating system according to the present disclosure. FIG. 38A is an isometric view showing the internal volume of the horizontal vortex in a button in a CFD study. FIG. 38B is a perspective front view of FIG. 38A in a button example.

FIGS. 39A and 39B illustrate another alternate exemplary embodiment of a vortex generating system according to the present disclosure. FIG. 39A is a transparent isometric view showing the flow of fluid of the horizontal vortex in a button in a CFD study. FIG. 39B is a perspective front view of FIG. 39A in a button example.

FIGS. 40A and 40B illustrate another alternate exemplary embodiment of a vortex generating system according to the present disclosure. FIG. 40A is a wire frame isometric view showing the flow of fluid of the horizontal vortex in a button in a CFD study. FIG. 40B is a perspective front view of FIG. 40A in a button example.

FIGS. 41A, 41B, 41C, 41D and 41E illustrate another alternate exemplary embodiment of a vortex generating system according to the present disclosure. FIGS. 41A, 41B, 41C, 41D and 41E show perspective front, side and bottom views of a horizontal long tube vortex in an actuator example.

FIGS. 42A and 42B illustrate another alternate exemplary embodiment of a vortex generating system according to the present disclosure. FIG. 42A is an isometric view of the internal volume of a horizontal long tube vortex in an actuator example. FIG. 42B is a perspective front view of FIG. 42A in an actuator example.

FIGS. 43A and 43B illustrate another alternate exemplary embodiment of a vortex generating system according to the present disclosure. FIG. 43A is a side view of the internal volume of a horizontal long tube vortex in an actuator example. FIG. 43B is a perspective side view of FIG. 43A in an actuator example.

FIGS. 44A and 44B illustrate another alternate exemplary embodiment of a vortex generating system according to the present disclosure. FIG. 44A is a bottom view of the internal volume of a horizontal long tube vortex in an actuator example. FIG. 44B is a perspective bottom view of FIG. 44A in an actuator example.

FIGS. 45A and 45B illustrate another alternate exemplary embodiment of a vortex generating system according to the present disclosure. FIG. 45A is an isometric view of the internal volume of a horizontal long tube vortex in an actuator example in a CFD study. FIG. 45B is a perspective side view of FIG. 45A in an actuator example.

FIGS. 46A and 46B illustrate another alternate exemplary embodiment of a vortex generating system according to the present disclosure. FIG. 46A is a transparent isometric view of the flow of fluid of a horizontal long tube vortex in an actuator example in a CFD study. FIG. 46B is a perspective side view of FIG. 46A in an actuator example.

FIGS. 47A and 47B illustrate another alternate exemplary embodiment of a vortex generating system according to the present disclosure. FIG. 47A is a wire frame isometric view of the flow of fluid of a horizontal long tube vortex in an actuator example in a CFD study. FIG. 47B is a perspective side view of FIG. 47A in an actuator example.

FIGS. 48A, 48B, 48C, 48D and 48E illustrate another alternate exemplary embodiment of a vortex generating system according to the present disclosure. FIGS. 48A, 48B, 48C, 48D and 48E show perspective front, side and bottom views of an offset vortex geometry in a 5x test fixture.

FIGS. 49A and 49B illustrate another alternate exemplary embodiment of a vortex generating system according to the present disclosure. FIG. 49A is an isometric view of the internal volume of offset vortex geometry in a 5x test fixture. FIG. 49B is a perspective side view of FIG. 49A in a 5x test fixture.

FIGS. 50A and 50B illustrate another alternate exemplary embodiment of a vortex generating system according to the present disclosure. FIG. 50A is a side view of the internal volume of offset vortex geometry in a 5x test fixture. FIG. 50B is a perspective side view of FIG. 50A in a 5x test fixture.

FIGS. 51A and 51B illustrate another alternate exemplary embodiment of a vortex generating system according to the present disclosure. FIG. 51A is a bottom view of the internal volume of offset vortex geometry in a 5x test fixture. FIG. 51B is a perspective bottom view of FIG. 501 in a 5x test fixture.

FIGS. 52A and 52B illustrate another alternate exemplary embodiment of a vortex generating system according to the present disclosure. FIG. 52A is an isometric view showing the internal volume of offset vortex geometry in a 5x test fixture in a CFD study. FIG. 52B is a perspective view of FIG. 52A in a 5x test fixture.

FIGS. 53A and 53B illustrate another alternate exemplary embodiment of a vortex generating system according to the present disclosure. FIG. 53A is a transparent view showing the flow of fluid of offset vortex geometry in a 5x test fixture in a CFD study. FIG. 53B is a perspective view of FIG. 53A in a 5x test fixture.

FIGS. 54A and 54B illustrate another alternate exemplary embodiment of a vortex generating system according to the present disclosure. FIG. 54A is a wire frame view showing the flow of fluid of offset vortex geometry in a 5x test fixture in a CFD study. FIG. 54B is a perspective view of FIG. 54A in a 5x test fixture.

FIGS. 55A, 55B, 55C, 55D and 55E illustrate a system that fails to generate a vortex in the manner disclosed according to the present disclosure. FIGS. 55A, 55B, 55C, 55D and 55E show perspective top, bottom, side and cross section views of a test fixture with a center pin and inlet hole on the center line. Non-induced tangential flow does not create a spray pattern.

FIGS. 56A and 56B illustrate a system that fails to generate a vortex in the manner disclosed according to the present disclosure. FIG. 56A shows an isometric view of the internal volume of a test fixture with a center pin and inlet hole on the center line. FIG. 56B is a perspective front view of FIG. 56A in a test fixture with a center pin and inlet hole on the center line.

FIGS. 57A and 57B illustrate a system that fails to generate a vortex in the manner disclosed according to the present disclosure. FIG. 57A shows a side view of the internal volume of a test fixture with a center pin and inlet hole on the center line. FIG. 57B is a perspective side view of FIG. 57A in a test fixture with a center pin and inlet hole on the center line.

FIGS. 58A and 58B illustrate a system that fails to generate a vortex in the manner disclosed according to the present disclosure. FIG. 58A shows a top view of the internal volume of a test fixture with a center pin and inlet hole on the center line. FIG. 58B is a perspective top view of FIG. 58A in a test fixture with a center pin and inlet hole on the center line.

FIGS. 59A and 59B illustrate a system that fails to generate a vortex in the manner disclosed according to the present disclosure. FIG. 59A shows the internal volume of a test fixture with a center pin and inlet hole on the center line in a CFD study. FIG. 59B is a perspective view of FIG. 59A in a test fixture with a center pin and inlet hole on the center line.

FIGS. 60A and 60B illustrate a system that fails to generate a vortex in the manner disclosed according to the present disclosure. FIG. 60A is a transparent isometric view showing the flow of fluid of a test fixture in a CFD study. FIG. 60B is a perspective view of FIG. 60A in a test fixture with a center pin and inlet hole on the center line.

FIGS. 61A and 61B illustrate a system that fails to generate a vortex in the manner disclosed according to the present disclosure. FIG. 61A is a wire frame isometric view showing the flow of fluid of a test fixture in a CFD study. FIG. 61B is a perspective view of FIG. 61A in a test fixture with a center pin and inlet hole on the center line.

FIGS. 62A, 62B, 62C, 62D and 62E illustrate another alternate exemplary embodiment of a vortex generating system according to the present disclosure. FIGS. 62A, 62B, 62C, 62D and 62E show perspective side, top, bottom and cross section views of a test fixture with no center pin and inlet hole offset from the center line.

FIGS. 63A and 63B illustrate another alternate exemplary embodiment of a vortex generating system according to the present disclosure. FIG. 63A shows an isometric view of the internal volume of a test fixture with no center pin and inlet hole offset from the center line. FIG. 63B is a perspective view of FIG. 63A in a test fixture with no center pin and inlet hole offset from the center line.

FIGS. 64A and 64B illustrate another alternate exemplary embodiment of a vortex generating system according to the present disclosure. FIG. 64A shows a side view of the internal volume of a test fixture with no center pin and inlet hole offset from the center line. FIG. 64B is a perspective side view of FIG. 64A in a test fixture with no center pin and inlet hole offset from the center line.

FIGS. 65A and 65B illustrate another alternate exemplary embodiment of a vortex generating system according to the present disclosure. FIG. 65A shows a top view of the internal volume of a test fixture with no center pin and inlet hole offset from the center line. FIG. 65B is a perspective top view of FIG. 65A in a test fixture with no center pin and inlet hole offset from the center line.

FIGS. 66A and 66B illustrate another alternate exemplary embodiment of a vortex generating system according to the present disclosure. FIG. 66A shows the internal volume of a test fixture with no center pin and inlet hole offset from the center line in a CFD study. FIG. 66B is a perspective view of FIG. 66A in a test fixture with no center pin and inlet hole offset from the center line.

FIGS. 67A and 67B illustrate another alternate exemplary embodiment of a vortex generating system according to the present disclosure. FIG. 67A shows a transparent isometric view of the flow of fluid of a test fixture in a CFD study. FIG. 67B is a perspective view of FIG. 67A in a test fixture with no center pin and inlet hole offset from the center line.

FIGS. 68A and 68B illustrate another alternate exemplary embodiment of a vortex generating system according to the present disclosure. FIG. 68A shows a wire frame isometric view of the flow of fluid of a test fixture in a CFD study. FIG. 68B is a perspective view of FIG. 68A in a test fixture with no center pin and inlet hole offset from the center line.

FIGS. 69A, 69B, 69C, 69D and 69E illustrate another alternate exemplary embodiment of a vortex generating system according to the present disclosure. FIGS. 69A, 69B, 69C, 69D and 69E are side, bottom, top and cross section views of a vertical test fixture with two inlets/outlets and ramps.

FIGS. 70A and 70B illustrate another alternate exemplary embodiment of a vortex generating system according to the present disclosure. FIG. 70A is an isometric view of a vertical test fixture with two inlets/outlets and ramps. FIG. 70B is a perspective view of FIG. 70A in a vertical test fixture with two inlets/outlets and ramps.

FIGS. 71A and 71B illustrate another alternate exemplary embodiment of a vortex generating system according to the present disclosure. FIG. 71A is a side view of a vertical test fixture with two inlets/outlets and ramps. FIG. 71B is a perspective view of FIG. 71A in a vertical test fixture with two inlets/outlets and ramps.

FIGS. 72A and 72B illustrate another alternate exemplary embodiment of a vortex generating system according to the present disclosure. FIG. 72A is a bottom view of a vertical test fixture with two inlets/outlets and ramps. FIG. 72B is a perspective bottom view of FIG. 72A in a vertical test fixture with two inlets/outlets and ramps.

FIGS. 73A and 73B illustrate another alternate exemplary embodiment of a vortex generating system according to the present disclosure. FIG. 73A shows the internal volume of a vertical test fixture with two inlets/outlets and ramps in a CFD study. FIG. 73B is a perspective view of FIG. 73A in a vertical test fixture with two inlets/outlets and ramps.

FIGS. 74A and 74B illustrate another alternate exemplary embodiment of a vortex generating system according to the present disclosure. FIG. 74A is a transparent isometric view showing the flow of fluid of a vertical test fixture with two inlets/outlets and ramps in a CFD study. FIG. 74B is a perspective view of FIG. 74A in a vertical test fixture with two inlets/outlets and ramps.

FIGS. 75A and 75B illustrate another alternate exemplary embodiment of a vortex generating system according to the present disclosure. FIG. 75A is a wire frame isometric view showing the flow of fluid of a vertical test fixture with two inlets/outlets and ramps in a CFD study. FIG. 75B is a perspective view of FIG. 75A in a vertical test fixture with two inlets/outlets and ramps.

FIGS. 76A, 76B, 76C, 76D and 76E illustrate another alternate exemplary embodiment of a vortex generating system according to the present disclosure. FIGS. 76A, 76B, 76C, 76D and 76E are side, top, bottom and cross section views of a vertical test fixture with one inlet/outlet and ramp.

FIGS. 77A and 77B illustrate another alternate exemplary embodiment of a vortex generating system according to the present disclosure. FIG. 77A is an isometric view of the internal volume of a vertical test fixture with one inlet/outlet and ramp. FIG. 77B is a perspective view of FIG. 77A in a vertical test fixture with one inlet/outlet and ramp.

FIGS. 78A and 78B illustrate another alternate exemplary embodiment of a vortex generating system according to the present disclosure. FIG. 78A is a side view of the internal volume of a vertical test fixture with one inlet/outlet and ramp. FIG. 78B is a perspective view of FIG. 78A in a vertical test fixture with one inlet/outlet and ramp.

FIGS. 79A and 79B illustrate another alternate exemplary embodiment of a vortex generating system according to the present disclosure. FIG. 79A is a bottom view of the internal volume of a vertical test fixture with one inlet/outlet and ramp. FIG. 79B is a perspective bottom view of FIG. 79A in a vertical test fixture with one inlet/outlet and ramp.

FIGS. 80A and 80B illustrate another alternate exemplary embodiment of a vortex generating system according to the present disclosure. FIG. 80A illustrates internal volume of a vertical test fixture with one inlet/outlet and ramp in a CFD study. FIG. 80B is a perspective view of FIG. 80A in a vertical test fixture with one inlet/outlet and ramp.

FIGS. 81A and 81B illustrate another alternate exemplary embodiment of a vortex generating system according to the present disclosure. FIG. 81A is a transparent isometric view showing the flow of fluid of a vertical test fixture with one inlet/outlet and ramp in a CFD study. FIG. 81B is a perspective view of FIG. 81A in a vertical test fixture with one inlet/outlet and ramp.

FIGS. 82A and 82B illustrate another alternate exemplary embodiment of a vortex generating system according to the present disclosure. FIG. 82A is a wire frame isometric view showing the flow of fluid of a vertical test fixture with one inlet/outlet and ramp in a CFD study. FIG. 82B is a perspective view of FIG. 82A in a vertical test fixture with one inlet/outlet and ramp.

FIG. 83 illustrates still another alternate exemplary embodiment of a vortex generating system according to the present disclosure. The system of FIG. 83 is referred to as a deep vortex Tango II-Rev B.

FIG. 84 illustrates still another alternate exemplary embodiment of a vortex generating system according to the present disclosure. FIG. 84 graphically shows mass flow using water in the deep vortex Tango II-Rev B.

FIG. 85 illustrates still another alternate exemplary embodiment of a vortex generating system according to the present disclosure.

FIG. 86 illustrates still another alternate exemplary embodiment of a vortex generating system according to the present disclosure.

FIG. 87 illustrates still another alternate exemplary embodiment of a vortex generating system according to the present disclosure.

FIG. 88 illustrates a further exemplary embodiment of a vortex generating system according to the present disclosure. The system of FIG. 88 is referred to as a dual ramps Tango II.

FIG. 89 illustrates a further exemplary embodiment of a vortex generating system according to the present disclosure.

FIG. 90 illustrates a further exemplary embodiment of a vortex generating system according to the present disclosure.

FIG. 91 illustrates a further exemplary embodiment of a vortex generating system according to the present disclosure. FIG. 91 graphically shows mass flow using water in the dual ramps Tango II.

FIG. 92 illustrates a further exemplary embodiment of a vortex generating system according to the present disclosure.

FIG. 93 illustrates a further exemplary embodiment of a vortex generating system according to the present disclosure.

FIG. 94 illustrates a further exemplary embodiment of a vortex generating system according to the present disclosure.

FIG. 95 illustrates a still further exemplary embodiment of a vortex generating system according to the present disclosure. The system of FIG. 95 is referred to as a fan Tango II.

FIG. 96 illustrates a still further exemplary embodiment of a vortex generating system according to the present disclosure.

FIG. 97 illustrates a still further exemplary embodiment of a vortex generating system according to the present disclosure.

FIG. 98 illustrates a still further exemplary embodiment of a vortex generating system according to the present disclosure. FIG. 98 graphically shows mass flow using water in the fan Tango II.

FIG. 99 illustrates a still further exemplary embodiment of a vortex generating system according to the present disclosure.

FIG. 100 illustrates a still further exemplary embodiment of a vortex generating system according to the present disclosure.

FIG. 101 illustrates a still further exemplary embodiment of a vortex generating system according to the present disclosure.

FIG. 102 illustrates another further exemplary embodiment of a vortex generating system according to the present disclosure. The system of FIG. 102 is referred to as a shallow vortex Tango II-Rev B.

FIG. 103 illustrates another further exemplary embodiment of a vortex generating system according to the present disclosure. FIG. 103 graphically shows mass flow using water in the shallow vortex Tango II-Rev B.

FIG. 104 illustrates another further exemplary embodiment of a vortex generating system according to the present disclosure.

FIG. 105 illustrates another further exemplary embodiment of a vortex generating system according to the present disclosure.

FIG. 106 illustrates another further exemplary embodiment of a vortex generating system according to the present disclosure.

FIG. 107 illustrates still another further exemplary embodiment of a vortex generating system according to the present disclosure. The system of FIG. 107 is referred to as Tango II.

FIG. 108 illustrates still another further exemplary embodiment of a vortex generating system according to the present disclosure. FIG. 108 graphically shows mass flow using water in the Tango II.

FIG. 109 illustrates still another further exemplary embodiment of a vortex generating system according to the present disclosure.

FIG. 110 illustrates still another further exemplary embodiment of a vortex generating system according to the present disclosure.

FIG. 111 illustrates still another further exemplary embodiment of a vortex generating system according to the present disclosure.

FIG. 112 illustrates an exemplary embodiment of a vortex generating system according to the present disclosure. FIG. 112 illustrates the internal volume of a 2-hole horizontal with sump feature and an internal guide post in a CFD study.

FIG. 113 illustrates an exemplary embodiment of a vortex generating system according to the present disclosure. FIG. 113 illustrates a transparent isometric view of the 2-hole horizontal with sump feature and internal guide post of FIG. 112 in a CFD study.

FIG. 114 illustrates an exemplary embodiment of a vortex generating system according to the present disclosure. FIG. 114 illustrates a wire frame side view showing the flow of fluid of the 2-hole horizontal with sump feature and internal guide post of FIG. 112 in a CFD study.

FIG. 115 illustrates an exemplary embodiment of a vortex generating system according to the present disclosure. FIG. 115 illustrates a wire frame top view showing the flow of fluid of the 2-hole horizontal with sump feature and internal guide post of FIG. 112 in a CFD study.

FIG. 116 illustrates an exemplary embodiment of a vortex generating system according to the present disclosure. FIG. 116 illustrates a wire frame front view showing the flow of fluid of the 2-hole horizontal with sump feature and internal guide post of FIG. 112 in a CFD study.

FIG. 117 illustrates an alternate exemplary embodiment of a vortex generating system according to the present disclosure. FIG. 117 illustrates the internal volume of the 2-hole horizontal with sump feature and no internal guide post in a CFD study.

FIG. 118 illustrates an alternate exemplary embodiment of a vortex generating system according to the present disclosure. FIG. 118 illustrates a transparent isometric view of the 2-hole horizontal with sump feature and no internal guide post of FIG. 117 in a CFD study.

FIG. 119 illustrates an alternate exemplary embodiment of a vortex generating system according to the present disclosure. FIG. 119 illustrates a wire frame side view showing the flow of fluid of the 2-hole horizontal with sump feature and no internal guide post of FIG. 117 in a CFD study.

FIG. 120 illustrates an alternate exemplary embodiment of a vortex generating system according to the present disclosure. FIG. 120 illustrates a wire frame top view showing the flow of fluid of the 2-hole horizontal with sump feature and no internal guide post of FIG. 117 in a CFD study.

FIG. 121 illustrates an alternate exemplary embodiment of a vortex generating system according to the present disclosure. FIG. 121 illustrates a wire frame front view showing the flow of fluid of the 2-hole horizontal with sump feature and no internal guide post of FIG. 117 in a CFD study.

FIG. 122 illustrates another alternate exemplary embodiment of a vortex generating system according to the present disclosure. FIG. 122 illustrates the internal volume of a 3-hole horizontal with sump feature with an internal guide post in a CFD study.

FIG. 123 illustrates another alternate exemplary embodiment of a vortex generating system according to the present disclosure. FIG. 123 illustrates a transparent isometric view of the 3-hole horizontal with sump feature and internal guide post of FIG. 122 in a CFD study.

FIG. 124 illustrates another alternate exemplary embodiment of a vortex generating system according to the present disclosure. FIG. 124 illustrates a wire frame side view showing the flow of fluid of the 3-hole horizontal with sump feature and internal guide post of FIG. 122 in a CFD study.

FIG. 125 illustrates another alternate exemplary embodiment of a vortex generating system according to the present disclosure. FIG. 125 illustrates a wire frame top view showing the flow of fluid of the 3-hole horizontal with sump feature and internal guide post of FIG. 122 in a CFD study.

FIG. 126 illustrates another alternate exemplary embodiment of a vortex generating system according to the present disclosure. FIG. 126 illustrates a wire frame back view showing the flow of fluid of the 3-hole horizontal with sump feature and internal guide post of FIG. 122 in a CFD study.

FIG. 127 illustrates another alternate exemplary embodiment of a vortex generating system according to the present disclosure. FIG. 127 illustrates the internal volume of a 3-hole horizontal with sump feature and no internal guide post in a CFD study.

FIG. 128 illustrates another alternate exemplary embodiment of a vortex generating system according to the present disclosure. FIG. 128 illustrates a transparent isometric view of the 3-hole horizontal with sump feature and no internal guide post of FIG. 127 in a CFD study.

FIG. 129 illustrates another alternate exemplary embodiment of a vortex generating system according to the present disclosure. FIG. 129 illustrates a wire frame side view showing the flow of fluid of the 3-hole horizontal with sump feature and no internal guide post of FIG. 127 in a CFD study.

FIG. 130 illustrates another alternate exemplary embodiment of a vortex generating system according to the present disclosure. FIG. 130 illustrates a wire frame top view showing the flow of fluid of the 3-hole horizontal with sump feature and no internal guide post of FIG. 127 in a CFD study.

FIG. 131 illustrates another alternate exemplary embodiment of a vortex generating system according to the present disclosure. FIG. 131 illustrates a wire frame back view showing the flow of fluid of the 3-hole horizontal with sump feature and no internal guide post of FIG. 127 in a CFD study.

FIG. 132 illustrates another alternate exemplary embodiment of a vortex generating system according to the present disclosure. FIG. 132 illustrates the internal volume of an oval horizontal with sump feature in a CFD study.

FIG. 133 illustrates another alternate exemplary embodiment of a vortex generating system according to the present disclosure. FIG. 133 illustrates the transparent isometric view of the oval horizontal with sump feature of FIG. 132 in a CFD study.

FIG. 134 illustrates another alternate exemplary embodiment of a vortex generating system according to the present disclosure. FIG. 134 illustrates the wire frame side view showing the flow of fluid of the oval horizontal with sump feature of FIG. 132 in a CFD study.

FIG. 135 illustrates another alternate exemplary embodiment of a vortex generating system according to the present disclosure. FIG. 135 illustrates the wire frame top view showing the flow of fluid of the oval horizontal with sump feature of FIG. 132 in a CFD study.

FIG. 136 illustrates another alternate exemplary embodiment of a vortex generating system according to the present disclosure. FIG. 136 illustrates the wire frame back view showing the flow of fluid of the oval horizontal with sump feature of FIG. 132 in a CFD study.

FIG. 137 illustrates another alternate exemplary embodiment of a vortex generating system according to the present disclosure. FIG. 137 illustrates the internal volume of an oval horizontal with sump feature and no center guide post in a CFD study.

FIG. 138 illustrates another alternate exemplary embodiment of a vortex generating system according to the present disclosure. FIG. 138 illustrates a transparent isometric view of the oval horizontal with sump feature and no center guide post of FIG. 137 in a CFD study.

FIG. 139 illustrates another alternate exemplary embodiment of a vortex generating system according to the present disclosure. FIG. 139 illustrates a wire frame side view showing the flow of fluid of the oval horizontal with sump feature and no center guide post of FIG. 137 in a CFD study.

FIG. 140 illustrates another alternate exemplary embodiment of a vortex generating system according to the present disclosure. FIG. 140 illustrates a wire frame top view showing the flow of fluid of the oval horizontal with sump feature and no center guide post of FIG. 137 in a CFD study.

FIG. 141 illustrates another alternate exemplary embodiment of a vortex generating system according to the present disclosure. FIG. 141 illustrates a wire frame back view showing the flow of fluid of the oval horizontal with sump feature and no center guide post of FIG. 137 in a CFD study.

FIG. 142 illustrates another alternate exemplary embodiment of a vortex generating system according to the present disclosure. FIG. 142 illustrates the internal volume of a 2-hole 45-degree with sump feature in a CFD study.

FIG. 143 illustrates another alternate exemplary embodiment of a vortex generating system according to the present disclosure. FIG. 143 illustrates a transparent view of the 2-hole 45-degree with sump feature of FIG. 142 in a CFD study.

FIG. 144 illustrates another alternate exemplary embodiment of a vortex generating system according to the present disclosure. FIG. 144 illustrates a transparent side view showing the flow of fluid of the 2-hole 45-degree with sump feature of FIG. 142 in a CFD study.

FIG. 145 illustrates another alternate exemplary embodiment of a vortex generating system according to the present disclosure. FIG. 145 illustrates a transparent front view showing the flow of fluid of the 2-hole 45-degree with sump feature of FIG. 142 in a CFD study.

FIG. 146 illustrates another alternate exemplary embodiment of a vortex generating system according to the present disclosure. FIG. 146 illustrates the internal volume of a 2-hole 45-degree with sump feature and no center guide post in a CFD study.

FIG. 147 illustrates another alternate exemplary embodiment of a vortex generating system according to the present disclosure. FIG. 147 illustrates a transparent view of the 2-hole 45-degree with sump feature and no center guide post of FIG. 146 in a CFD study.

FIG. 148 illustrates another alternate exemplary embodiment of a vortex generating system according to the present disclosure. FIG. 148 illustrates a transparent side view showing the flow of fluid of the 2-hole 45-degree with sump feature and no center guide post of FIG. 146 in a CFD study.

FIG. 149 illustrates another alternate exemplary embodiment of a vortex generating system according to the present disclosure. FIG. 149 illustrates a transparent front view showing the flow of fluid of the 2-hole 45-degree with sump feature and no center guide post of FIG. 146 in a CFD study.

### DESCRIPTION OF THE PREFERRED EMBODIMENT

The present disclosure advantageously uses different geometric forms to produce a vortex effect on the fluids passing through a spray actuator. The geometric forms are configured to break up the bulk volume of the fluid into sheets, ligaments and finally to create spray droplets without the use of a separate assembled insert. Advantageously, the geometric forms of the present disclosure can be formed within a single plastic molding, which reduces the overall cost of capital investment and cost of manufacturing the component.

In an embodiment, there is provided a system and apparatus for dispensing a fluid or liquid product in the form of a spray, said system or apparatus comprising a discharge channel and at least one inlet channel, wherein the discharge channel and the at least one inlet channel are disposed with respect to one another such that the at least one inlet channel is capable of providing a tangential feed of fluid into the discharge channel sufficient to generate a vortex and spray pattern. The tangential feed of fluid into the discharge channel causes a turbulent flow of the fluid, in use, into the outlet portion of the discharge channel.

The system and apparatus according to the disclosure is advantageous principally because tangential feed of the fluid into the discharge channel causes turbulent flow, in use, without the need for a flow-modifying insert or nozzle, or any other additional component. The system and apparatus may therefore comprise an actuator that is formed as a single component, thereby reducing manufacturing costs for such system and apparatus considerably.

The inlet channels are preferably tubular in form, and are most preferably generally cylindrical. The longitudinal axis of the inlet channel is therefore preferably coincidental with the direction of flow of the fluid or liquid product along the inlet portion during use.

The discharge channel is preferably tubular in form, and is most preferably generally cylindrical. The entrance aperture from the inlet channel is preferably circular, or elliptical, in shape. The inlet channel and discharge channel of the system or apparatus may be orientated at an angle to one another. For example, the inlet channel and discharge channel may be orientated generally perpendicular to each other. The length of the discharge channel is selected depending upon the desired spray characteristics, and the discharge channel may include an end portion of gradually increasing cross-sectional dimensions that leads to an exit aperture of increased cross-sectional area relative to the entrance aperture.

The inlet channel and discharge channel are preferably adapted to form a vortex within the fluid or liquid product. In a preferred configuration, the discharge channel and at least one inlet channel are disposed with respect to one another such that the at least one inlet channel is capable of providing a tangential feed of fluid into the discharge channel sufficient to generate a vortex and spray pattern.

The system or dispensing apparatus of this disclosure preferably forms part of an actuator for actuating a dispensing valve of a container that stores the fluid or liquid product. The system or dispensing apparatus therefore preferably comprises a container for storing the fluid or liquid product, a dispensing valve having a valve outlet through which the fluid or liquid product is released under pressure, when actuated, and the actuator which is engaged with the dispensing valve such that the inlet channel of the is in communication with the valve outlet.

The container and dispensing valve may together have the form of a conventional aerosol canister in which the fluid or liquid product is stored under pressure. Alternatively, the dispensing valve may include pump means for urging the fluid or liquid product though the dispensing valve under pressure. In any case, however, the dispensing valve is usually actuated by depressing the valve outlet of the dispensing valve.

As used herein, the term “vortex” shall mean a circular, spiral, or helical motion in a fluid, such as a gas, or the fluid in such a motion. Without wishing to be limited to any particular theory, it is believed that a vortex forms around areas of low pressure and attracts the fluid, and the objects moving within it, toward its center.

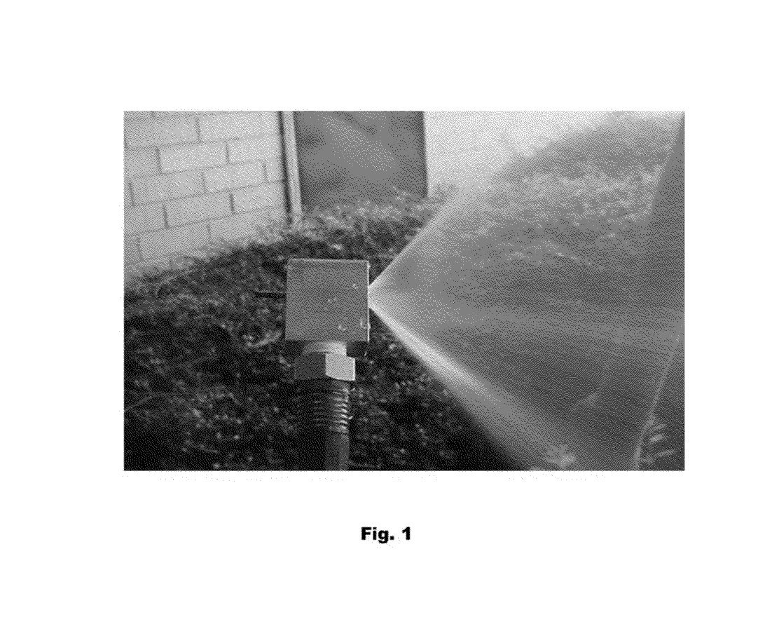

Referring now to the drawings, FIG. 1 illustrates an exemplary embodiment of a vortex generating stem according to the present disclosure. The vortex generating stem has a discharge channel that is perpendicular to an inlet channel. The inlet channel provides tangential feed to generate a vortex and a spray pattern.

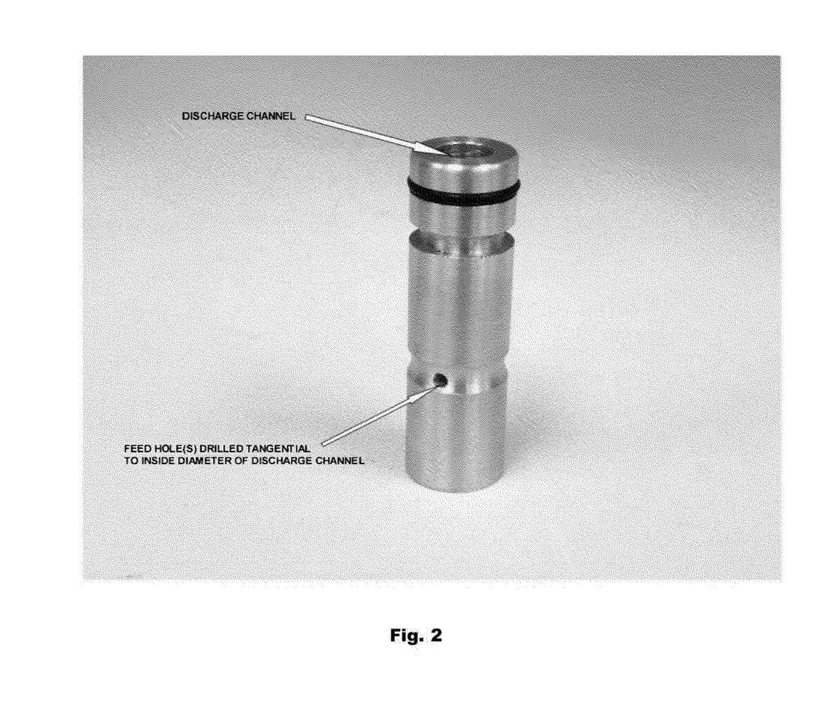

FIG. 2 illustrates a mock 5x super 90 stem standard length discharge channel. Feed holes are drilled tangential to the inside diameter of the discharge channel.

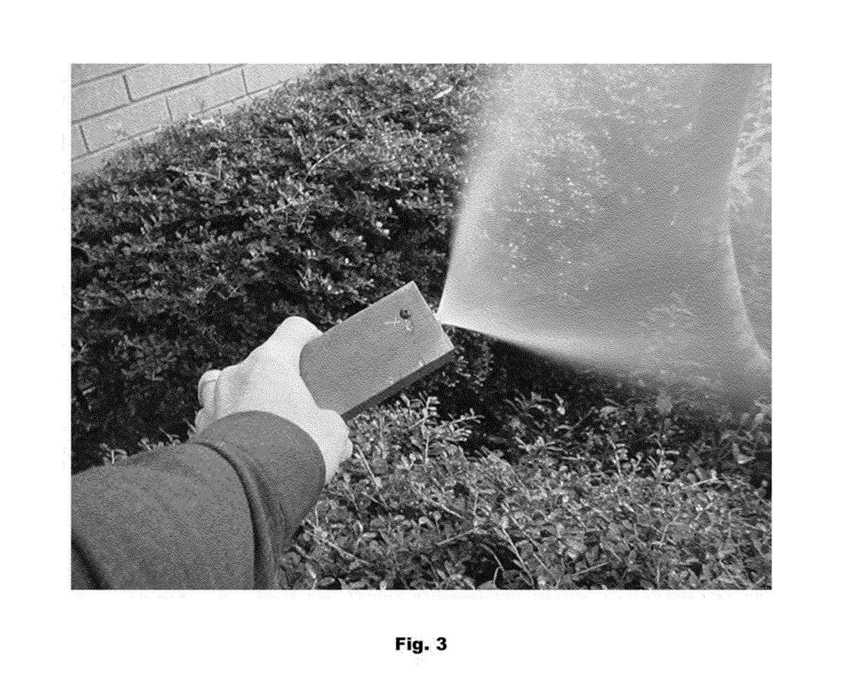

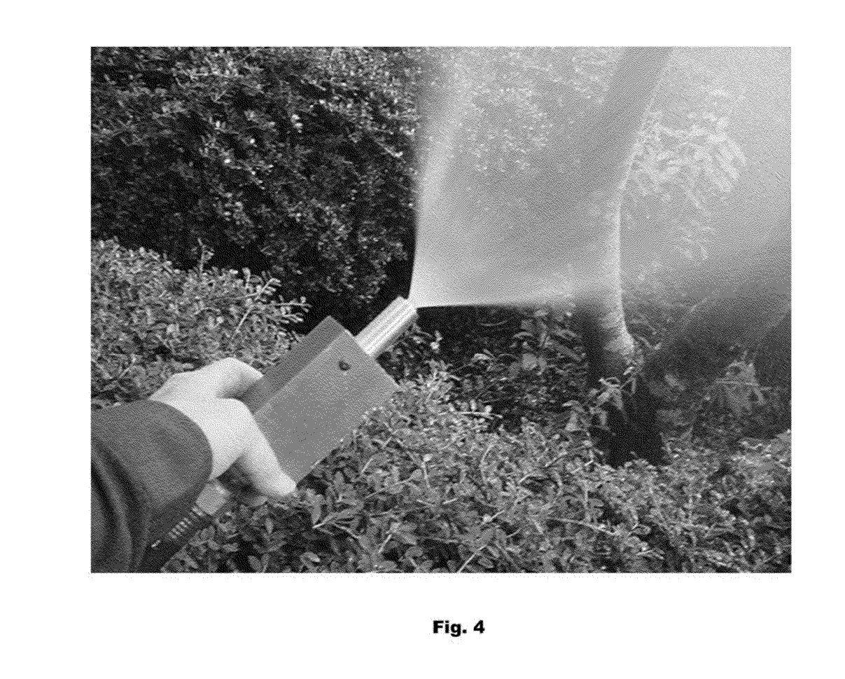

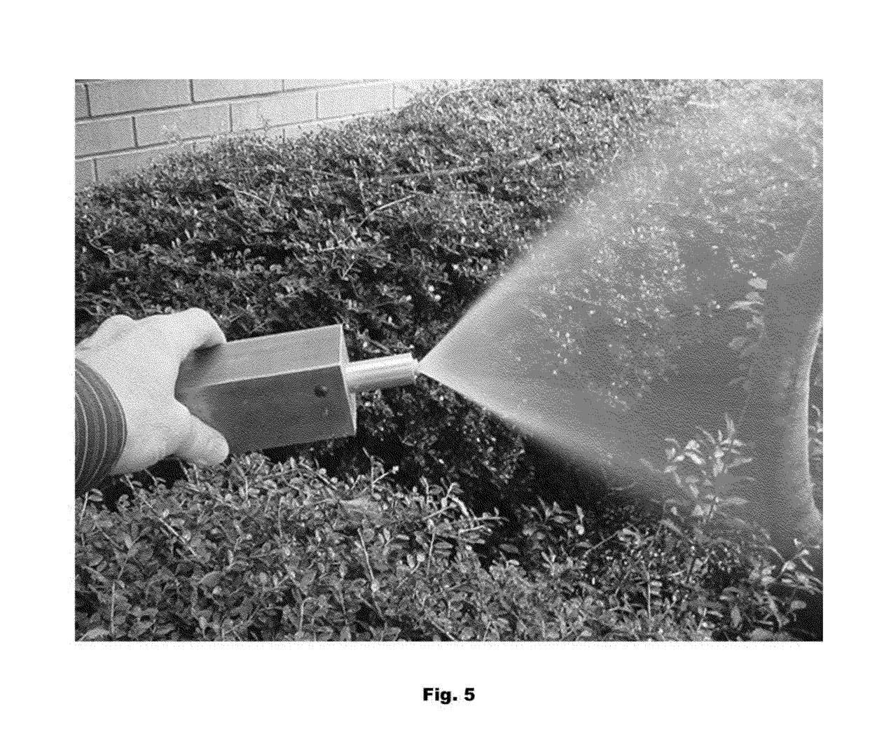

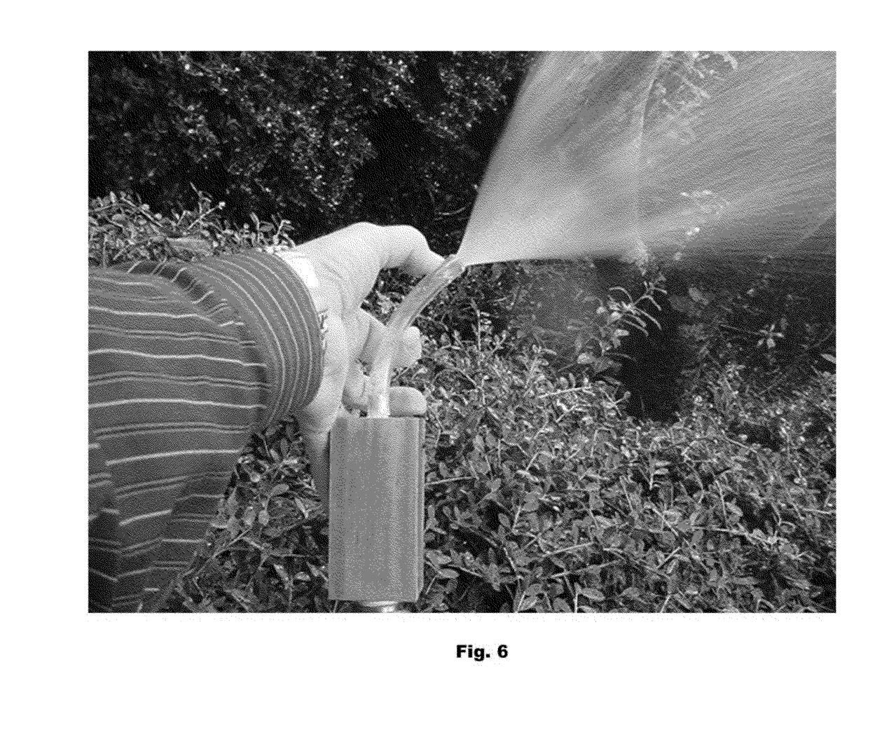

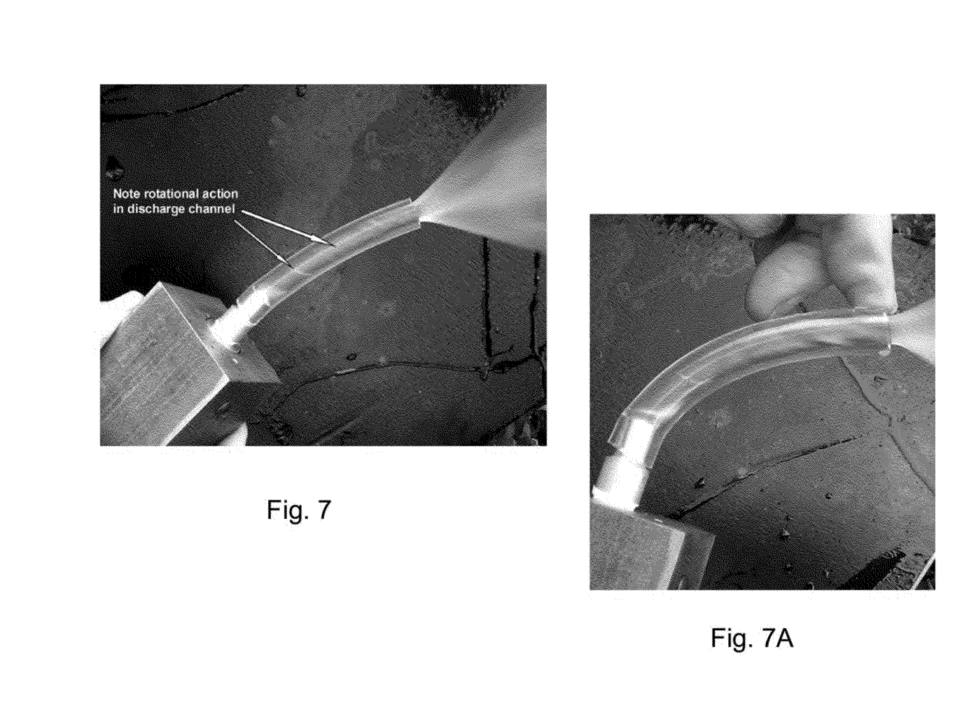

FIGS. 3 through 7 illustrate spray patterns of the stem of FIG. 2. FIG. 3 illustrates a mock 5x super 90 stem model spray pattern. FIG. 4 illustrates a mock 5x super 90 stem model (with extended discharge channel) spray pattern. The extended discharge channel extracts rotational energy from spray stream and narrows the spray cone angle. FIG. 5 illustrates a mock 5x super 90 stem model (with extended discharge channel) spray pattern as in FIG. 4, except with a tapered insert to reduce the discharge outlet diameter. The apparent effect is an increase in velocity which widens the spray cone angle to nearly that of the shorter discharge channel. FIG. 6 illustrates a curved discharge channel spray pattern. FIG. 7 illustrates additional curved discharge channels. Rotational action in the discharge channel is shown.

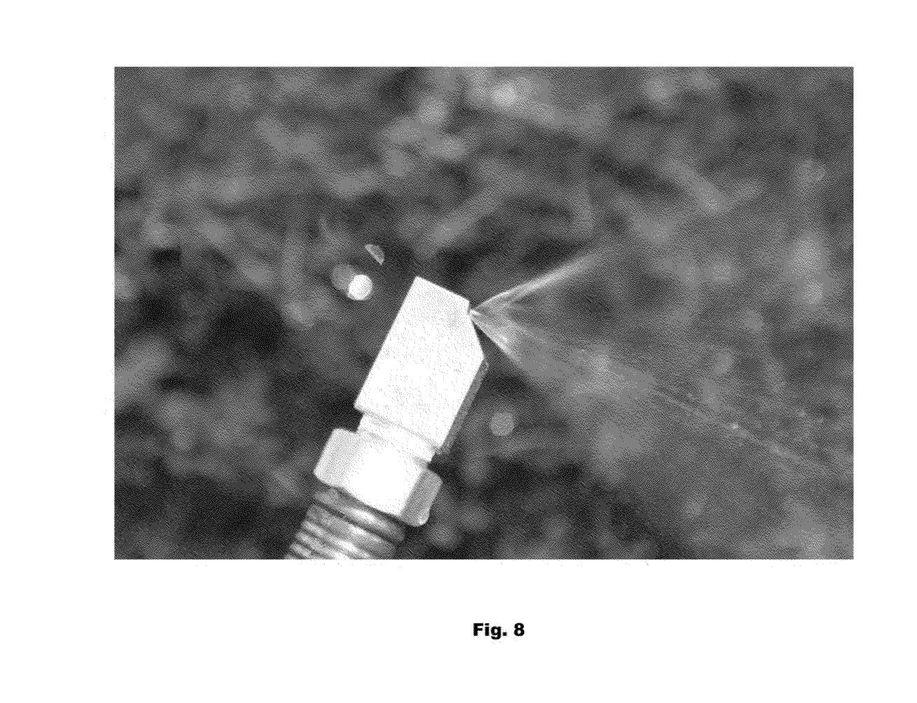

FIG. 8 illustrates another exemplary embodiment of a vortex generating system according to the present disclosure.

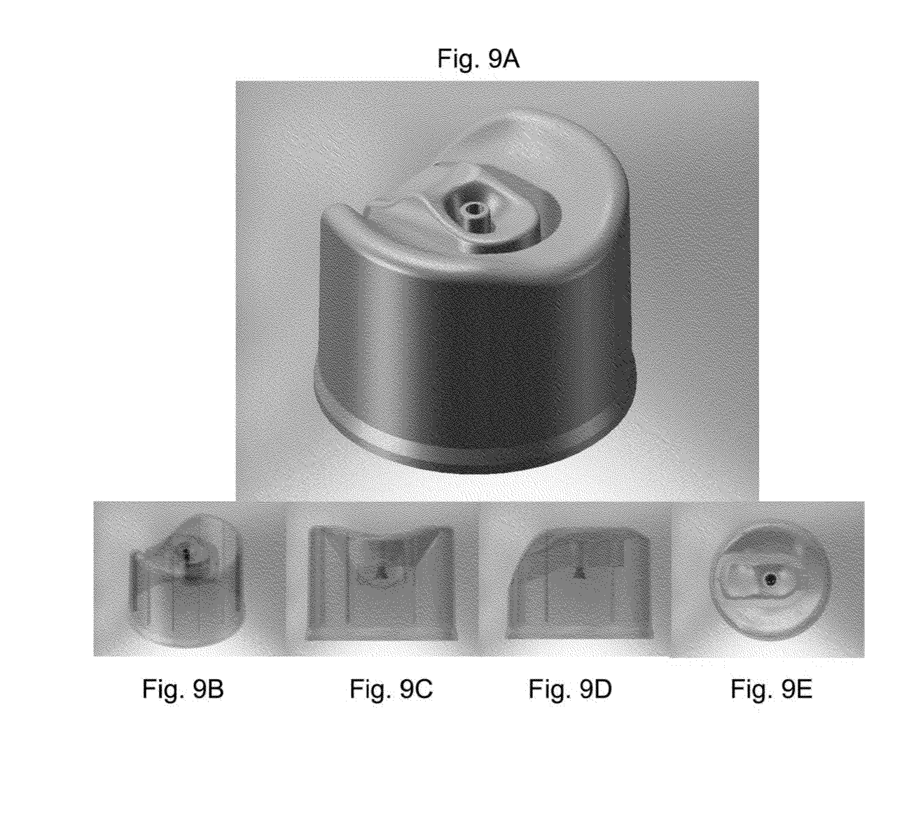

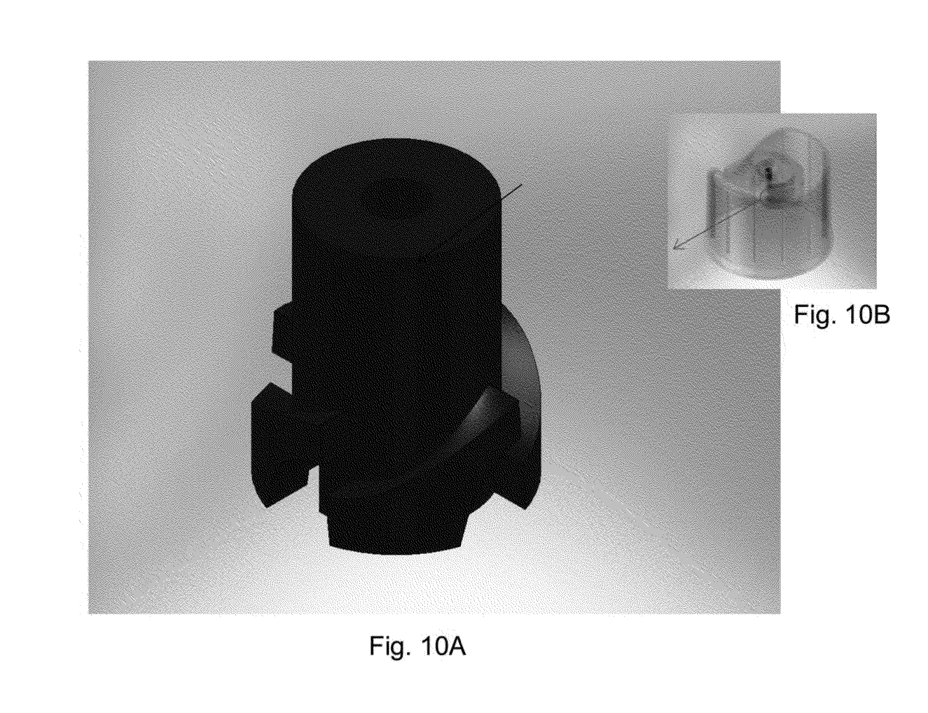

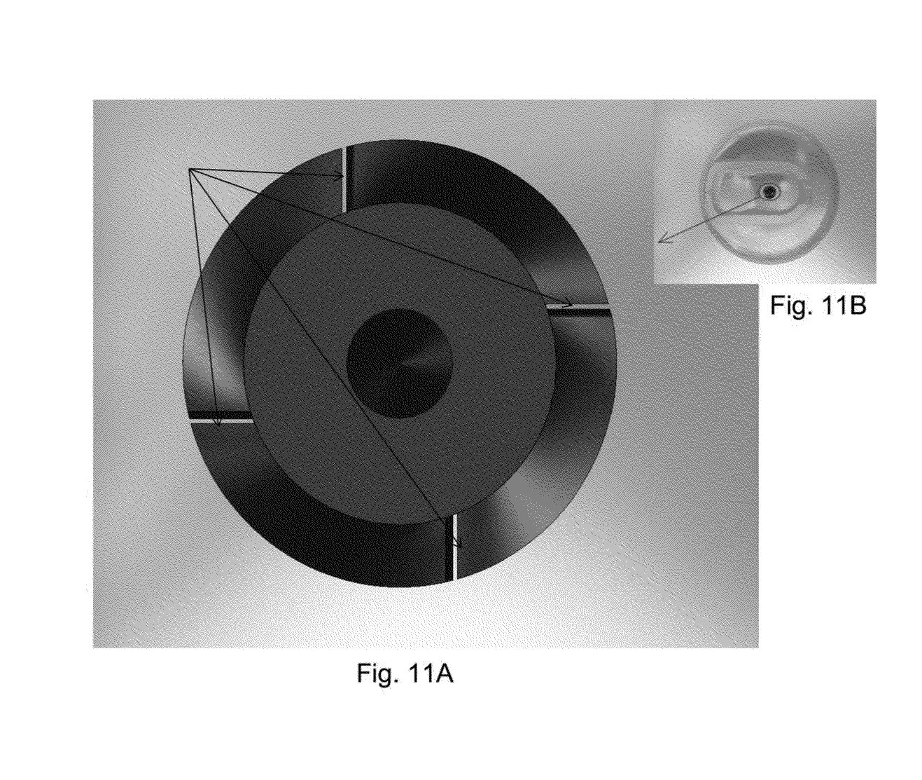

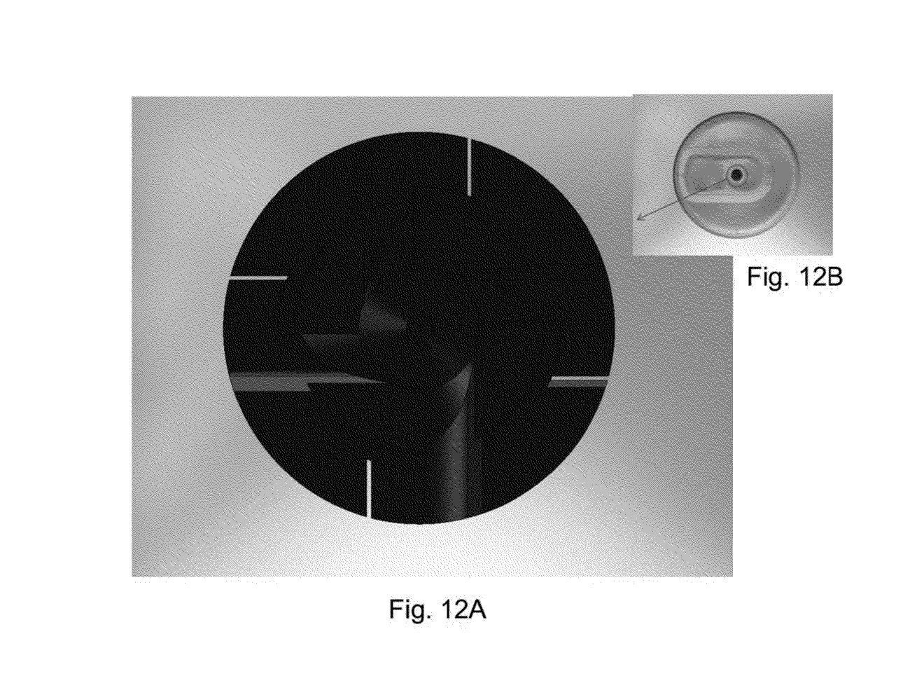

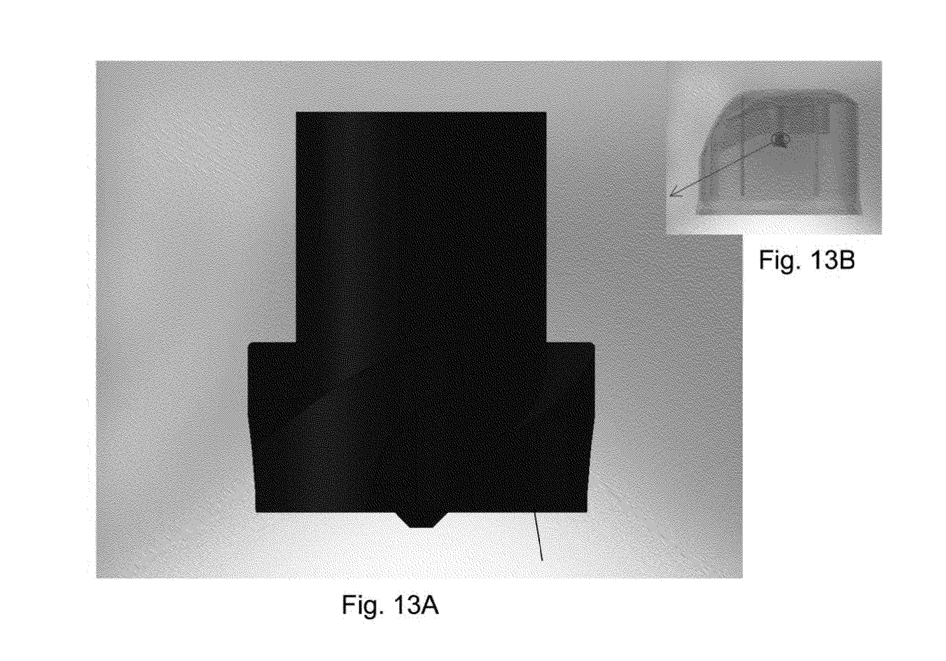

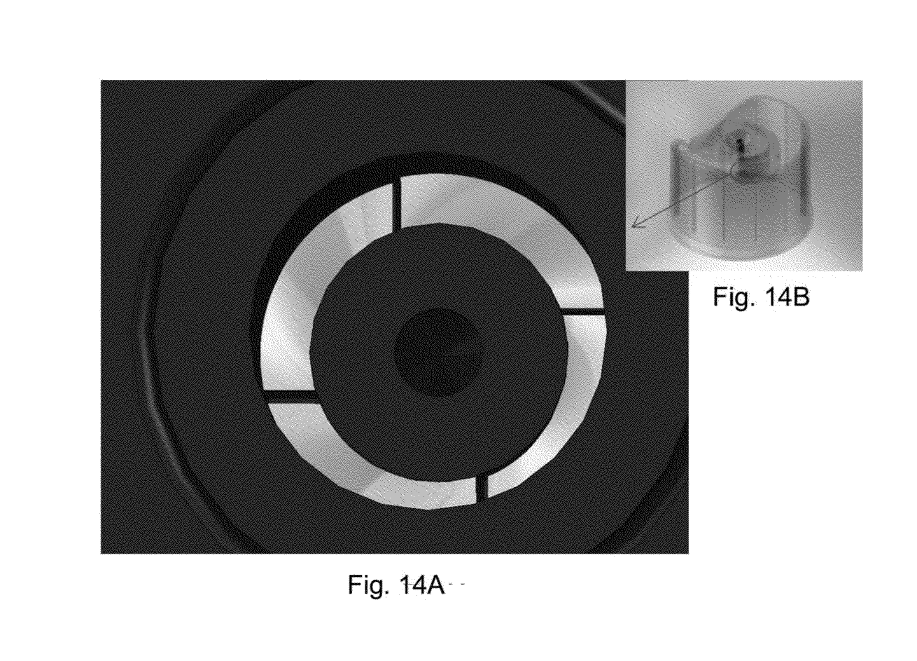

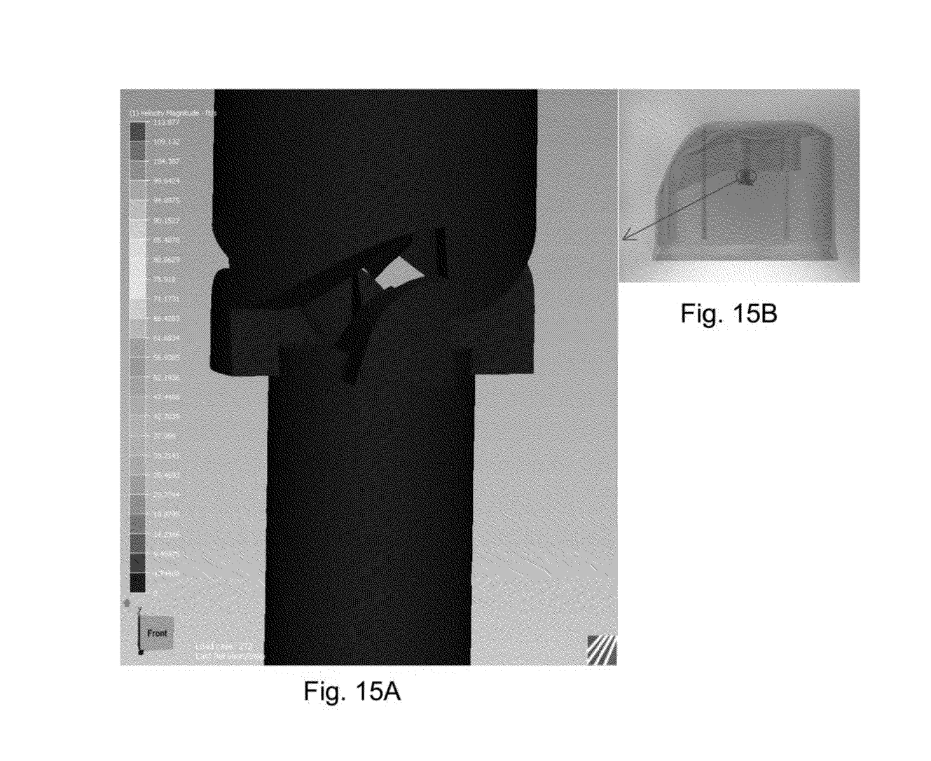

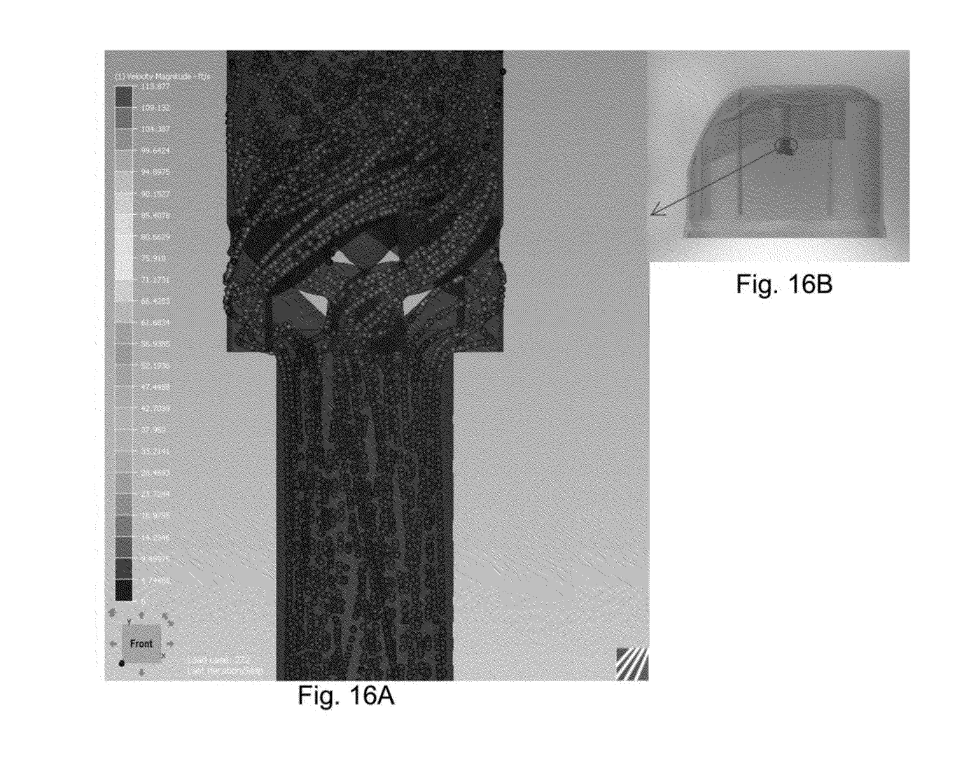

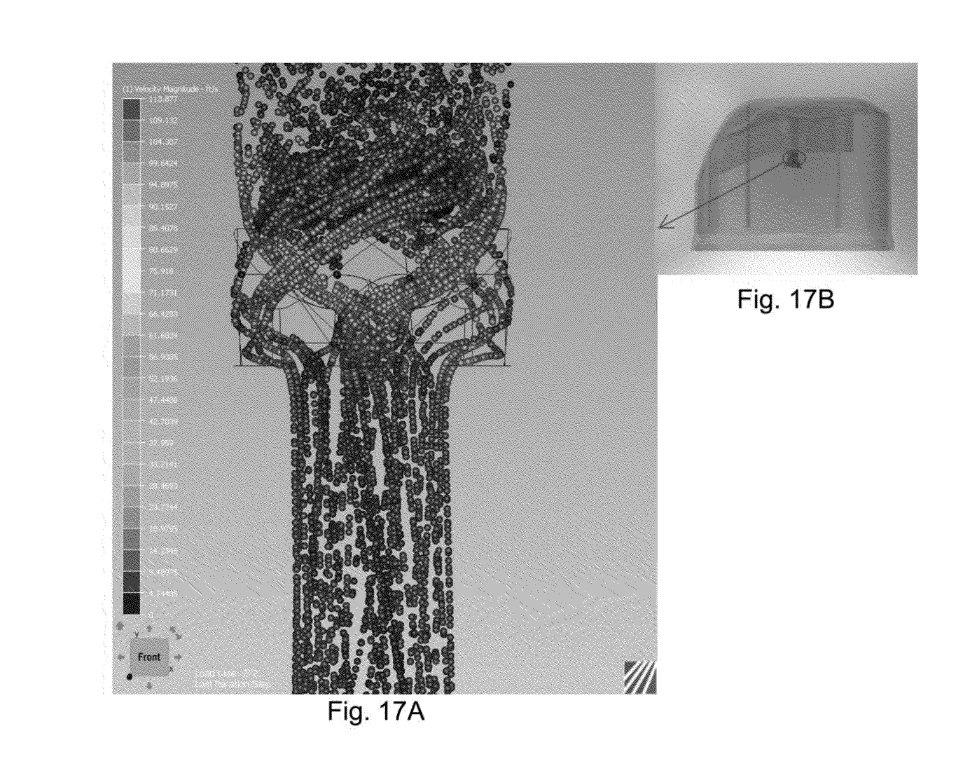

FIGS. 9 through 17 illustrate another exemplary embodiment of a vortex generating system according to the present disclosure illustrated in a dome cap. FIG. 9 illustrates a fan vortex geometry in a dome example. FIG. 10 is an isometric view of internal volume of a fan vortex geometry with four inlets/outlets and ramps. FIG. 11 is a front view of internal volume of a fan vortex geometry showing the four outlets, ramps, and center post. With respect to the gaps between the four ‘fan blades’, this is created by overlapping the steel from the two halves of the mold, above and below the molding split line. FIG. 12 is a bottom view of internal volume of a fan vortex geometry showing the four inlets, ramps, and center post. FIG. 13 is a side view of internal volume of a fan vortex geometry showing the inlet, ramp, and center post. FIG. 14 is a highlighted model view of the fan vortex illustrating the front view with the four outlets, ramps, and center post. FIG. 15 is a side view showing the internal volume of the fan vortex in a Computational Fluid Dynamics (CFD) study. FIG. 16 is a transparent side view showing the flow of fluid of the fan vortex in a CFD study. FIG. 17 is a wire frame side view showing the flow of fluid of the fan vortex in a CFD study.

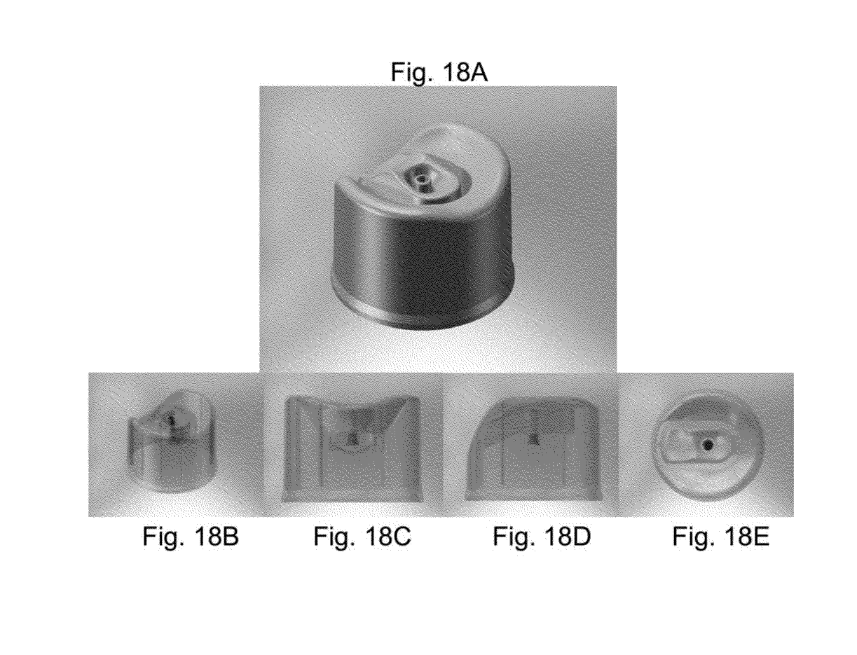

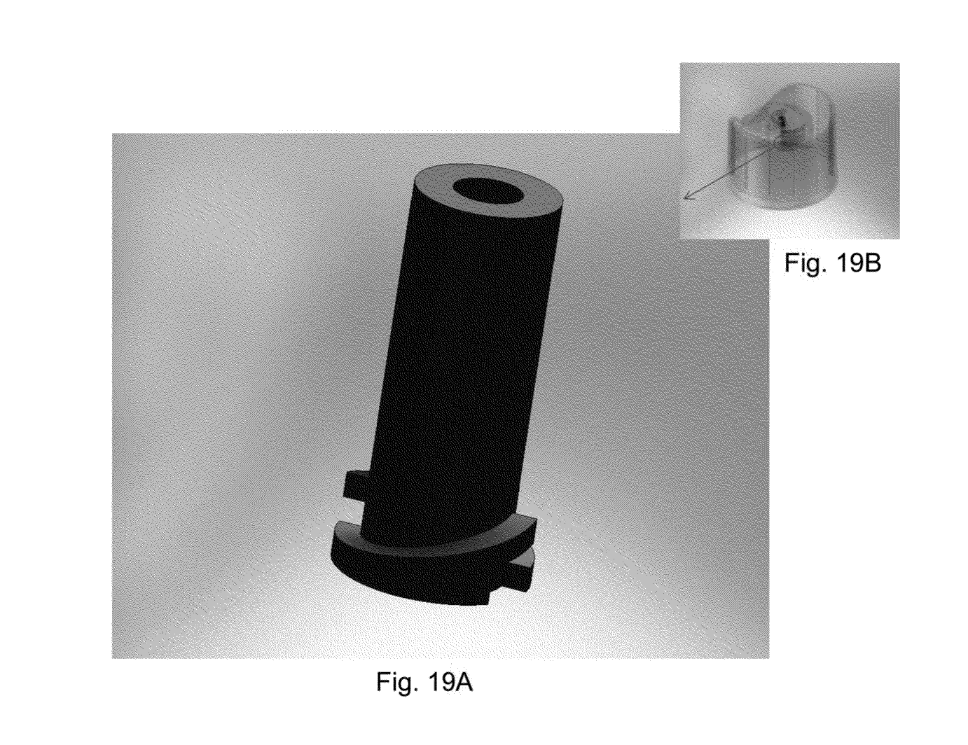

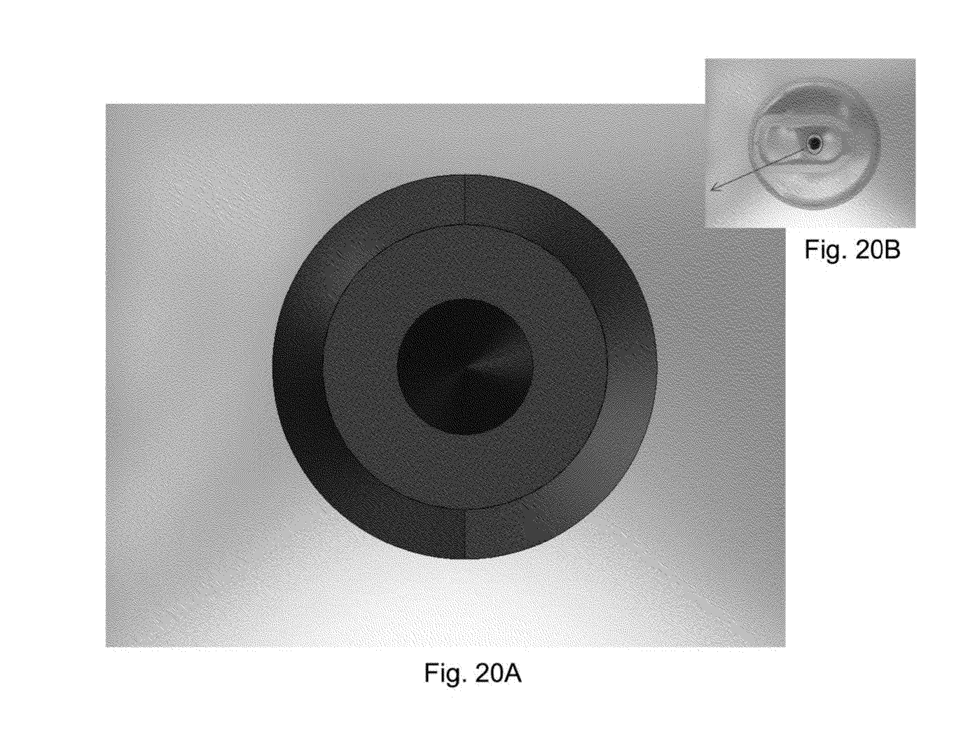

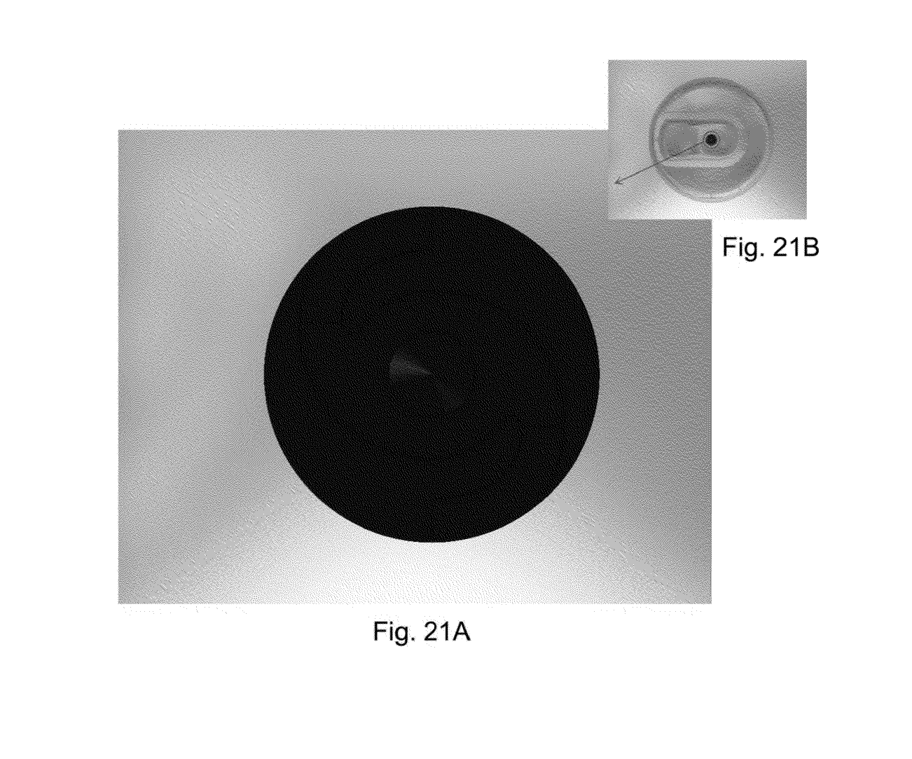

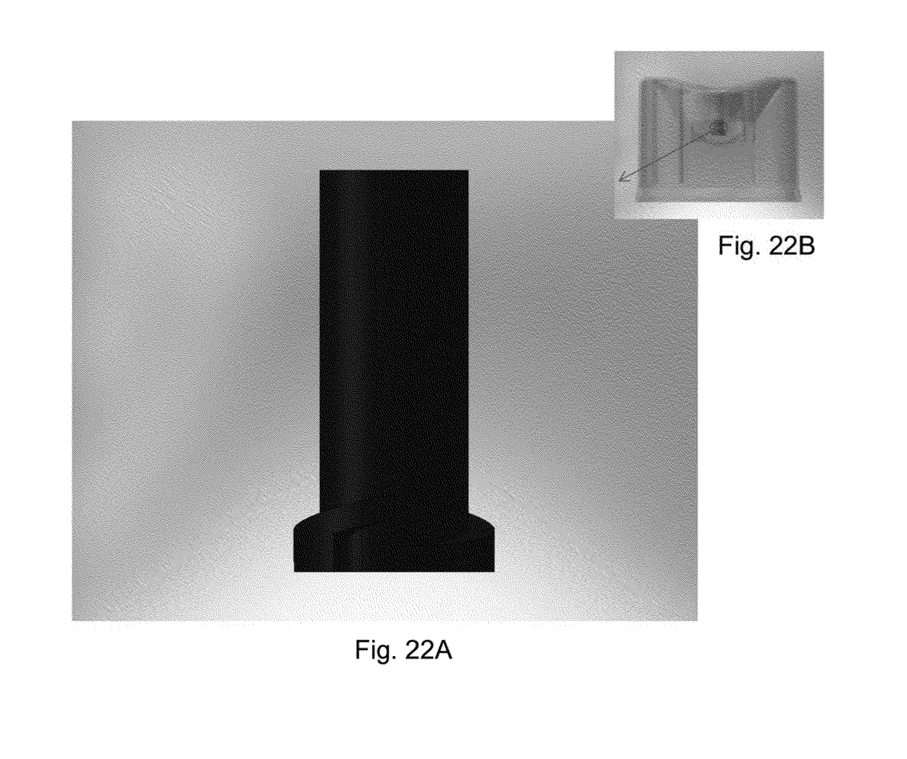

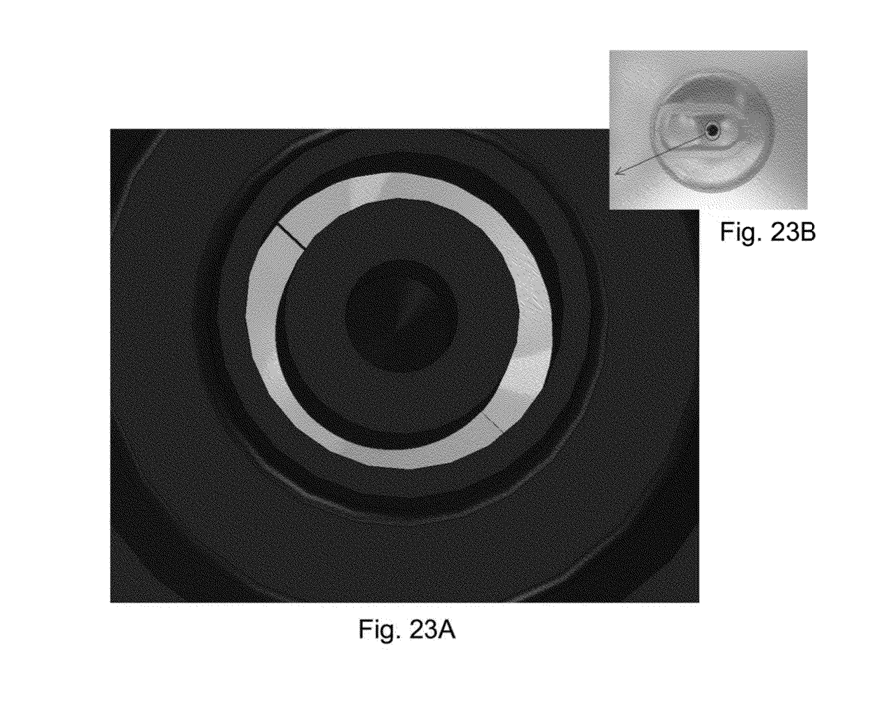

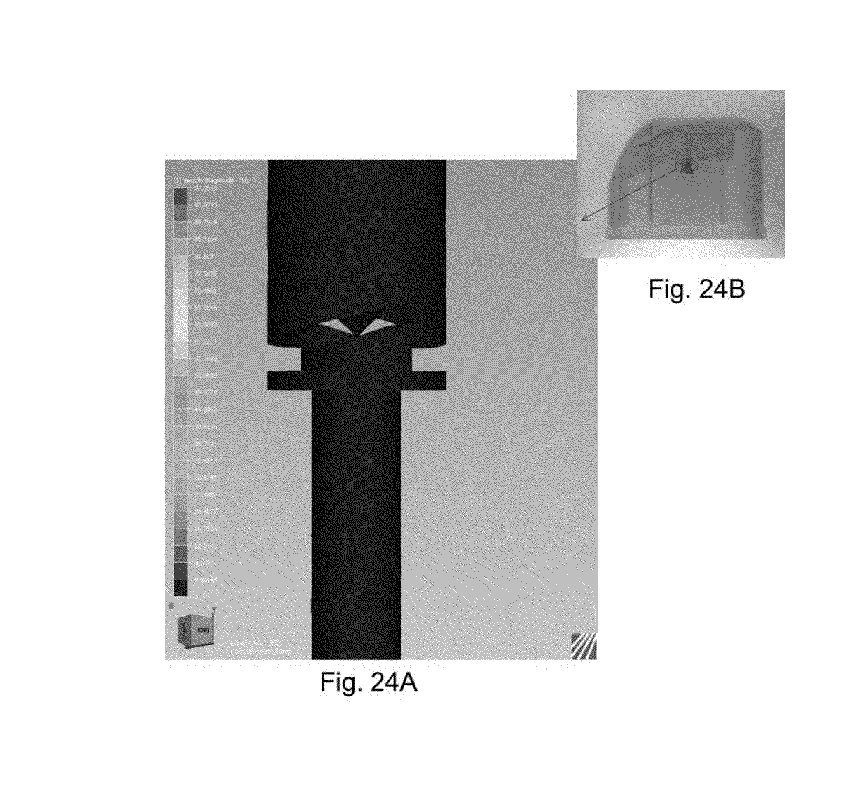

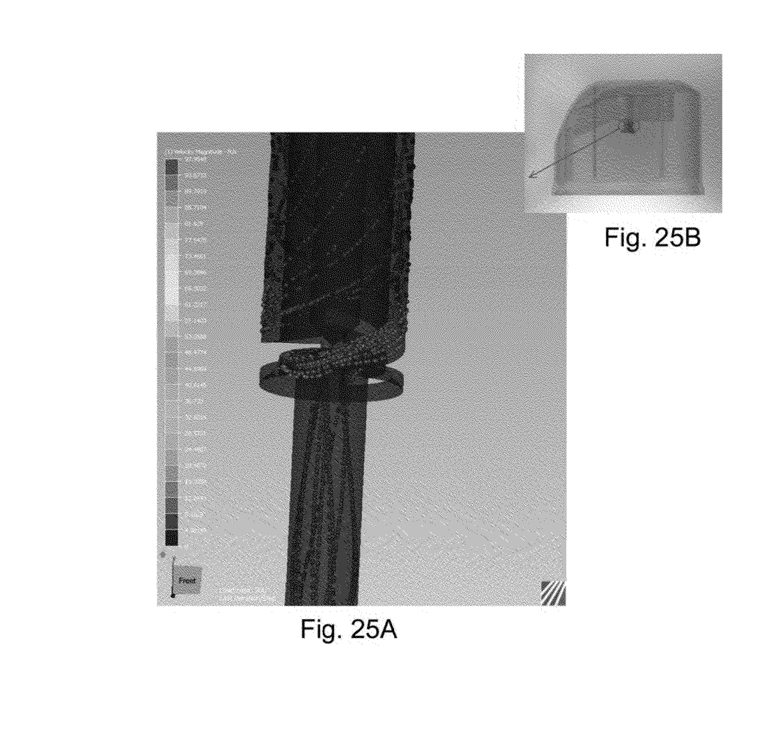

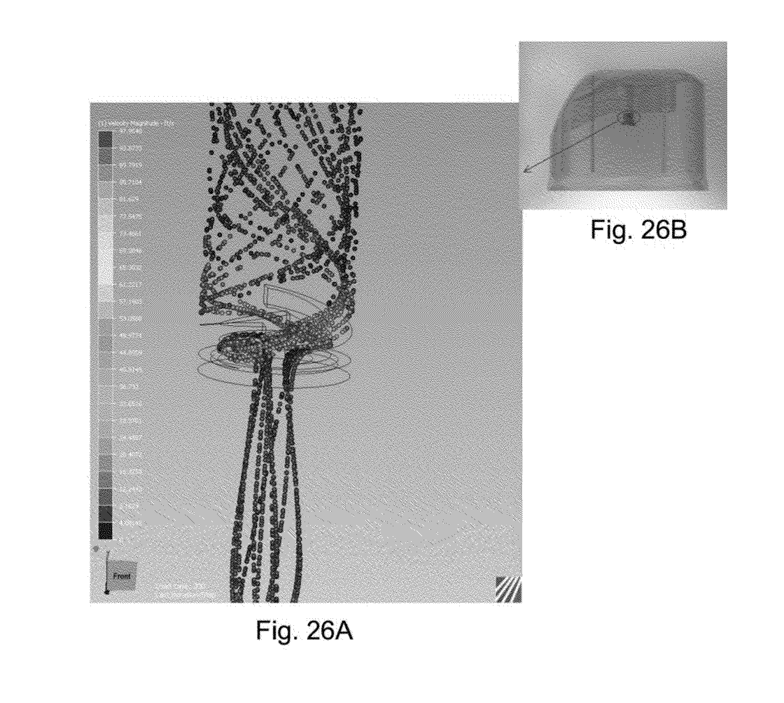

FIGS. 18 through 26 illustrate another exemplary embodiment of a dual vortex generating system according to the present disclosure illustrated in a dome cap. FIG. 18 illustrates dual vortex geometry in a dome example. FIG. 19 is an isometric view of internal volume of dual ramps vortex geometry with two inlets/outlets and ramps. This is similar to prior illustrated design only this time with two ‘blades’. FIG. 19 more clearly shows the helix angle of the blade to direct fluid flow. FIG. 20 is a front view of internal volume of dual ramps vortex geometry showing the two outlets, ramps, and center post. It is contemplated for the designated areas to have openings from two-part molding operations. FIG. 21 is a bottom view of internal volume of dual ramps vortex geometry showing the two inlets, ramps, and center post. FIG. 22 is a side view of internal volume dual ramps vortex geometry showing the inlet, ramp, and center post. FIG. 23 is a highlighted model view of the dual ramps vortex illustrating the front view with the two outlets, ramps, and center post. FIG. 24 is a side view showing the internal volume of the dual ramps vortex in a CFD study. FIG. 25 is a transparent side view showing the flow of fluid of the dual ramps vortex in a CFD study. FIG. 26 is a wire frame side view showing the flow of fluid of the dual ramps vortex in a CFD study.

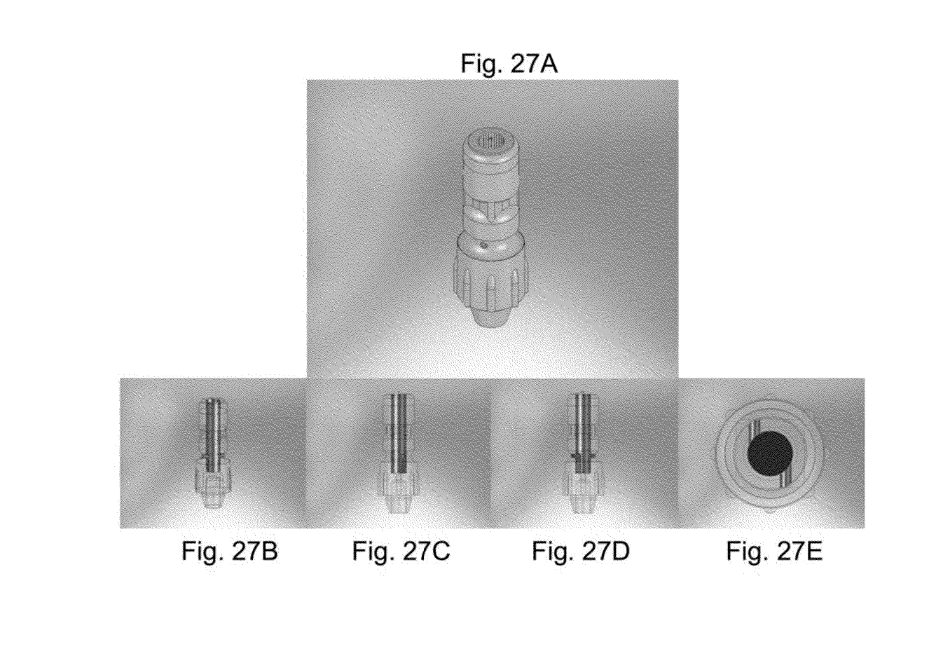

FIG. 27 illustrates an alternate exemplary embodiment of a vortex generating system according to the present disclosure. In particular, FIG. 27 is an offset vortex geometry in a stem example.

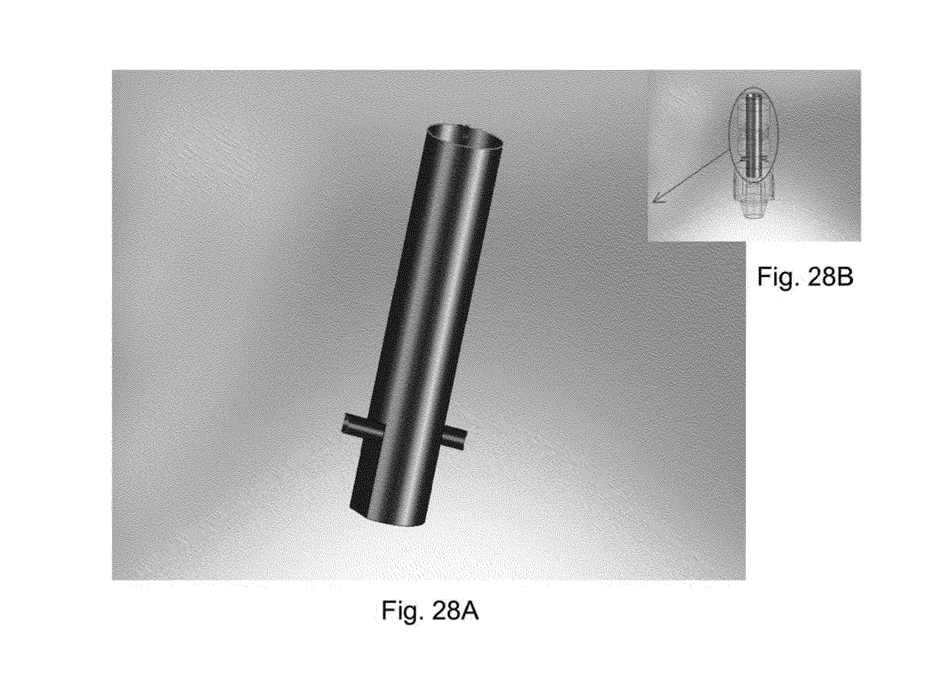

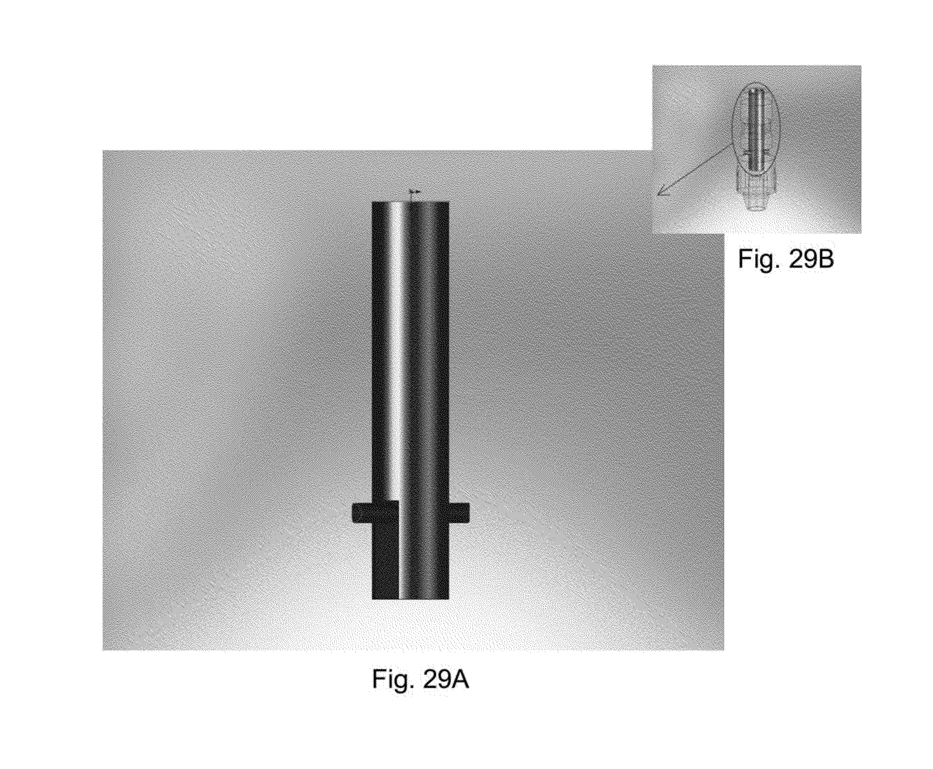

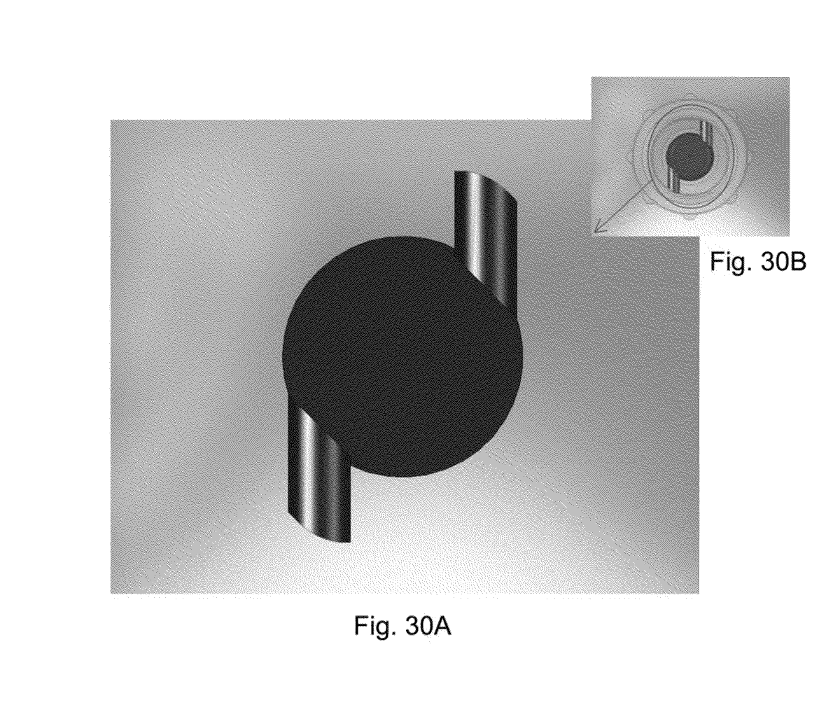

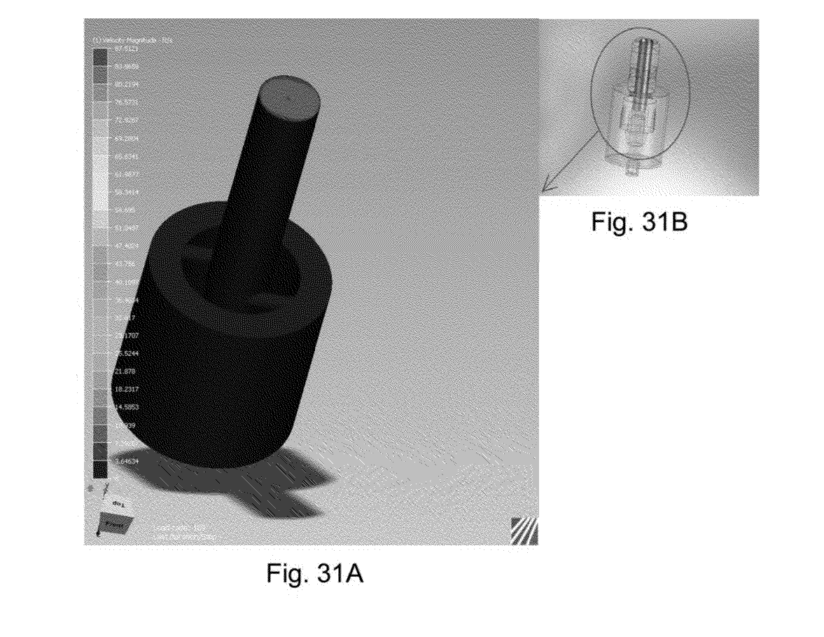

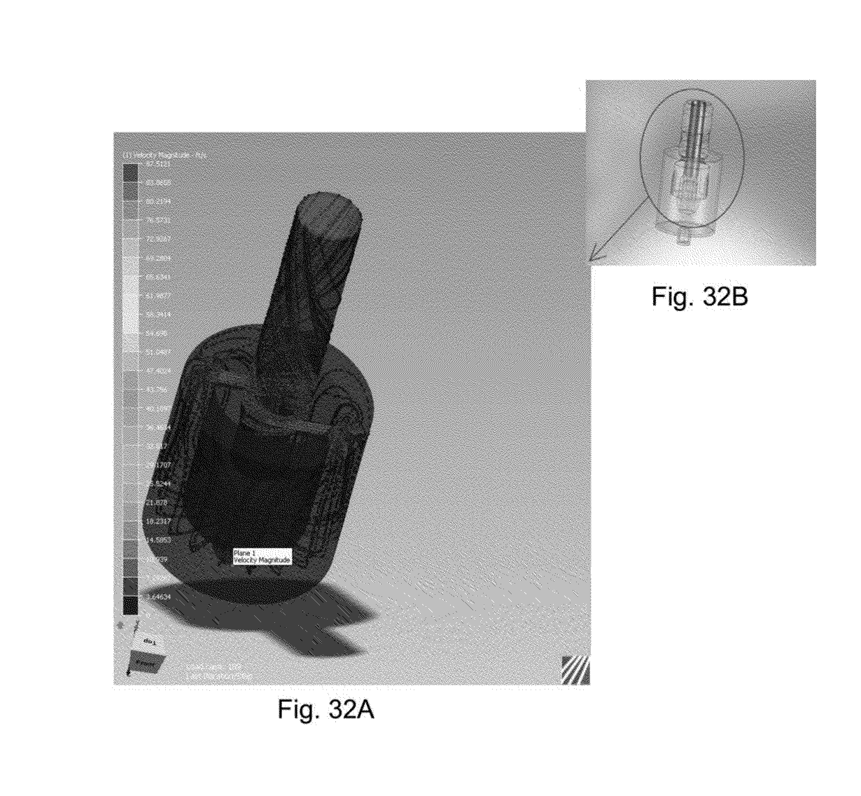

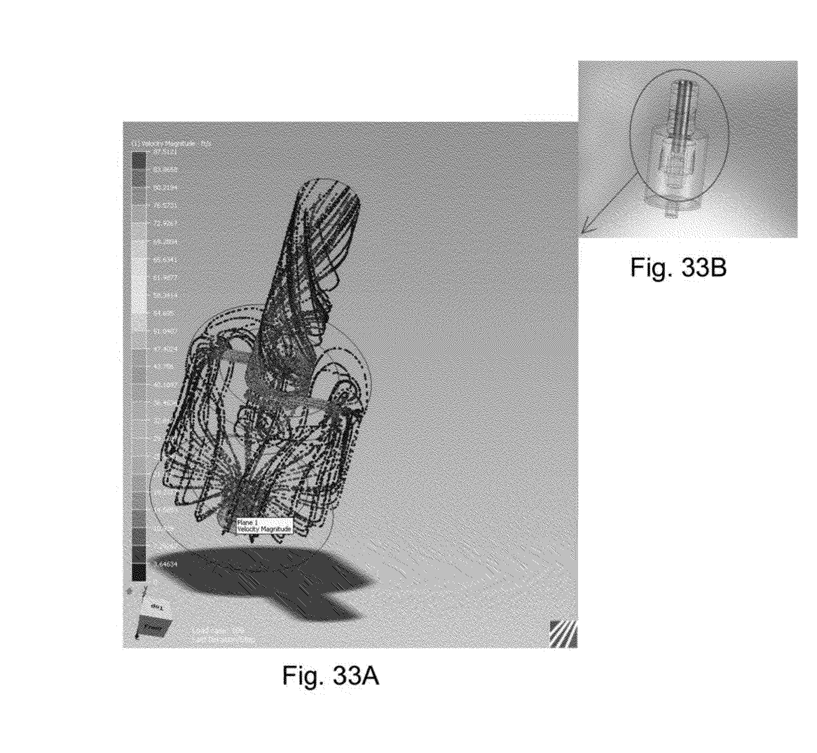

FIGS. 28 through 33 illustrate another alternate exemplary embodiment of a vortex generating system according to the present disclosure. FIG. 28 is an isometric view of internal volume of S90 stem vortex geometry with two inlets. This geometry below the side holes can be very influential in fluid rotational behavior. FIG. 29 is a side view of internal volume of S90 stem vortex geometry showing the two inlets at offset opposing locations. FIG. 30 is a bottom view of internal volume of S90 stem vortex geometry showing the two inlets at offset opposing locations. FIG. 31 is an isometric view showing the internal volume of the S90 stem vortex in a CFD study with an attached housing. FIG. 32 is a transparent isometric view showing the flow of fluid of the S90 stem vortex in a CFD study. FIG. 33 is a wire frame isometric view showing the flow of fluid of the S90 stem vortex in a CFD study.

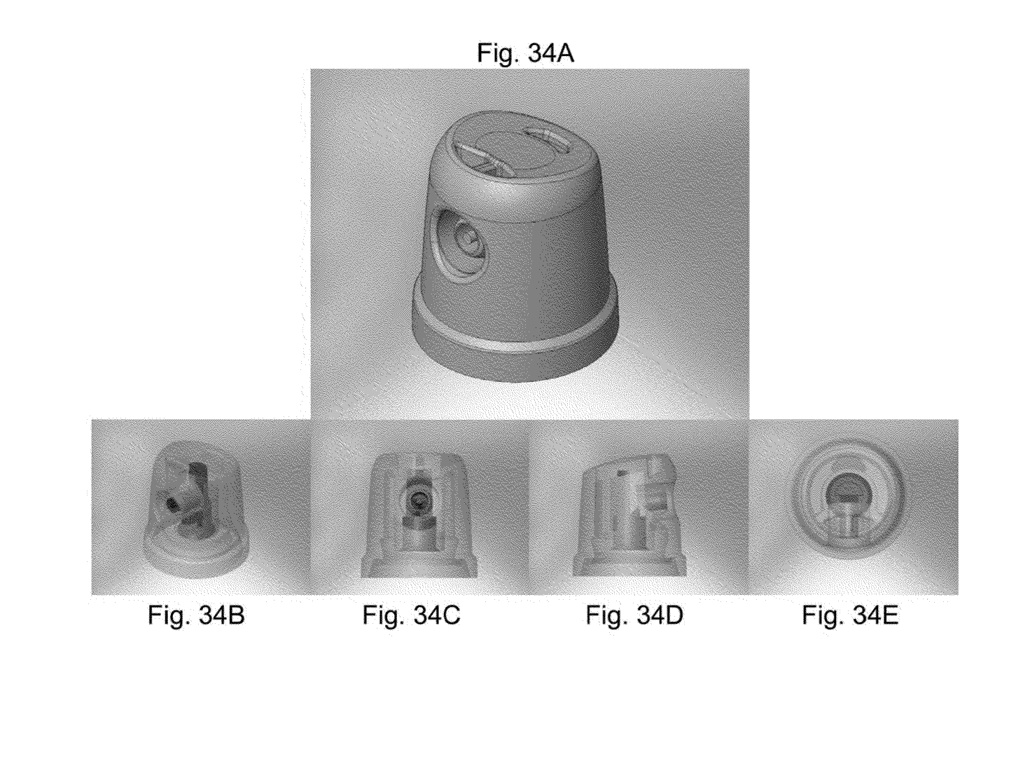

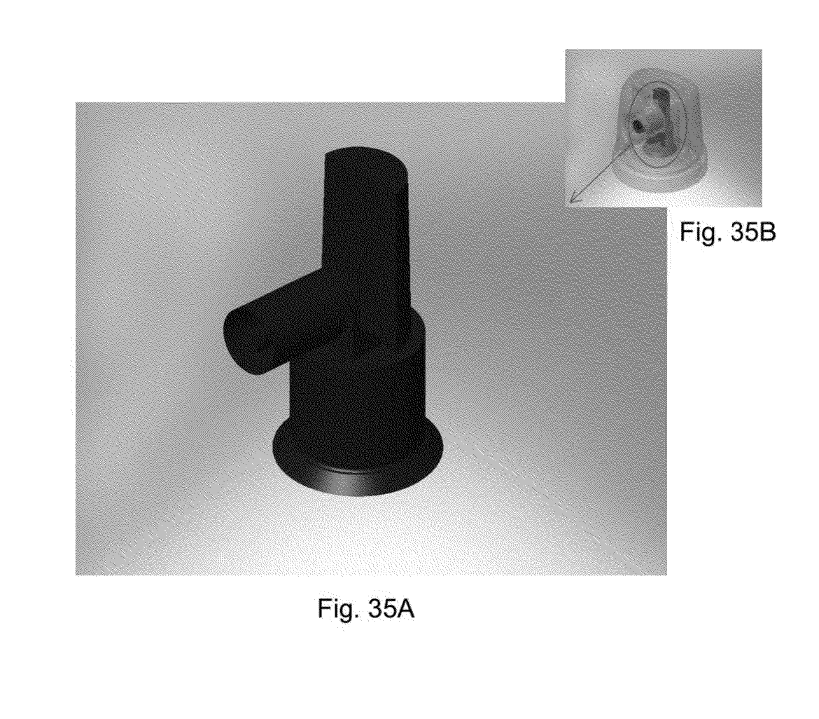

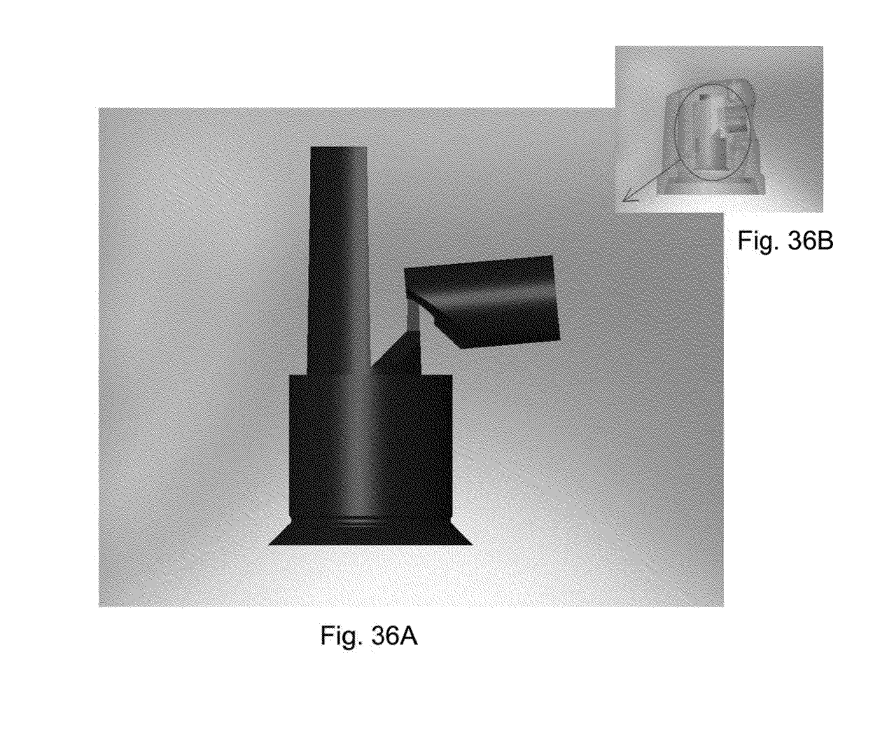

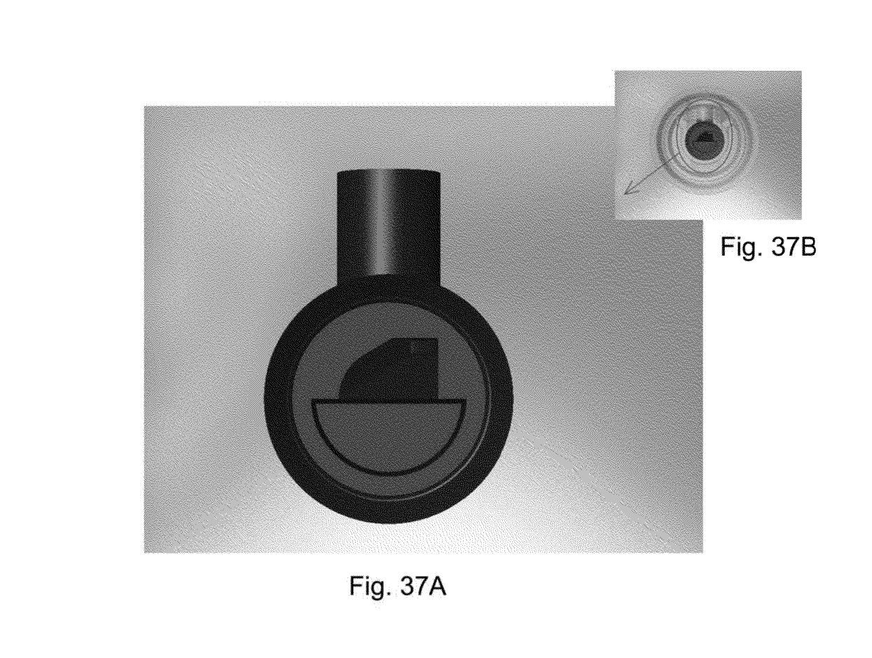

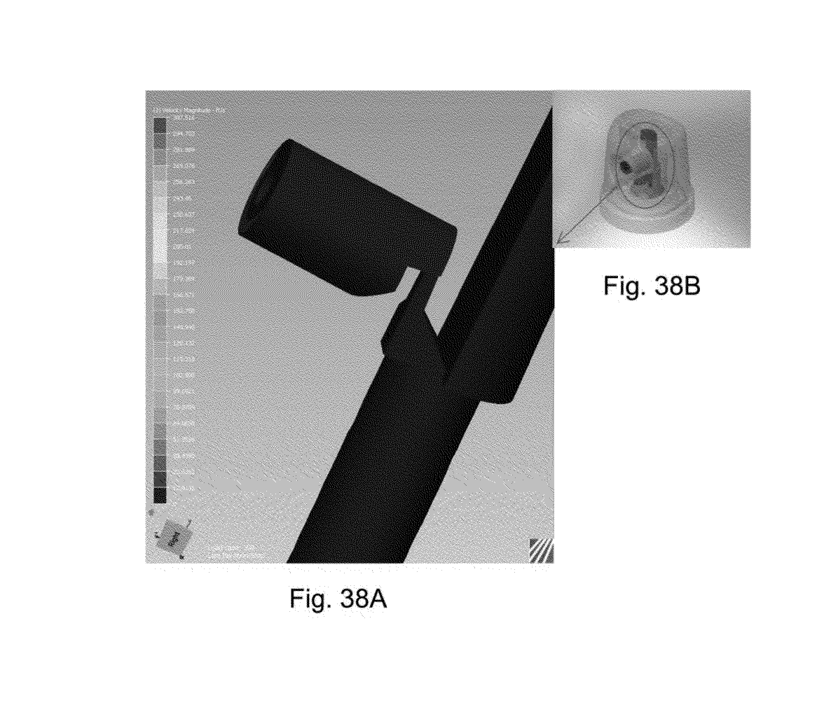

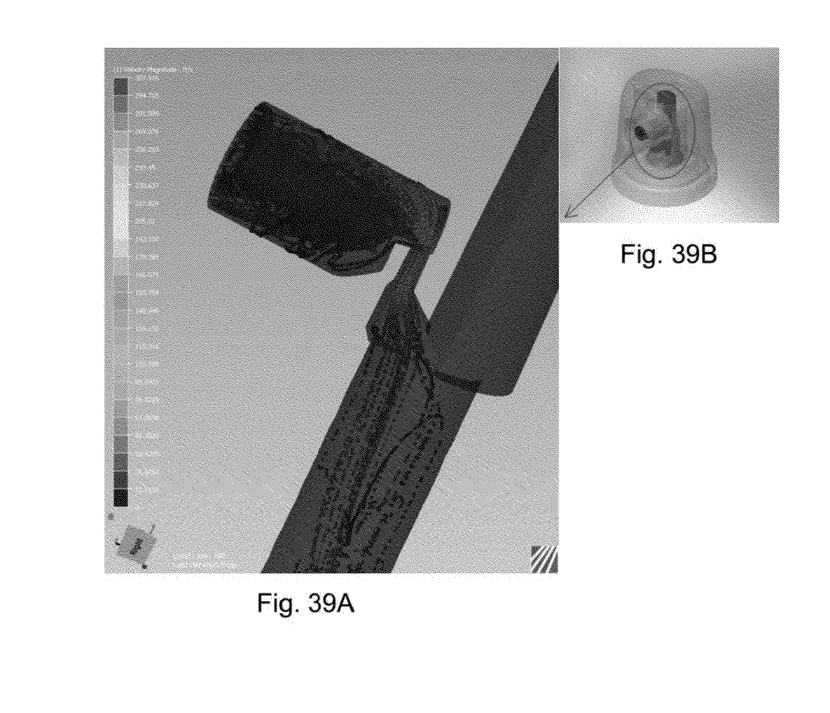

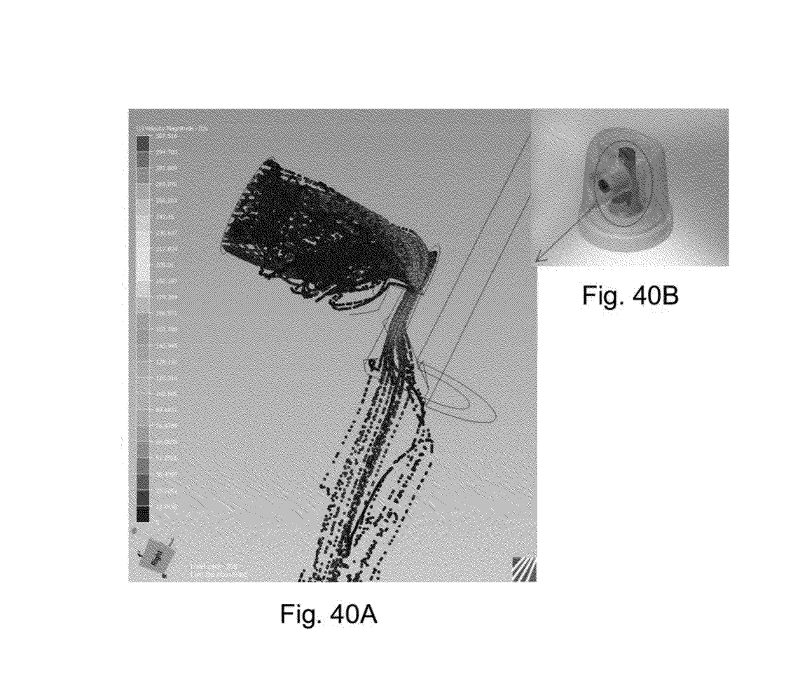

FIGS. 34 through 40 illustrate another alternate exemplary embodiment of a vortex generating system according to the present disclosure. FIG. 34 is a horizontal or slightly angled vortex geometry in a button example. FIG. 35 is an isometric view of internal volume of horizontal or slightly angled button vortex geometry. FIG. 36 is a side view of internal volume of horizontal or slightly angled button vortex geometry. While this feed onto a ramped profile is an alternate embodiment, the design does not need to be so complicated and the feed can be tangentially into a plain bore. FIG. 37 is a bottom view of internal volume of horizontal or slightly angled button vortex geometry. FIG. 38 is an isometric view showing the internal volume of the horizontal vortex in a button in a CFD study. FIG. 39 is a transparent isometric view showing the flow of fluid of the horizontal vortex in a button in a CFD study. FIG. 40 is a wire frame isometric view showing the flow of fluid of the horizontal vortex in a button in a CFD study.

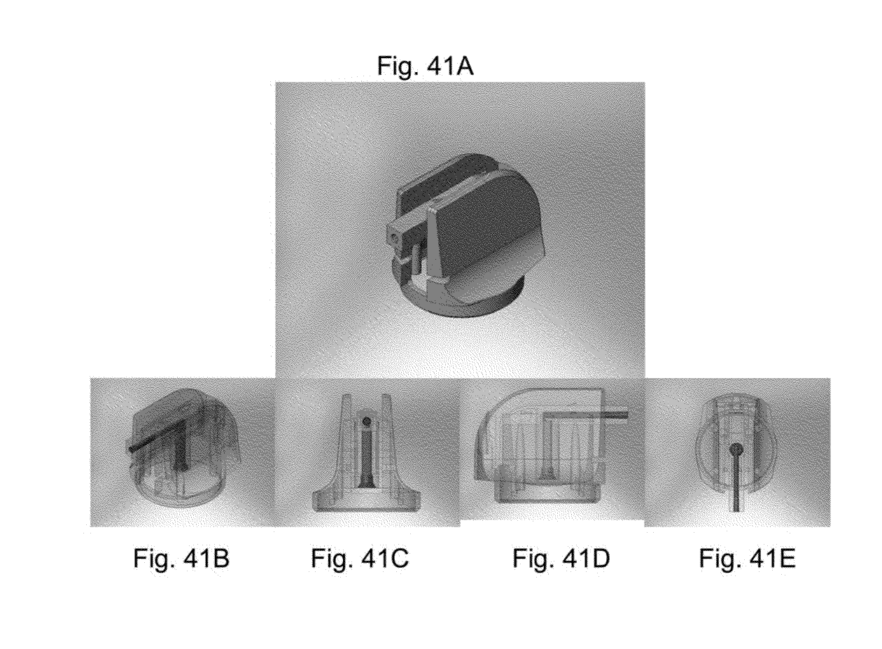

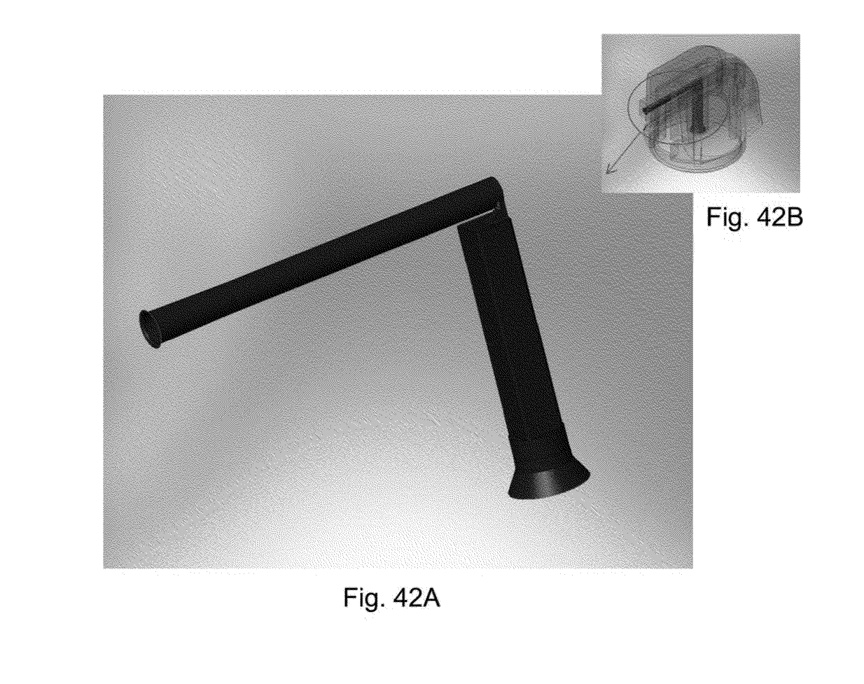

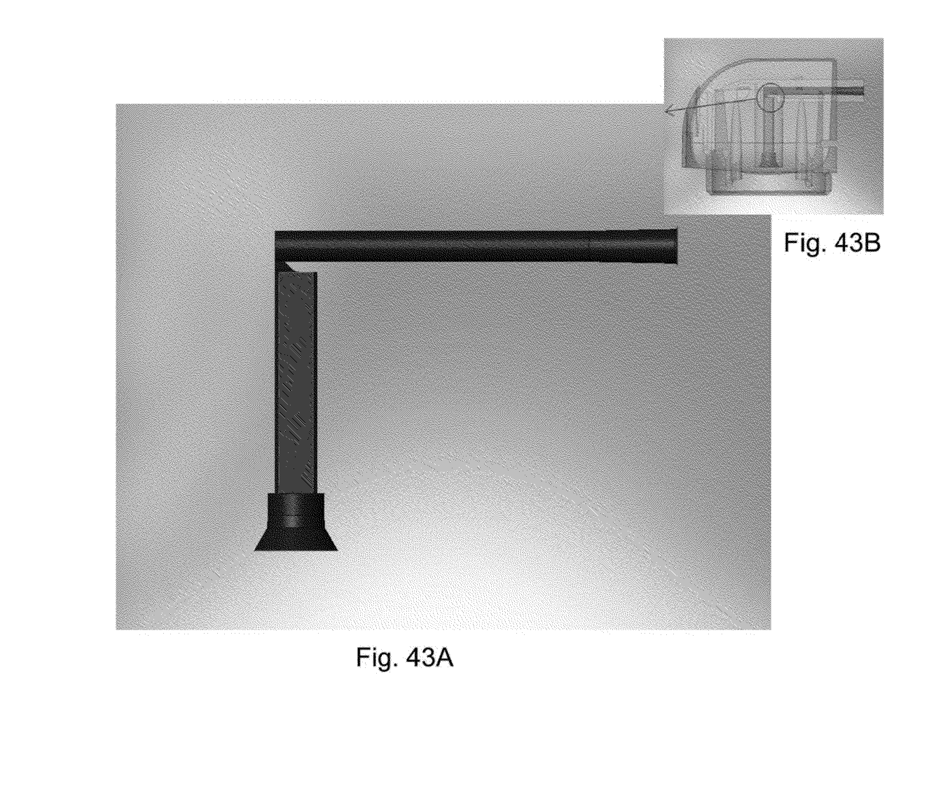

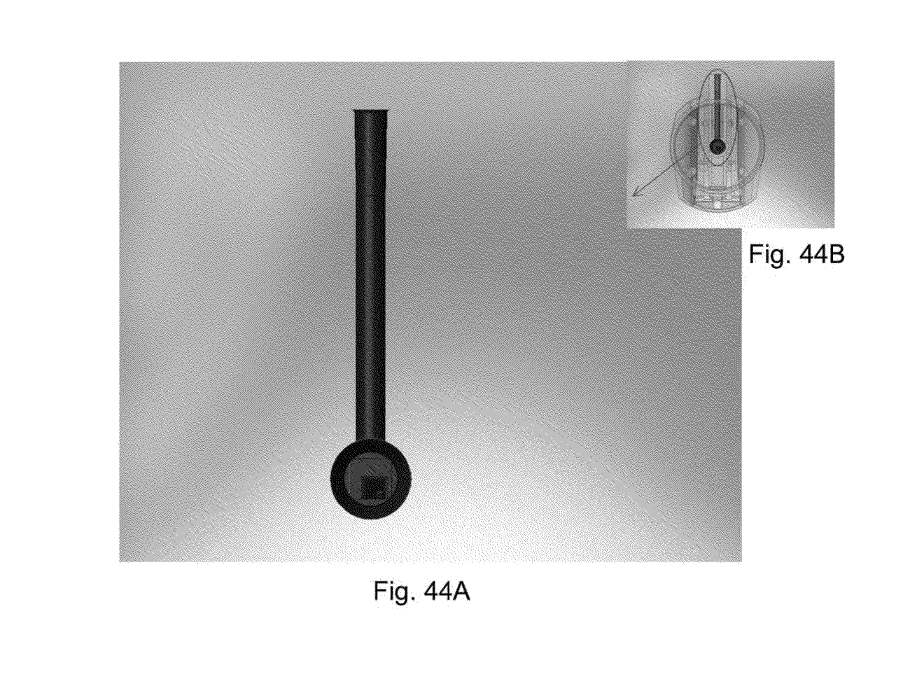

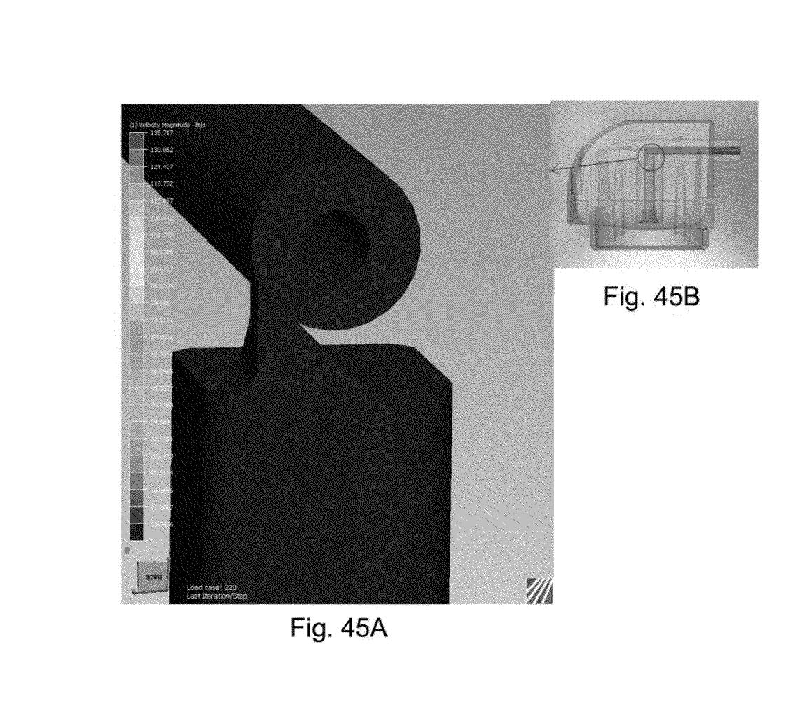

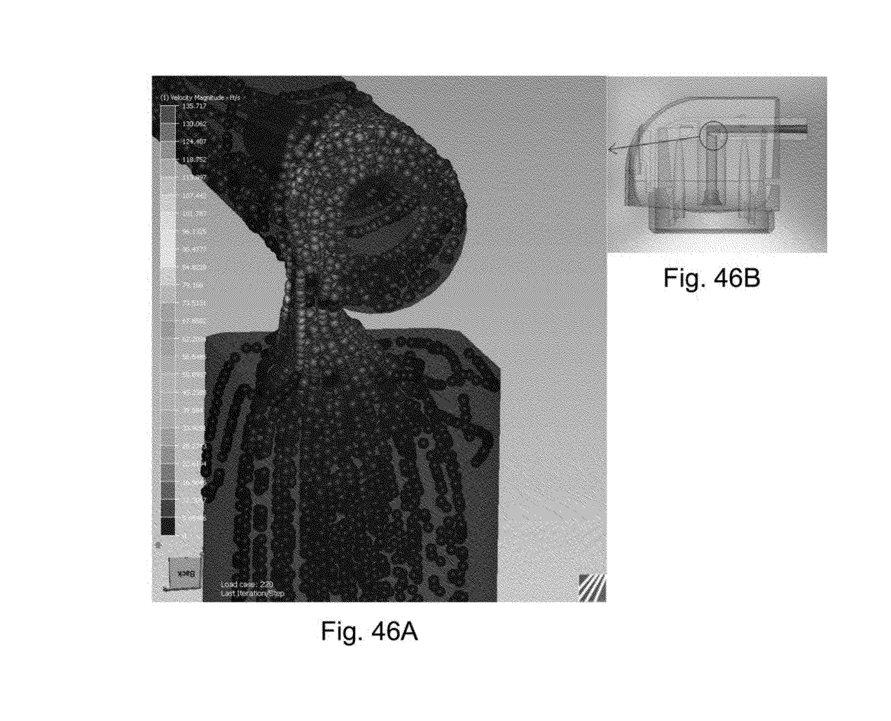

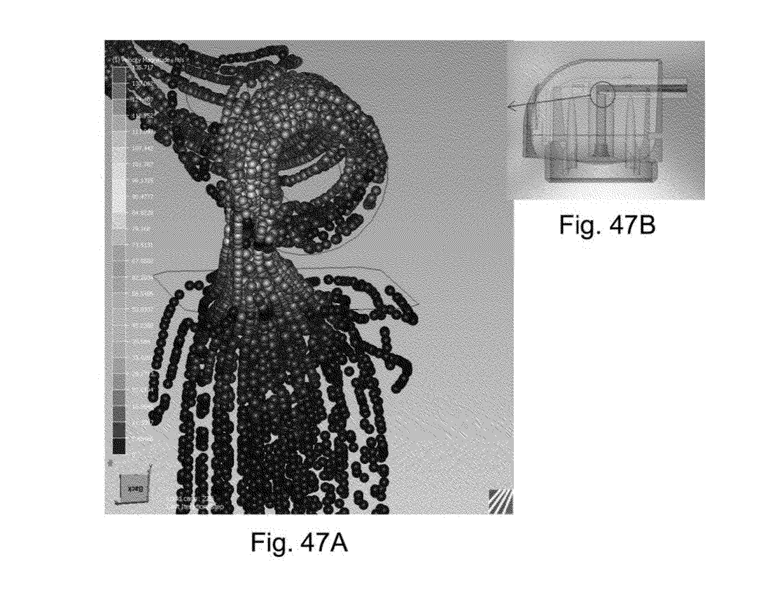

FIGS. 41 through 47 illustrate another alternate exemplary embodiment of a vortex generating system according to the present disclosure. FIG. 41 is a horizontal long tube vortex in an actuator example. FIG. 42 is an isometric view of internal volume of horizontal long tube vortex in an actuator example. FIG. 43 is a side view of internal volume of horizontal long tube vortex in an actuator example. FIG. 44 is a bottom view of internal volume of horizontal long tube vortex in an actuator example. FIG. 45 is an isometric view showing the internal volume of the horizontal long tube vortex in an actuator example in a CFD study. FIG. 46 is a transparent isometric view showing the flow of fluid of the horizontal long tube vortex in an actuator in a CFD study. FIG. 47 is a wire frame isometric view showing the flow of fluid of the horizontal long tube vortex in an actuator in a CFD study.

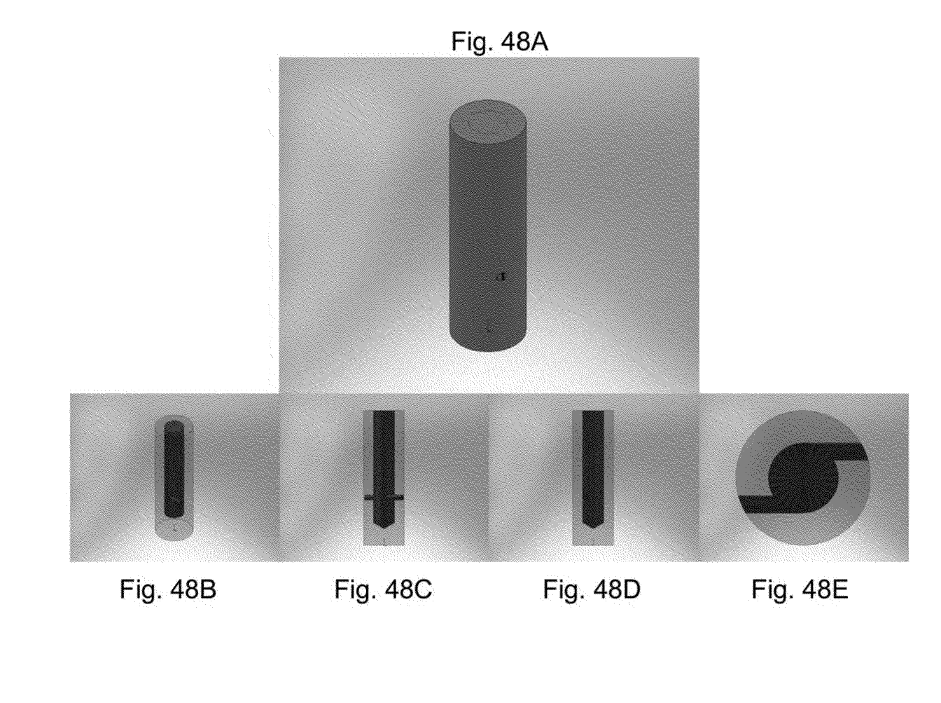

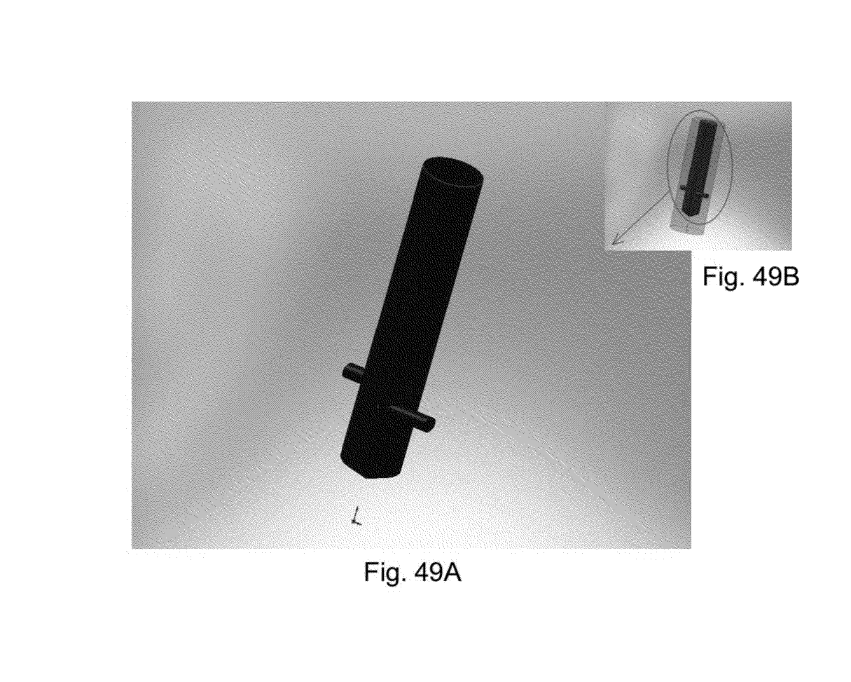

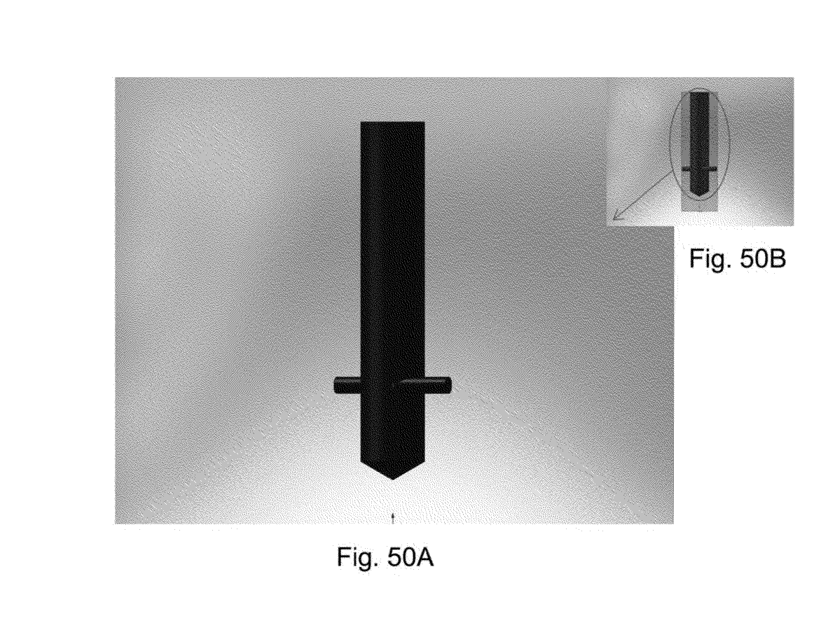

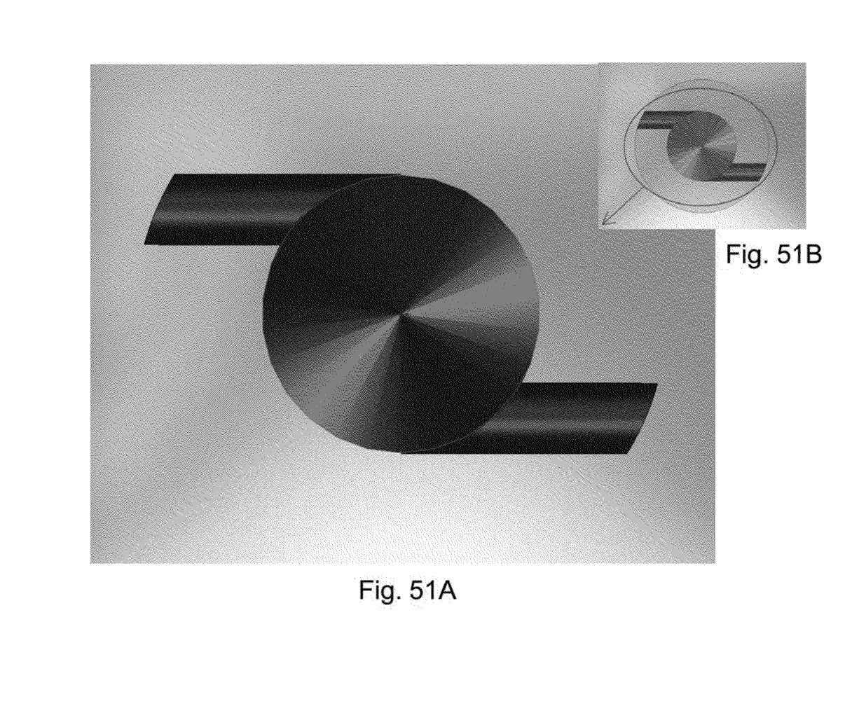

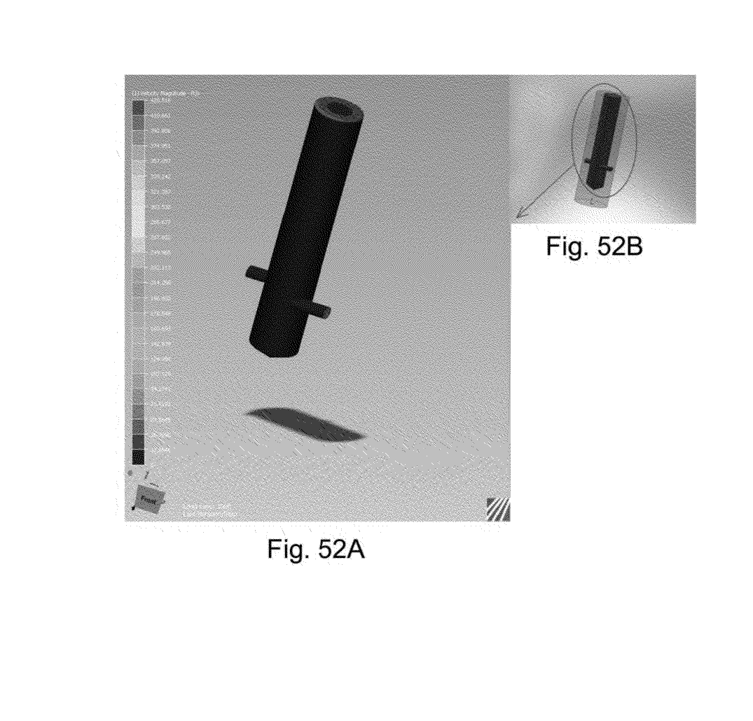

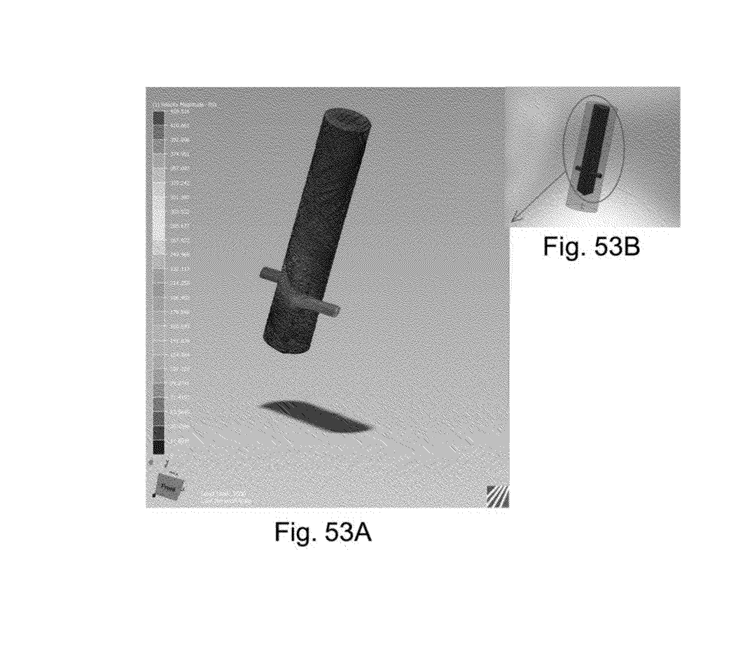

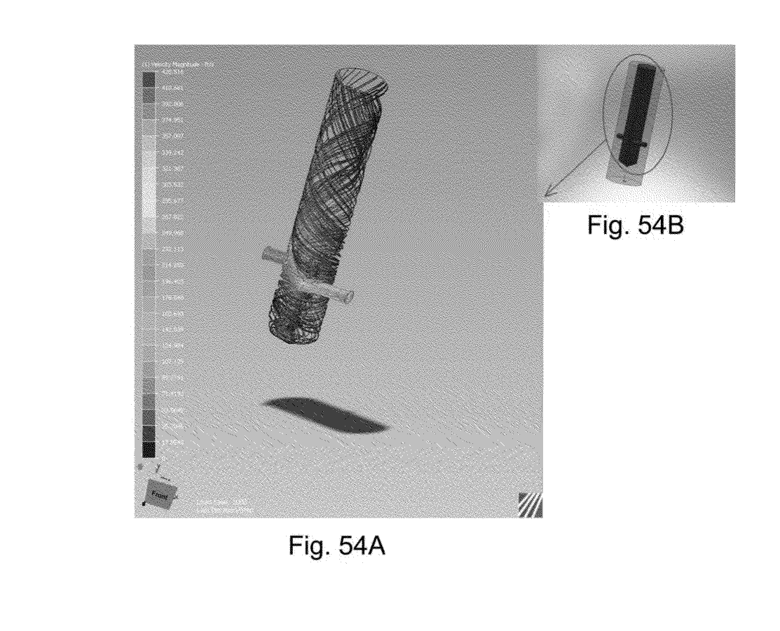

FIGS. 48 through 54 illustrate another alternate exemplary embodiment of a vortex generating system according to the present disclosure. FIG. 48 is an offset vortex geometry in a 5x test fixture. FIG. 49 is an isometric view of internal volume of offset vortex geometry in a 5x test fixture. FIG. 50 is a side view of internal volume of offset vortex geometry in a 5x test fixture. FIG. 51 is a bottom view of internal volume of offset vortex geometry in a 5x test fixture. FIG. 52 is an isometric view showing the internal volume of the offset vortex geometry in a 5x test fixture in a CFD study. FIG. 53 is a transparent view showing the flow of fluid of the offset vortex geometry in a 5x test fixture in a CFD study. FIG. 54 is a wire frame view showing the flow of fluid of the offset vortex geometry in a 5x test fixture in a CFD study.

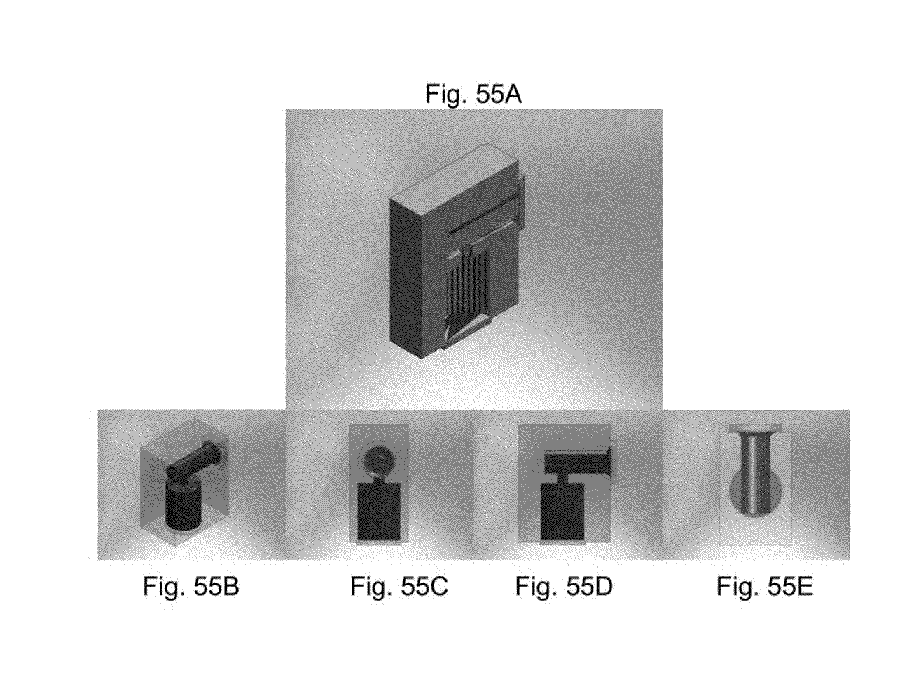

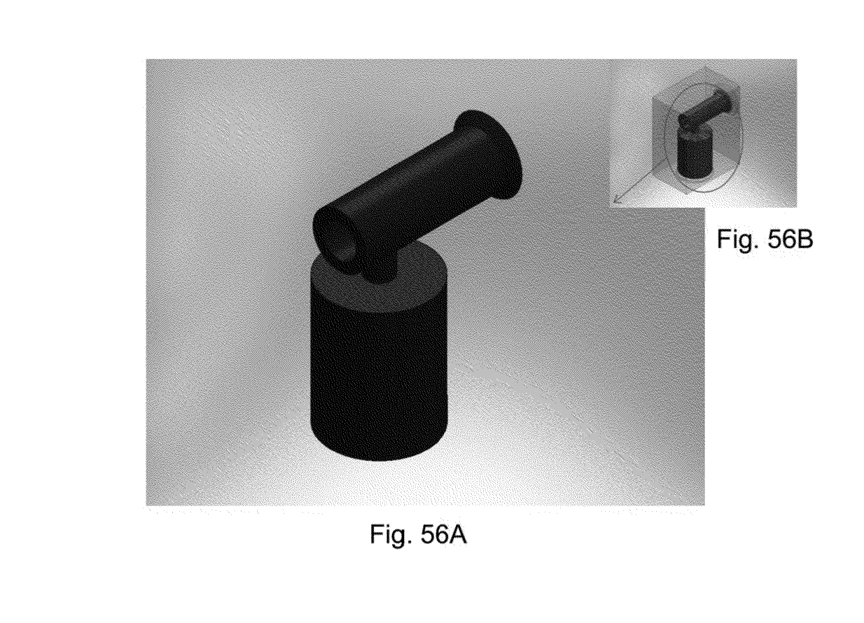

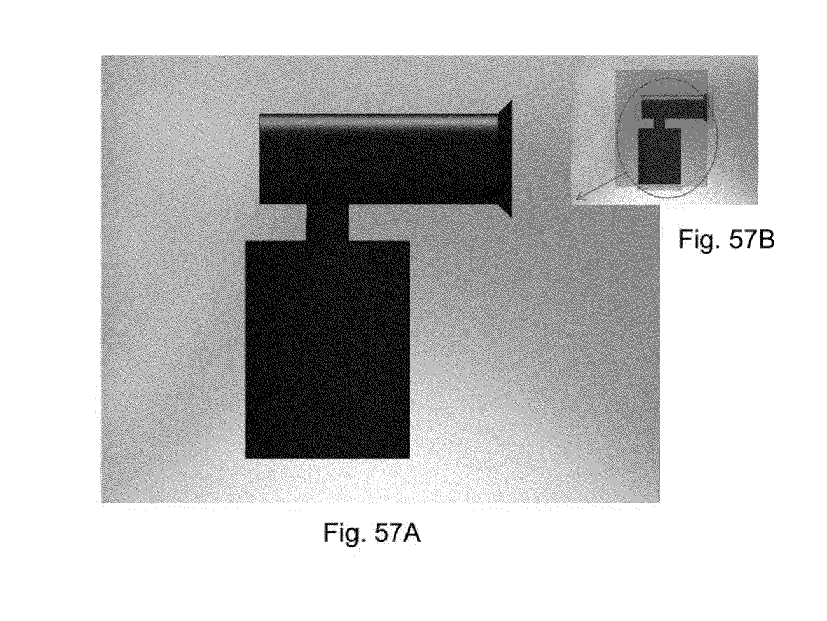

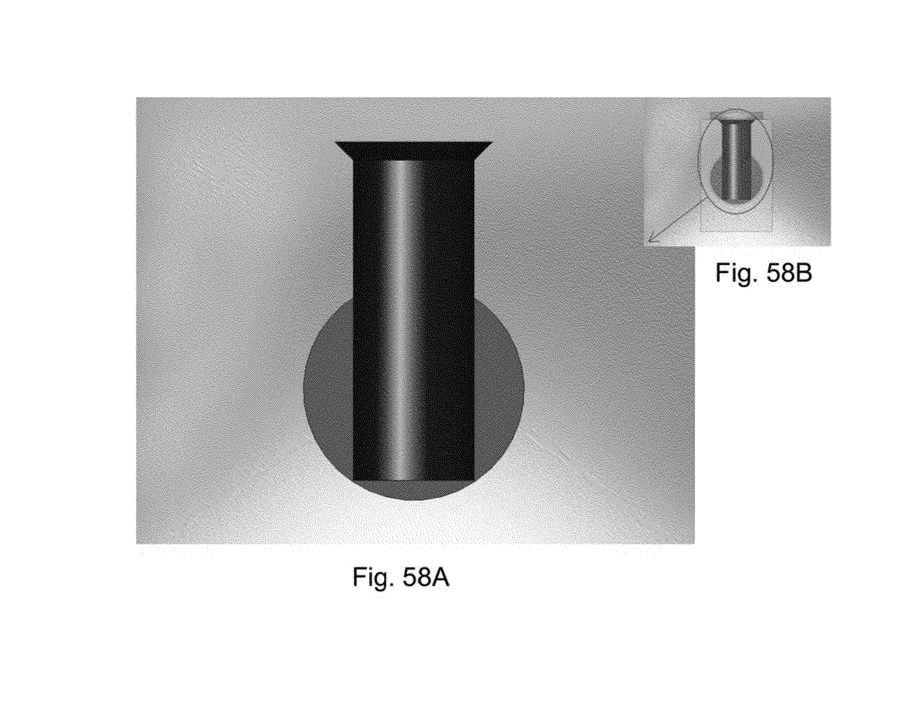

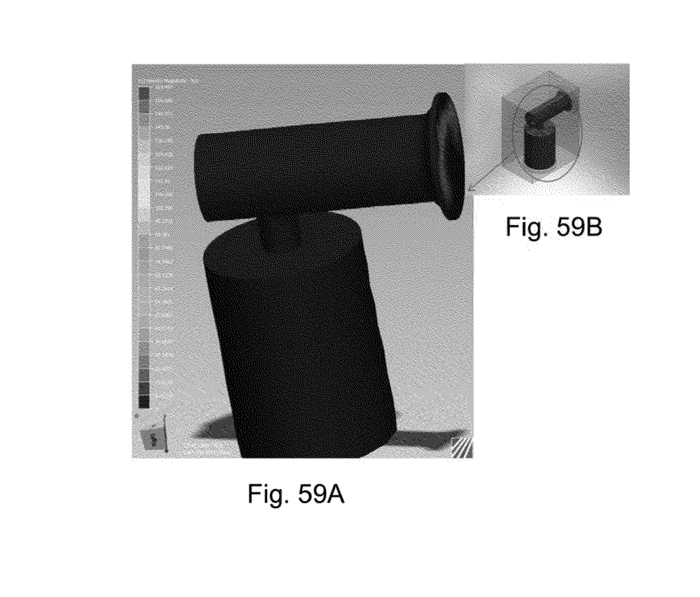

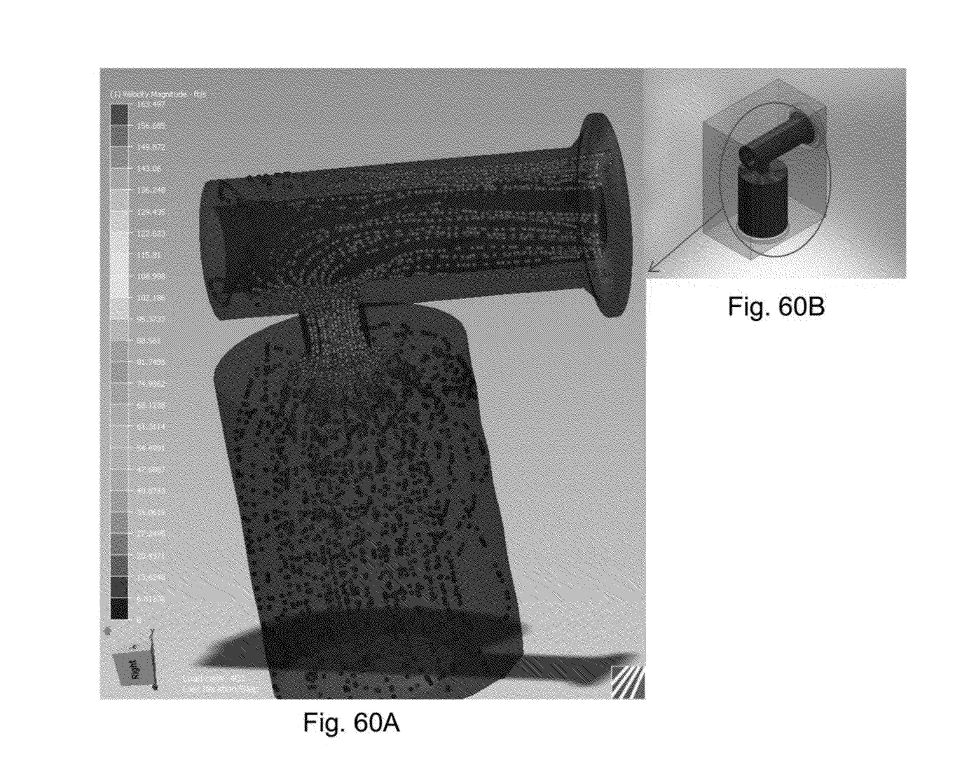

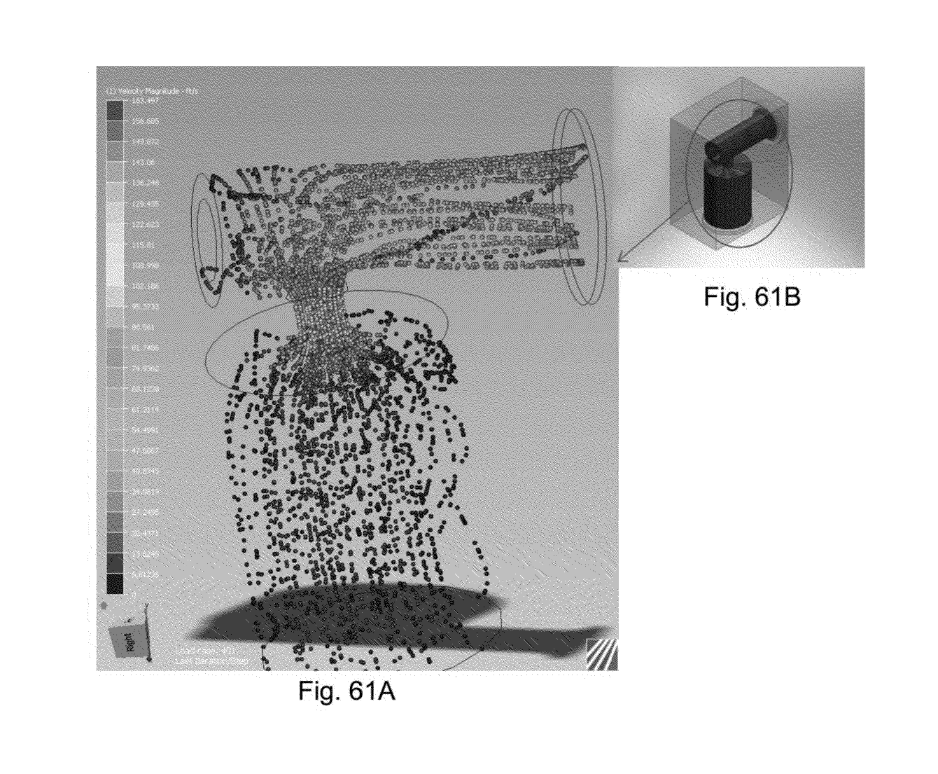

FIGS. 55 through 61 illustrate a system that fails to generate a vortex in the manner disclosed according to the present disclosure. FIG. 55 is a cross section view of a test fixture with center pin and inlet hole on center line. The design shown in FIG. 55 has no vortex created and no spray pattern induced. FIGS. 55 through 61 show that non-induced tangential flow does not create a spray pattern. FIG. 56 is an isometric view of internal volume of a test fixture with center pin and inlet hole on center line. FIG. 57 is a side view of internal volume of a test fixture with center pin and inlet hole on center line. FIG. 58 is a top view of internal volume of a test fixture with center pin and inlet hole on center line. FIG. 59 is an internal volume of a test fixture with center pin and inlet hole on center line in a CFD study. FIG. 60 is a transparent isometric view showing the flow of fluid of the early test fixture in a CFD study. FIG. 61 is a wire frame isometric view showing the flow of fluid of the early test fixture in a CFD study.

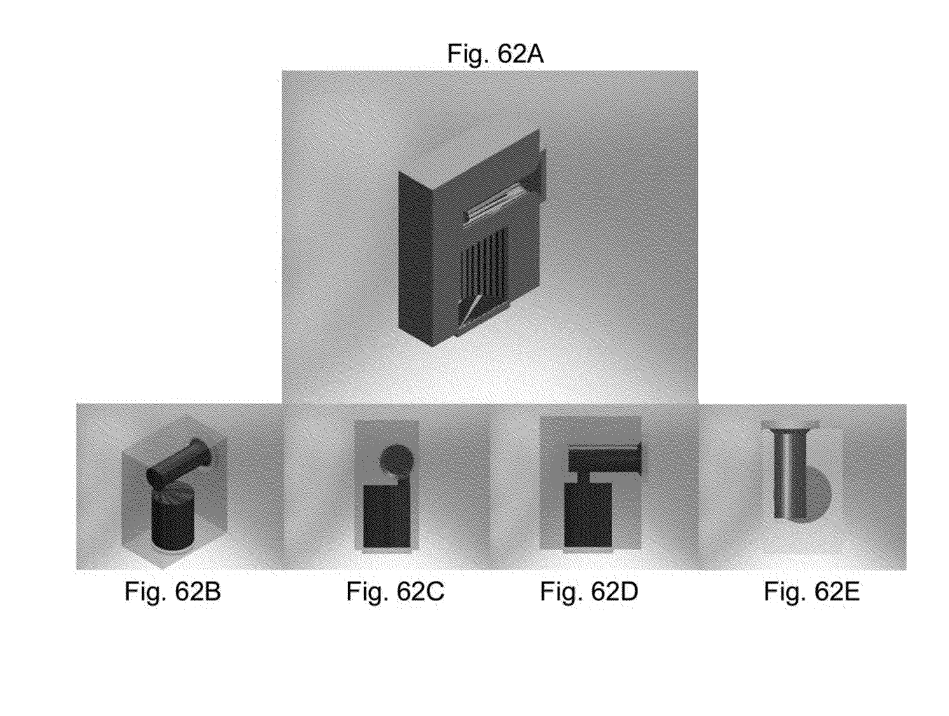

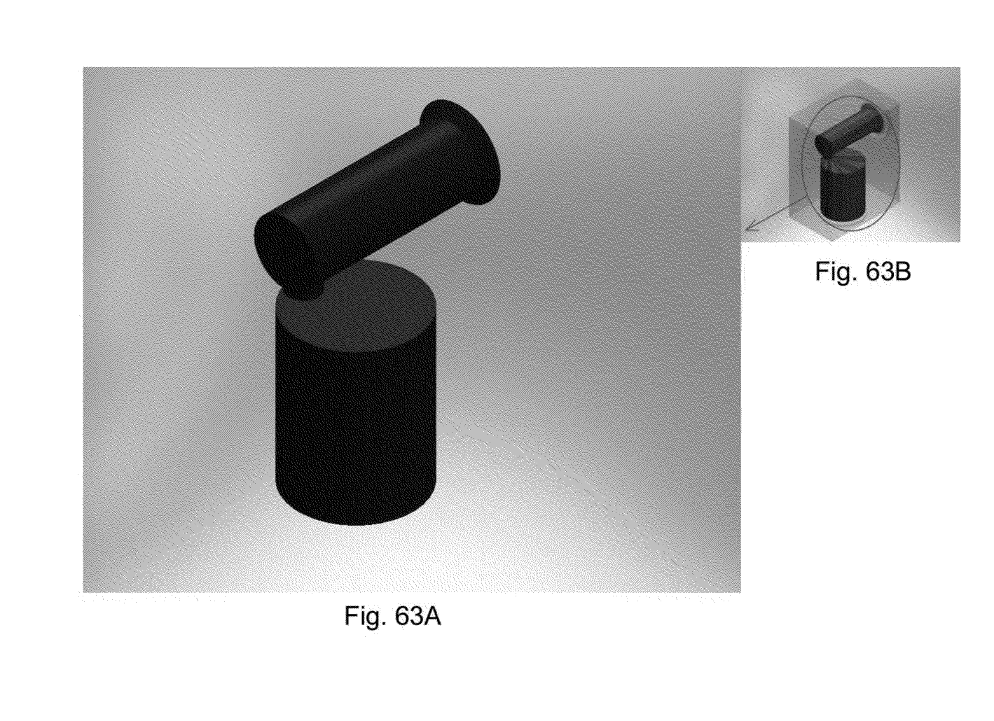

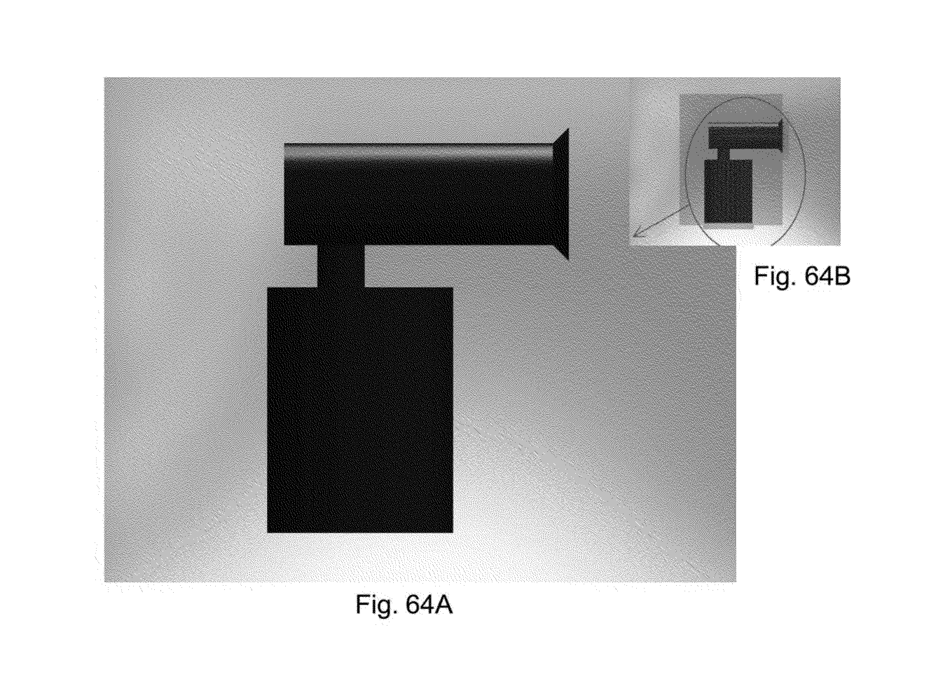

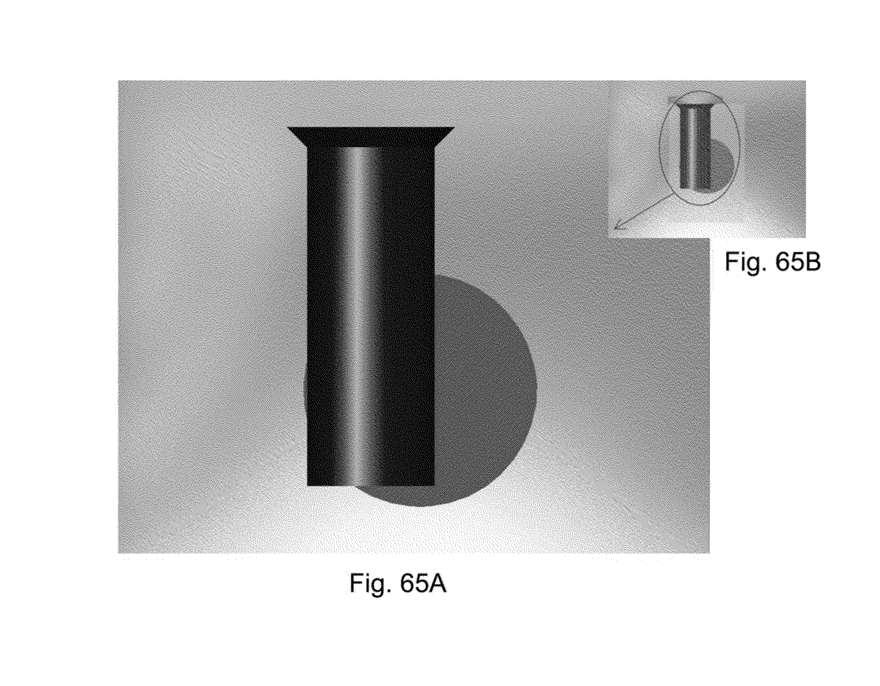

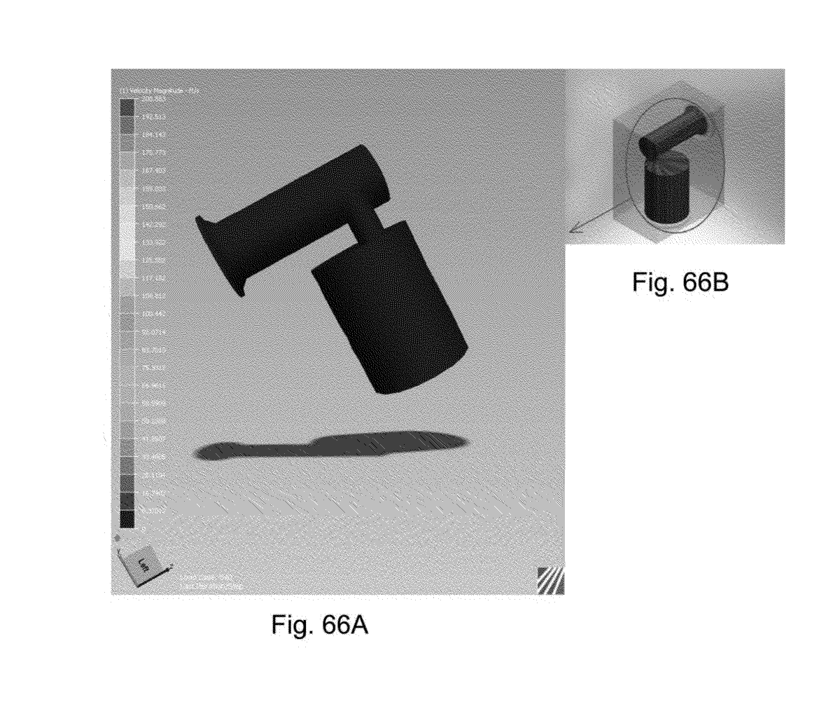

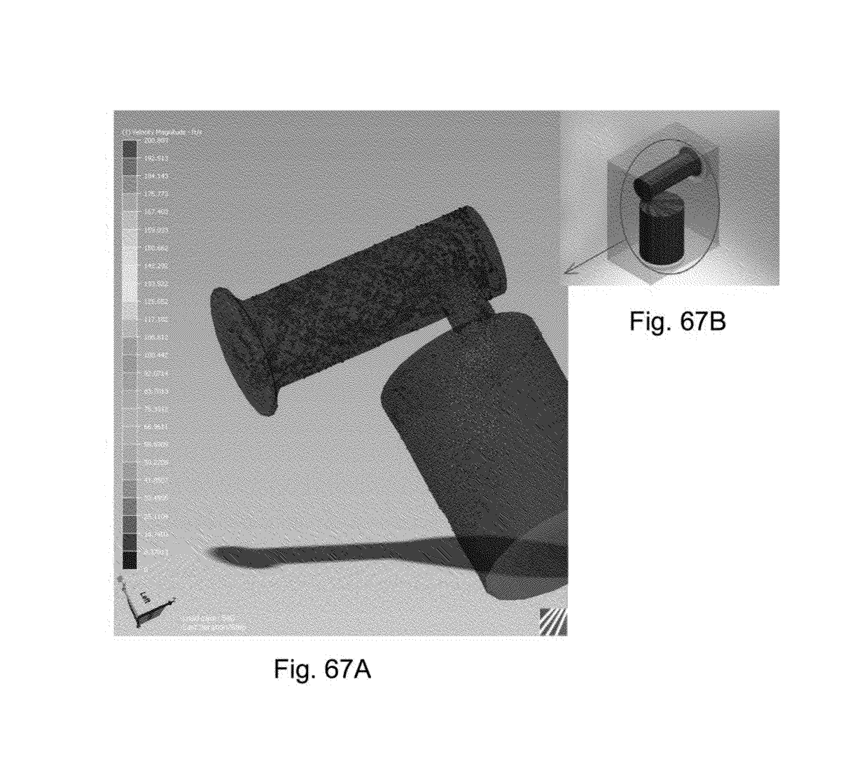

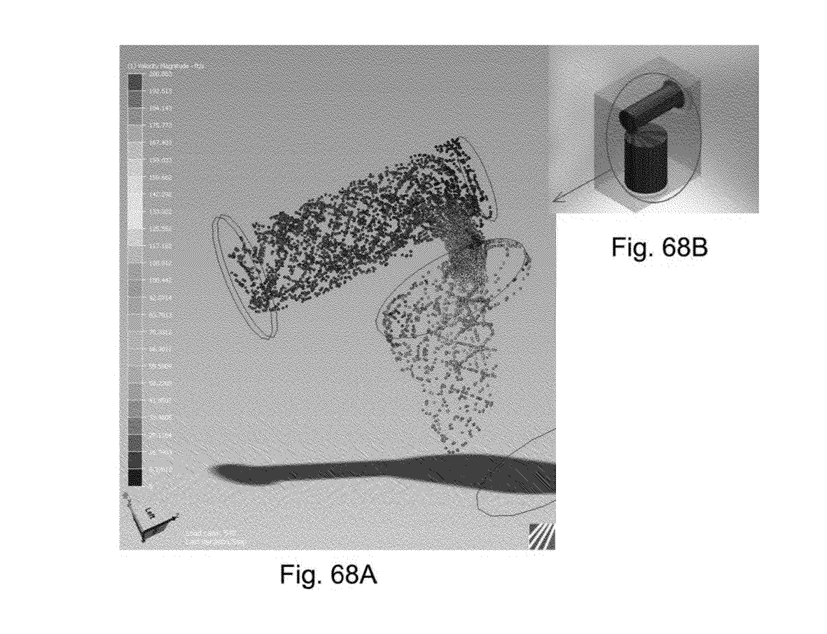

FIGS. 62 through 68 illustrate another alternate exemplary embodiment of a vortex generating system according to the present disclosure. FIG. 62 is a cross section view of a revised test fixture with no center pin and the inlet hole offset from the centerline. FIG. 63 is an isometric view of internal volume of a revised test fixture with no center pin and the inlet hole offset from the centerline. FIG. 64 is a side view of internal volume of a revised test fixture with no center pin and the inlet hole offset from the centerline. FIG. 65 is a top view of internal volume of a revised test fixture with no center pin and the inlet hole offset from the centerline. FIG. 66 illustrates internal volume of a revised test fixture with no center pin and the inlet hole offset from the centerline in a CFD study. FIG. 67 is a transparent isometric view showing the flow of fluid of a revised test fixture in a CFD study. FIG. 68 is a wire frame isometric view showing the flow of fluid of a revised test fixture in a CFD study.

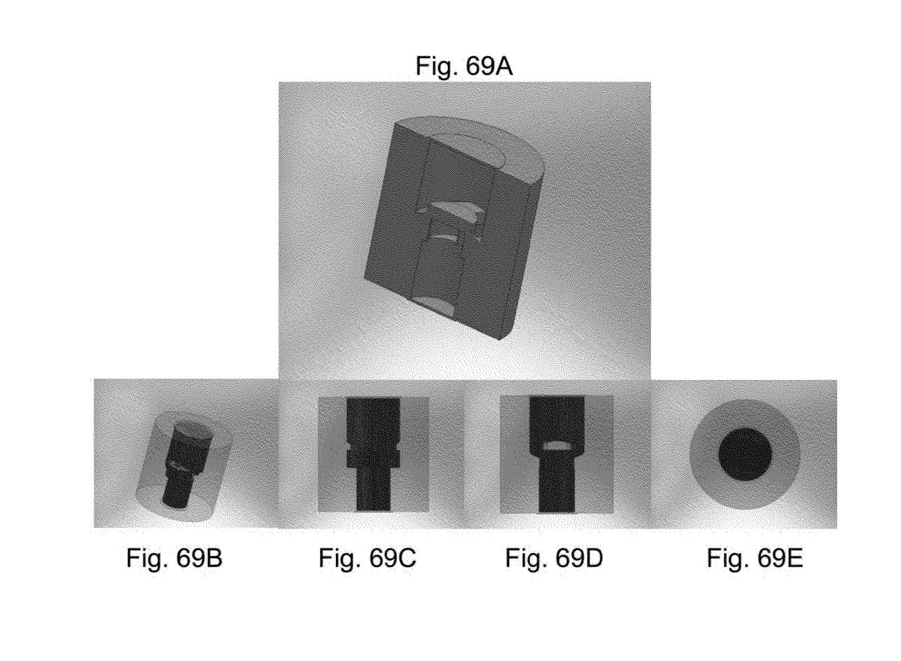

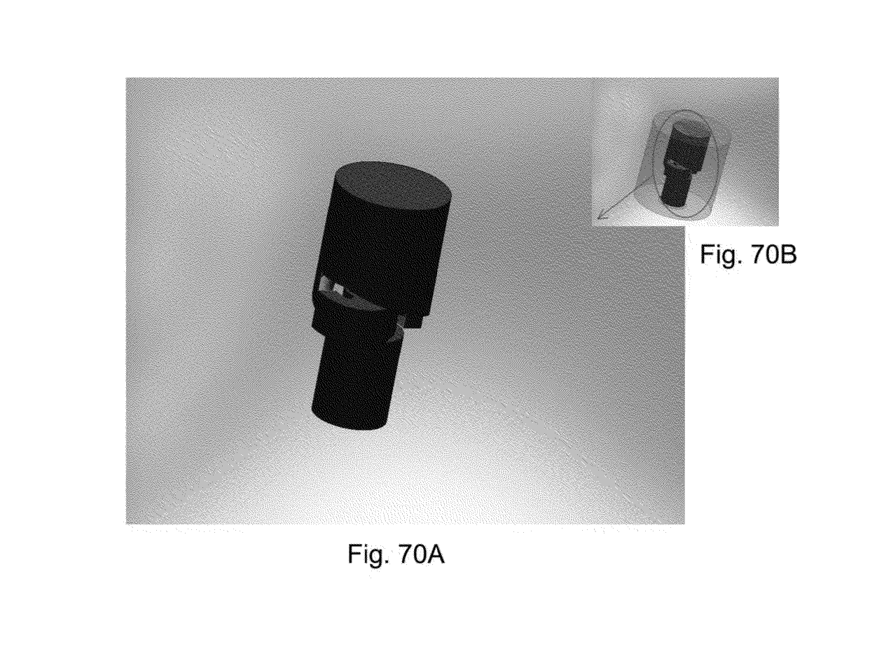

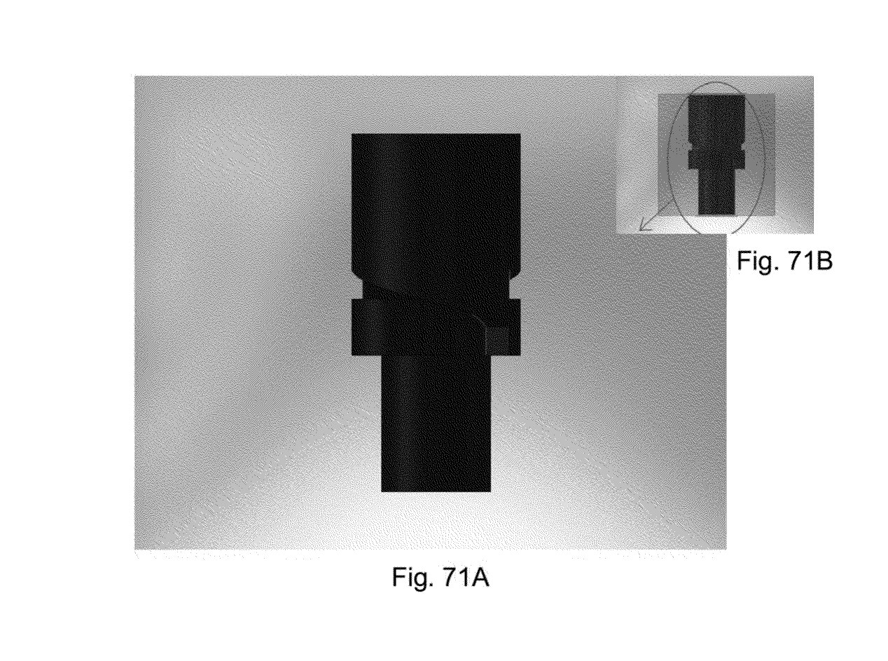

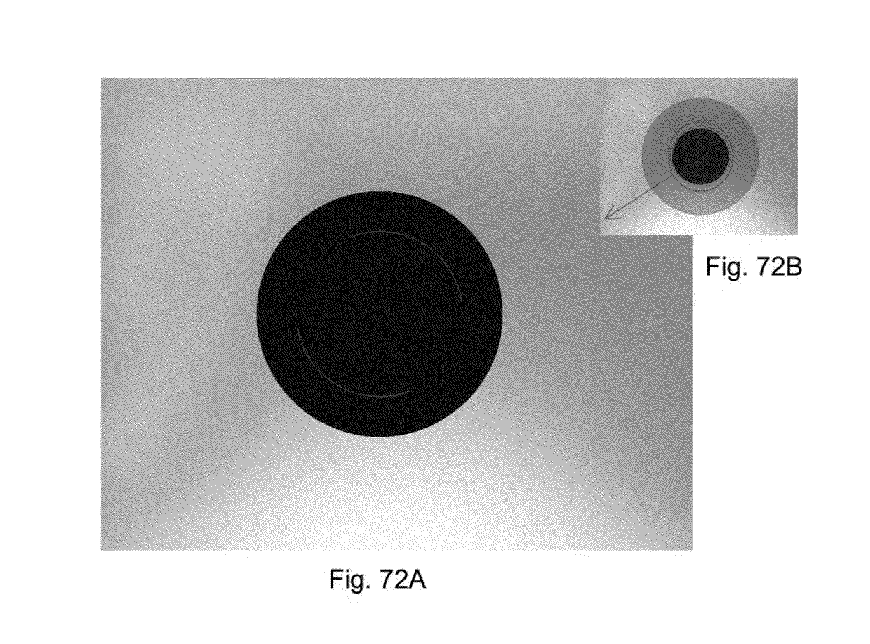

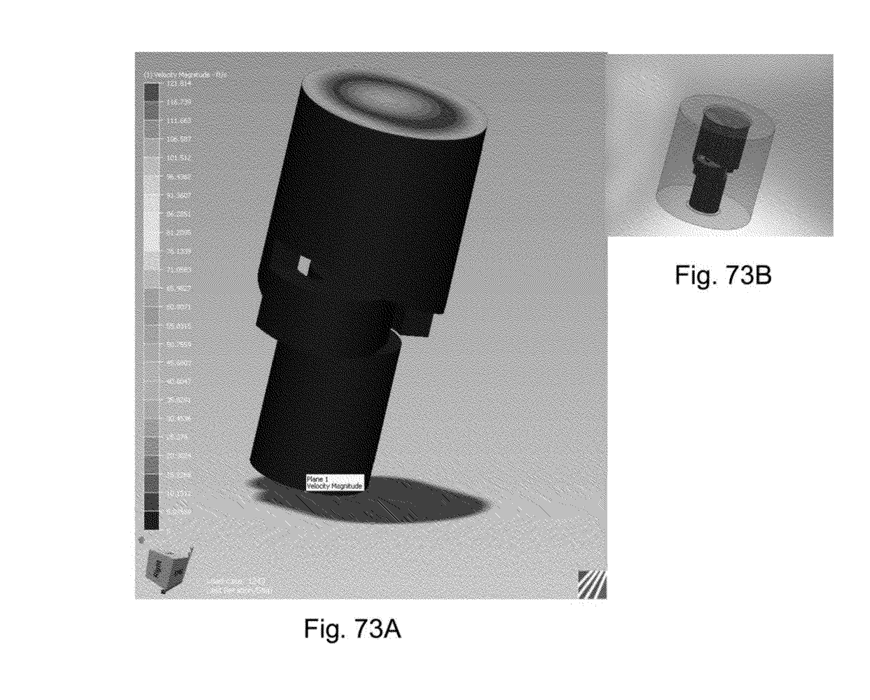

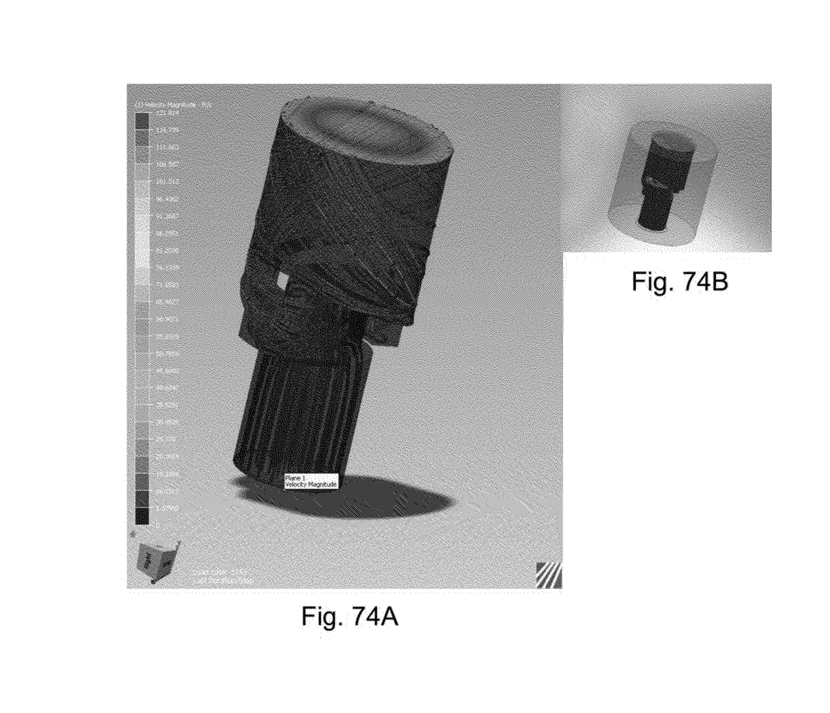

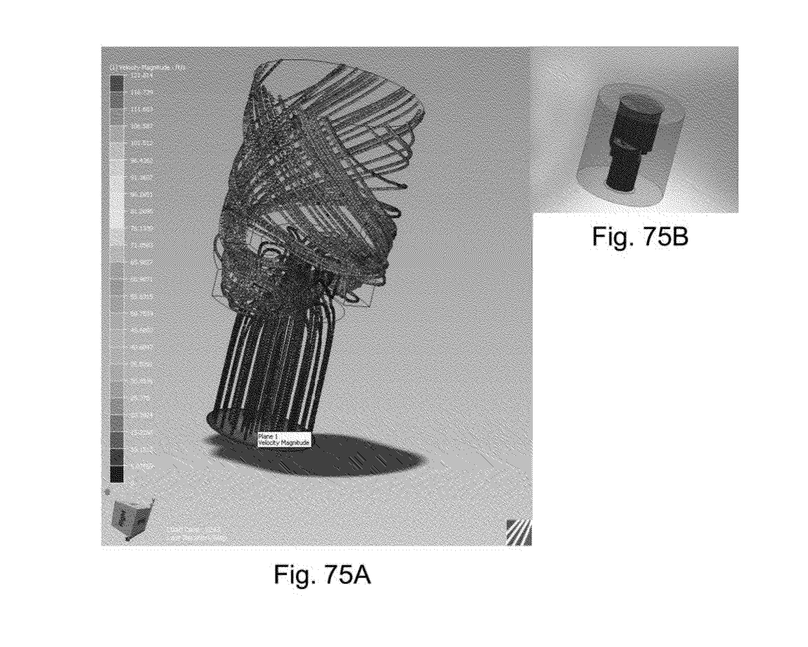

FIGS. 69 through 75 illustrate another alternate exemplary embodiment of a vortex generating system according to the present disclosure. FIG. 69 is a cross section view of a vertical test fixture with two inlets/outlets and ramps. FIG. 70 is an isometric view of internal volume of a vertical test fixture with two inlets/outlets and ramps. FIG. 71 is a side view of internal volume of a vertical test fixture with two inlets/outlets and ramps. FIG. 72 is a bottom view of internal volume of a vertical test fixture with two inlets/outlets and ramps. FIG. 73 illustrates internal volume of a vertical test fixture with two inlets/outlets and ramps in a CFD study. FIG. 74 is a transparent isometric view showing the flow of fluid of a vertical test fixture with two inlets/outlets and ramps in a CFD study. FIG. 75 is a wire frame isometric view showing the flow of fluid of a vertical test fixture with two inlets/outlets and ramps in a CFD study.

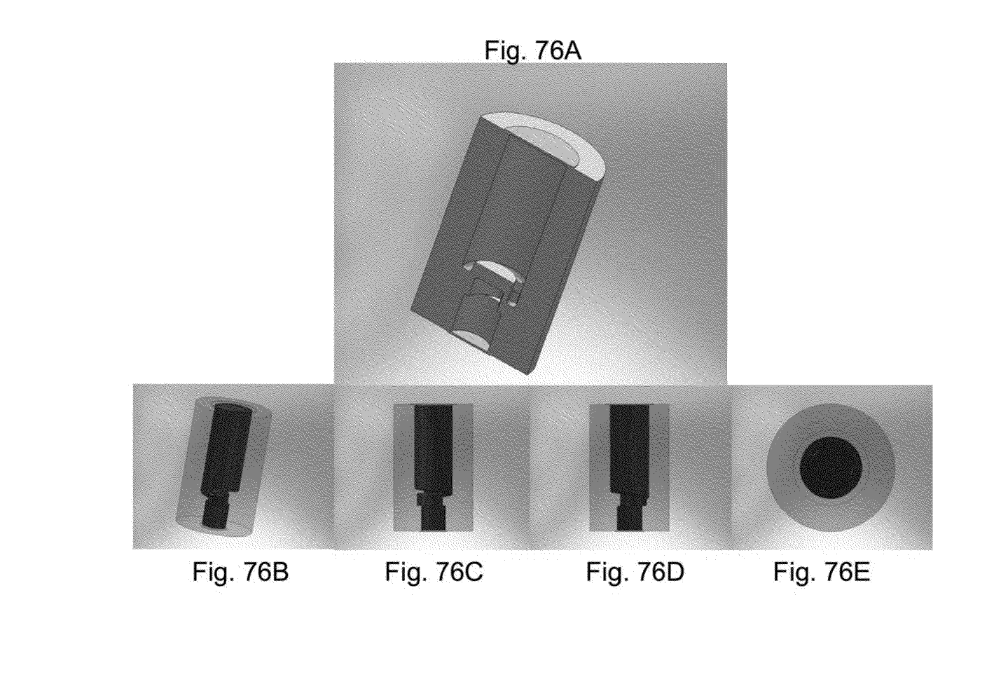

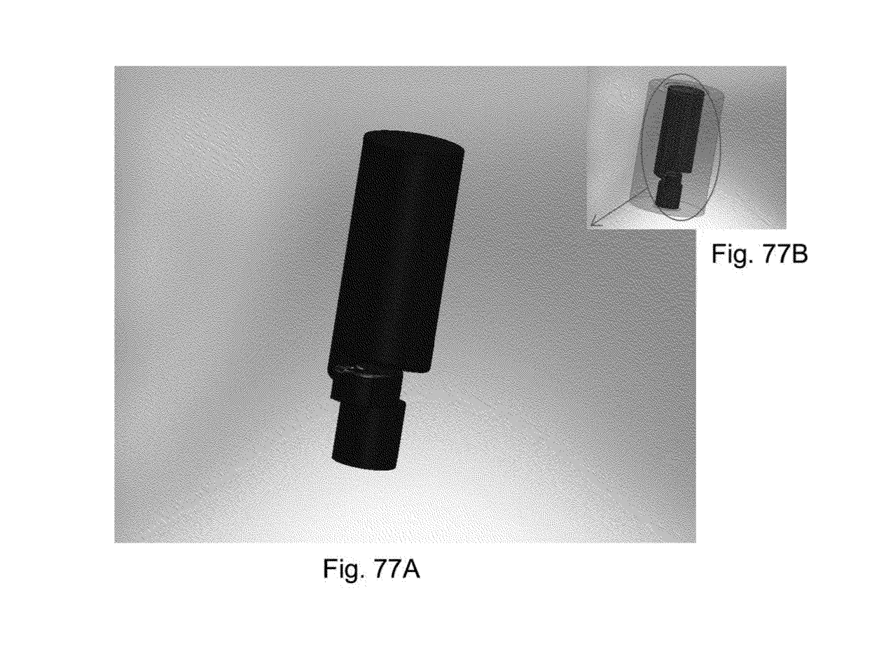

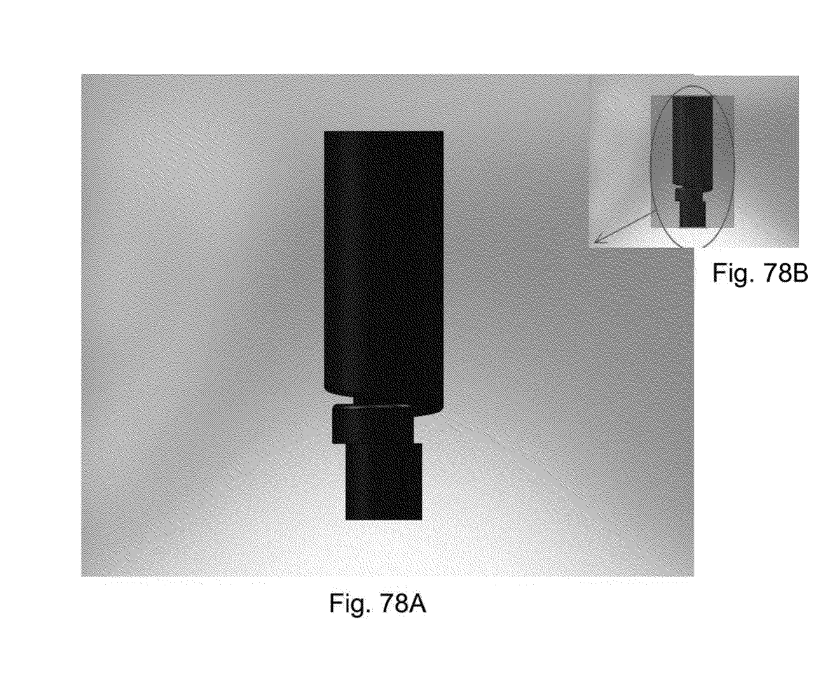

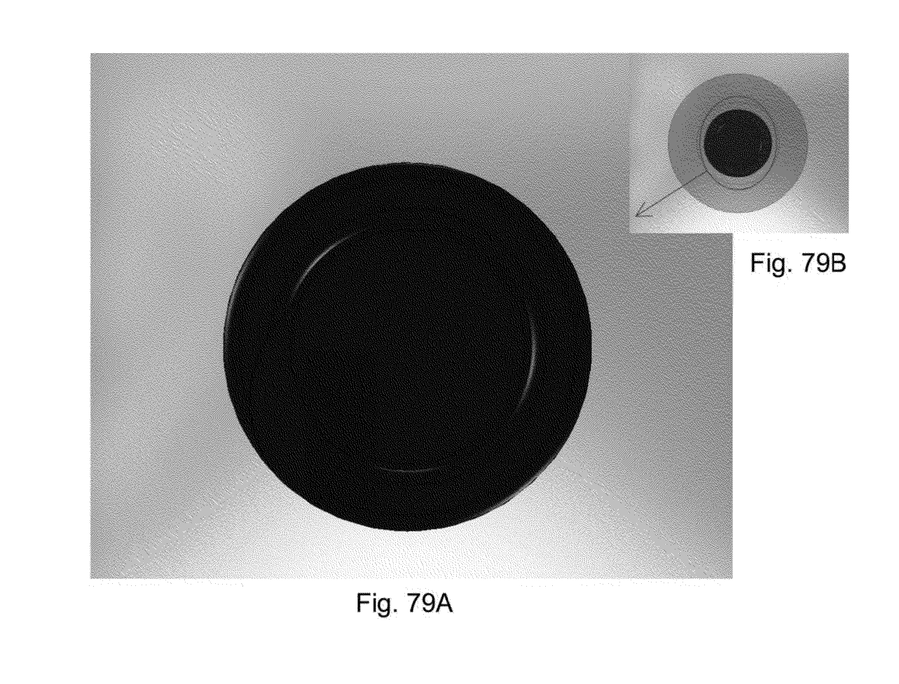

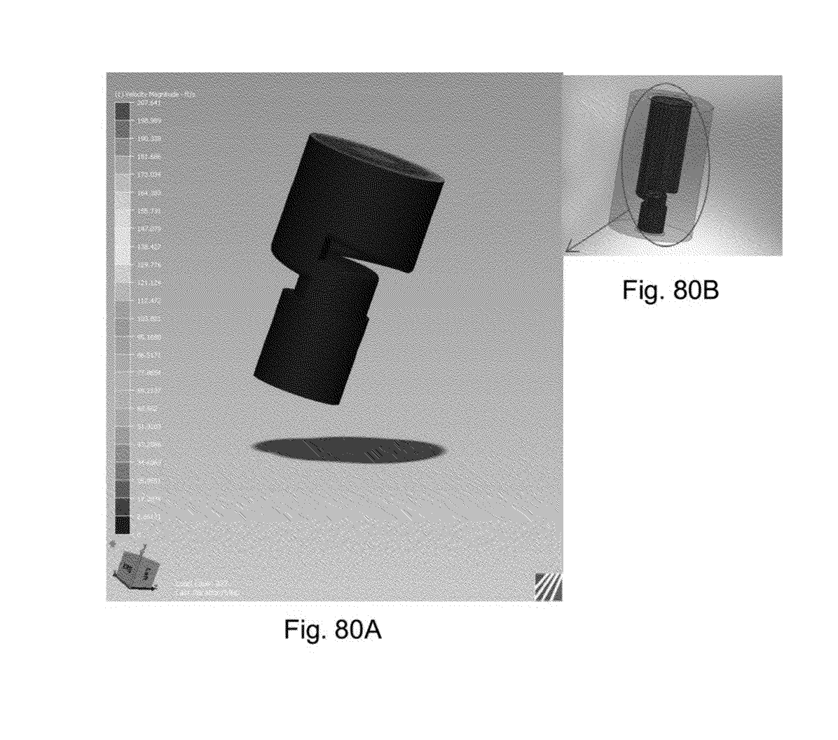

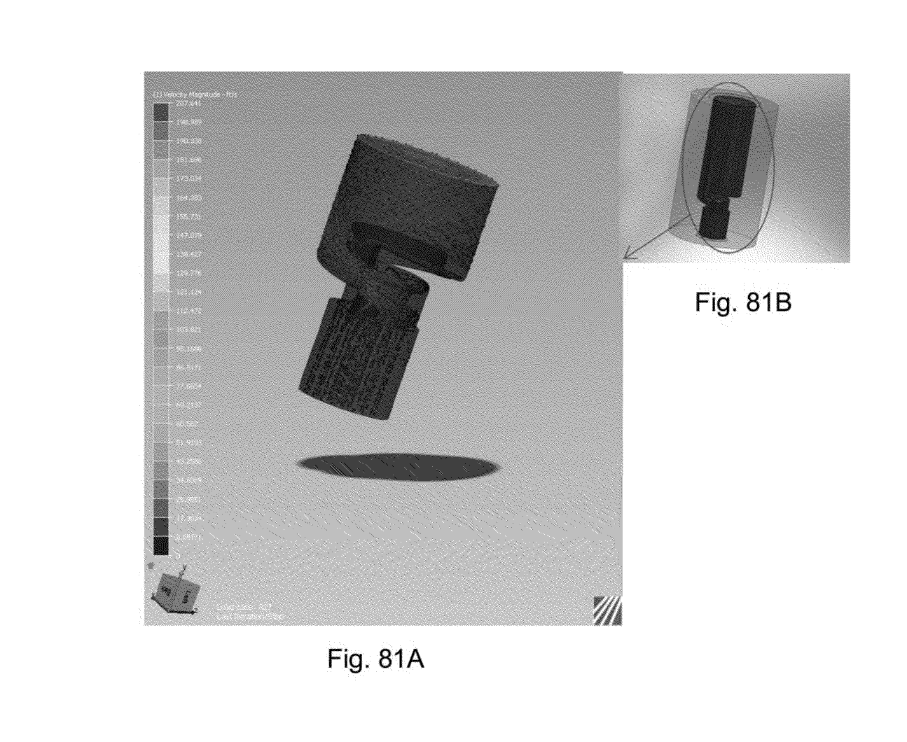

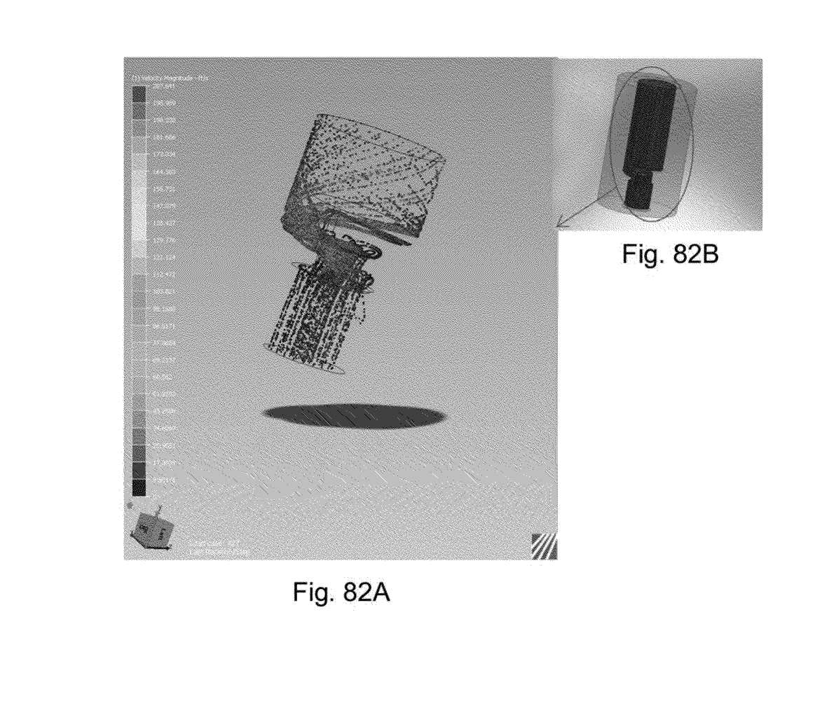

FIGS. 76 through 82 illustrate another alternate exemplary embodiment of a vortex generating system according to the present disclosure. FIG. 76 is a cross section view of a vertical test fixture with one inlet/outlet and ramp. FIG. 77 is an isometric view of the internal volume of a vertical test fixture with one inlet/outlet and ramp. FIG. 78 is a side view of the internal volume of a vertical test fixture with one inlet/outlet and ramp. FIG. 79 is a bottom view of the internal volume of a vertical test fixture with one inlet/outlet and ramp. FIG. 80 illustrates internal volume of a vertical test fixture with one inlet/outlet and ramp in a CFD study. FIG. 81 is a transparent isometric view showing the flow of fluid of a vertical test fixture with one inlet/outlet and ramp in a CFD study. FIG. 82 is a wire frame isometric view showing the flow of fluid of a vertical test fixture with one inlet/outlet and ramp in a CFD study.

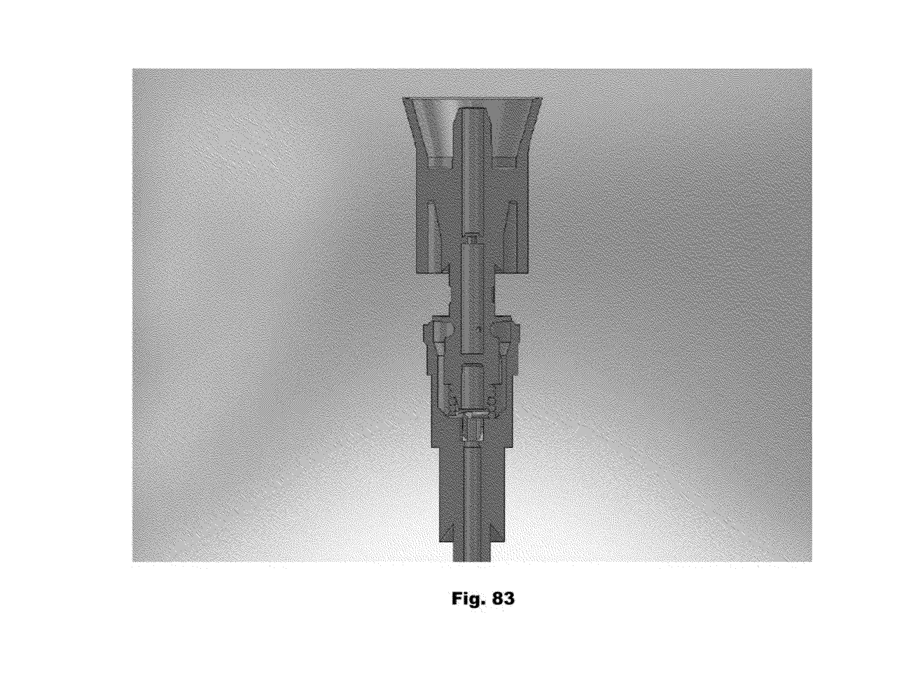

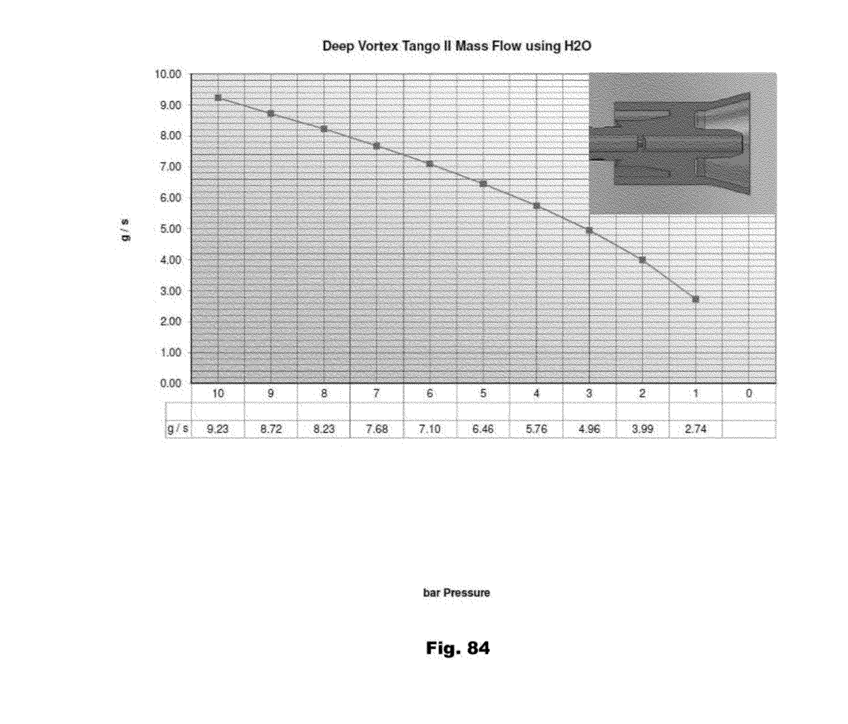

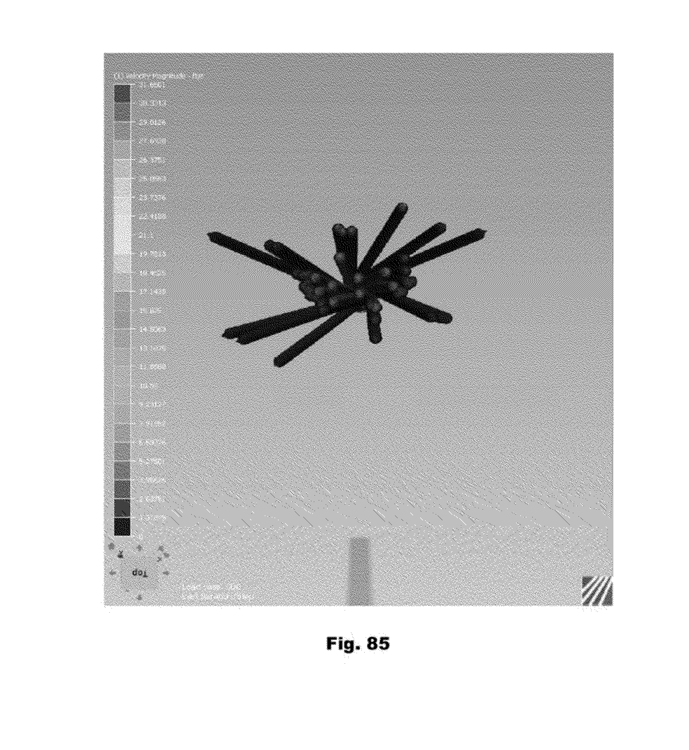

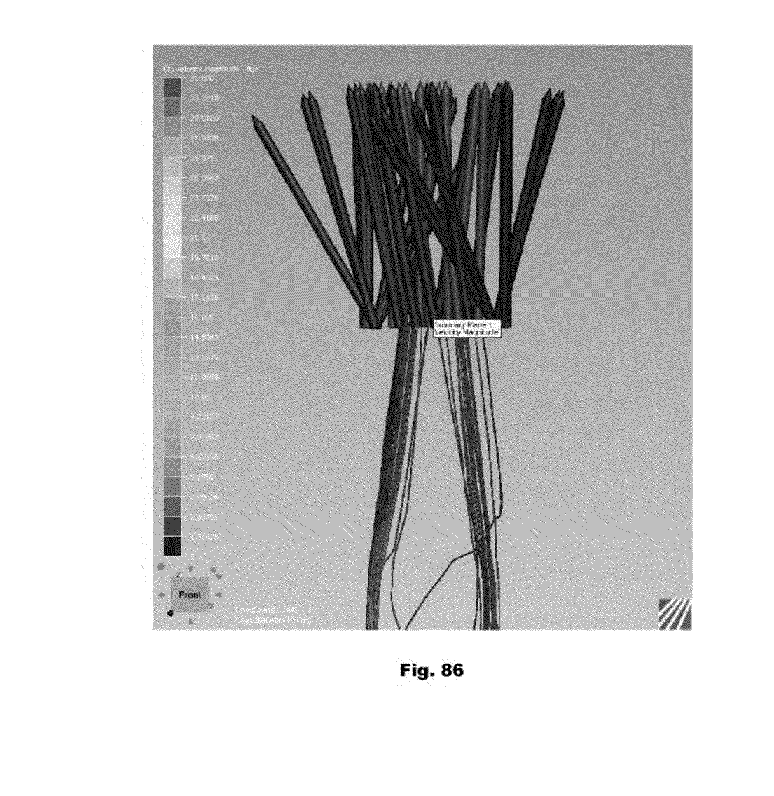

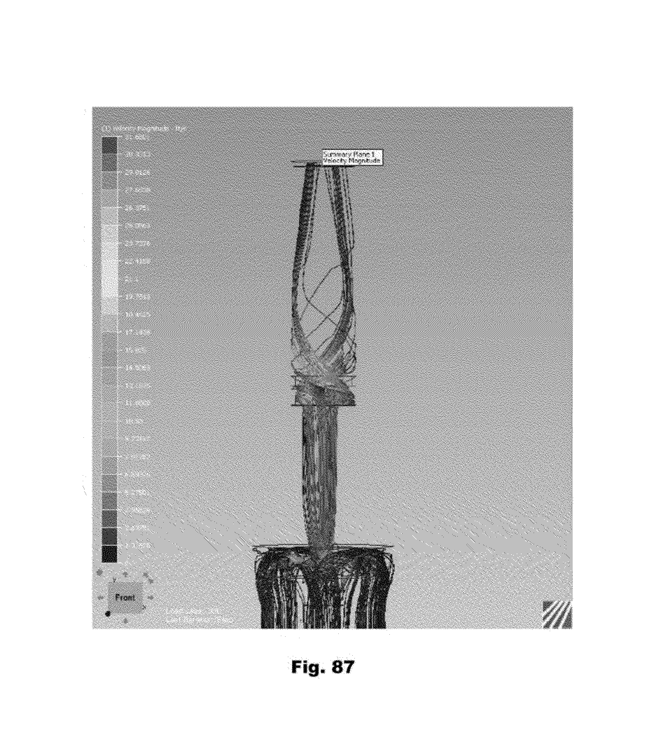

FIGS. 83 through 87 illustrate still another alternate exemplary embodiment of a vortex generating system according to the present disclosure.

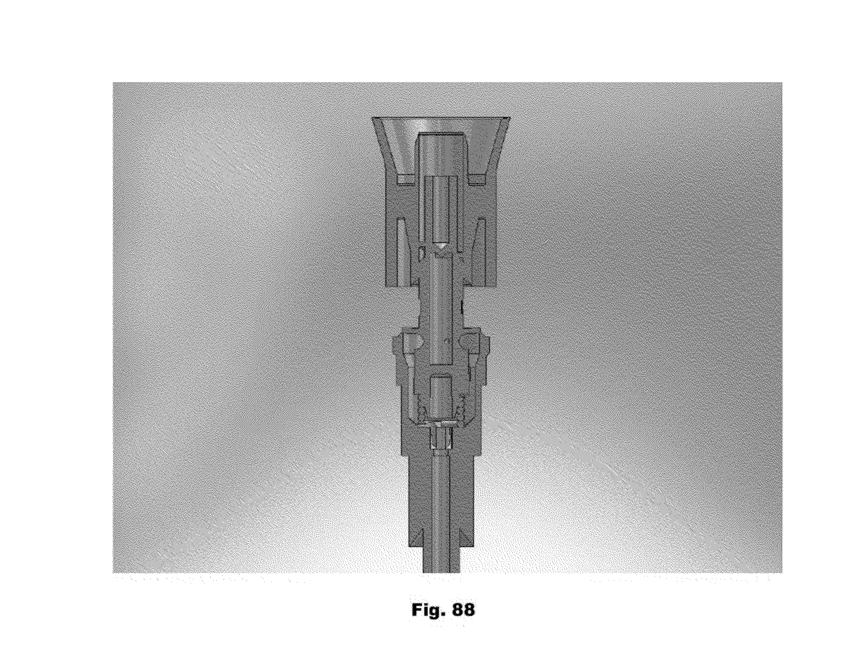

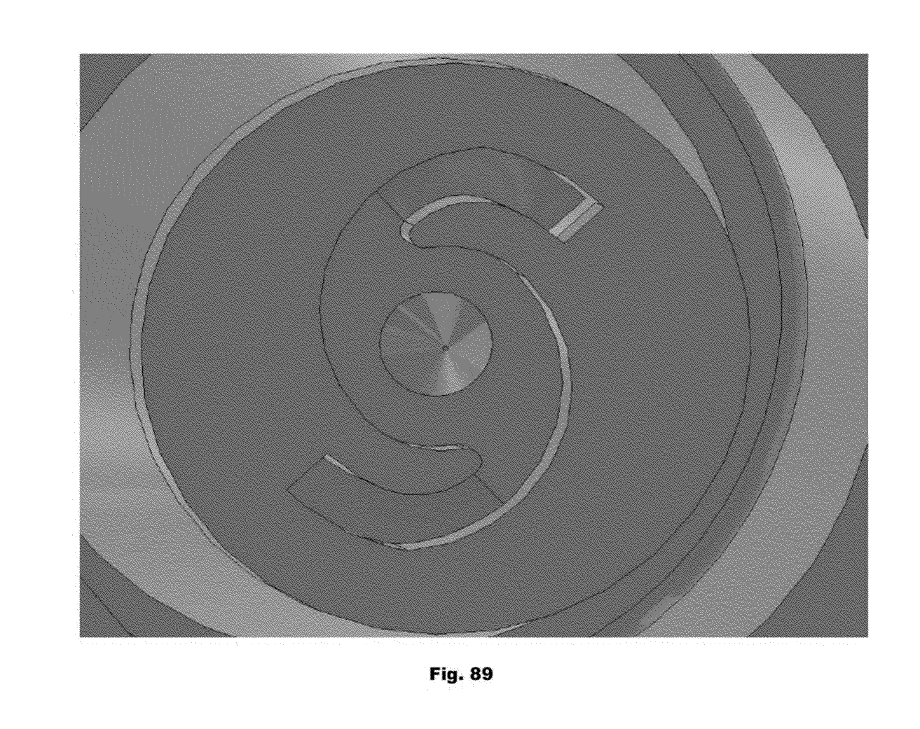

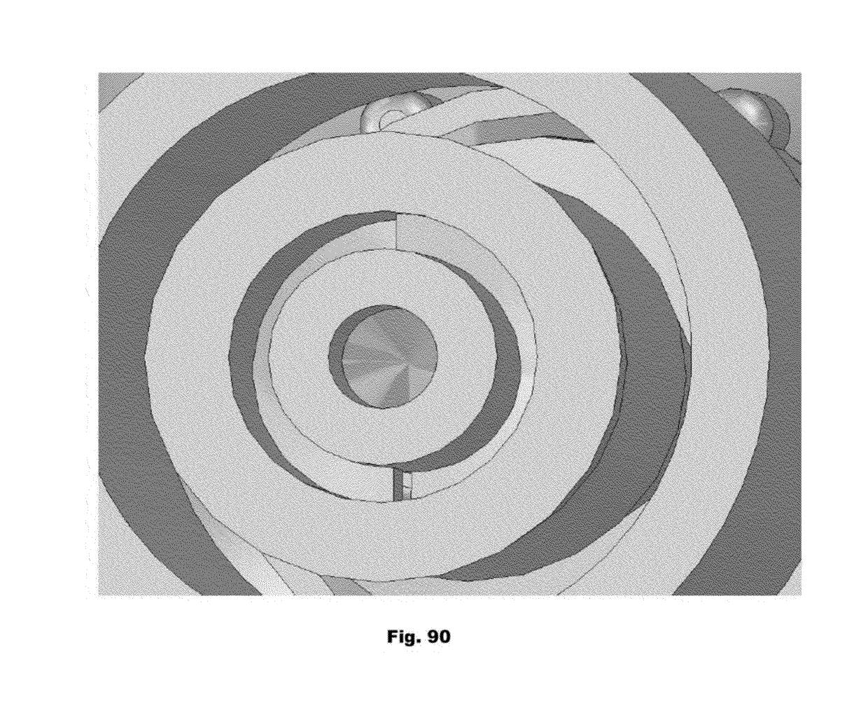

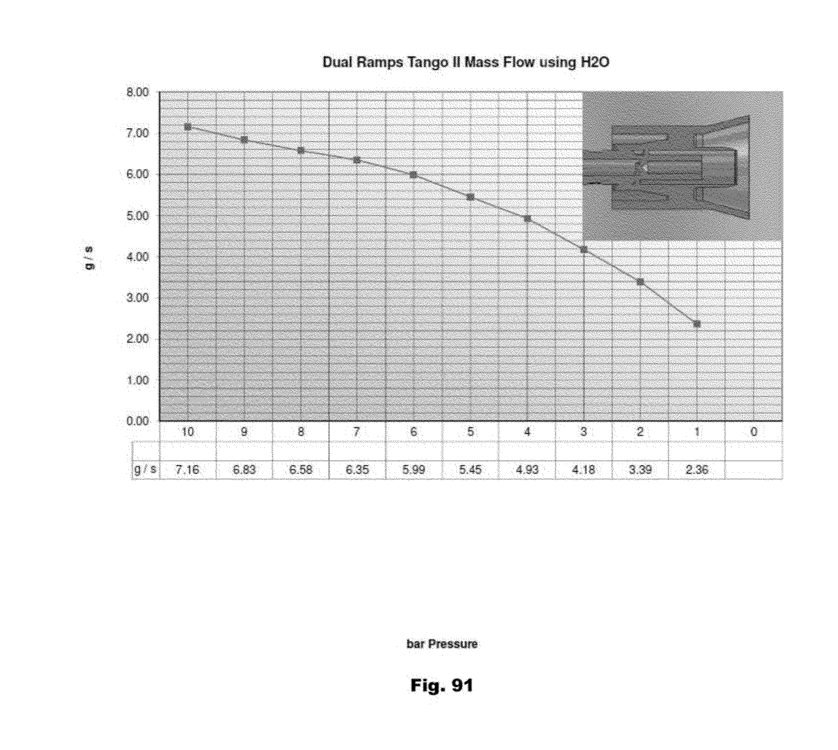

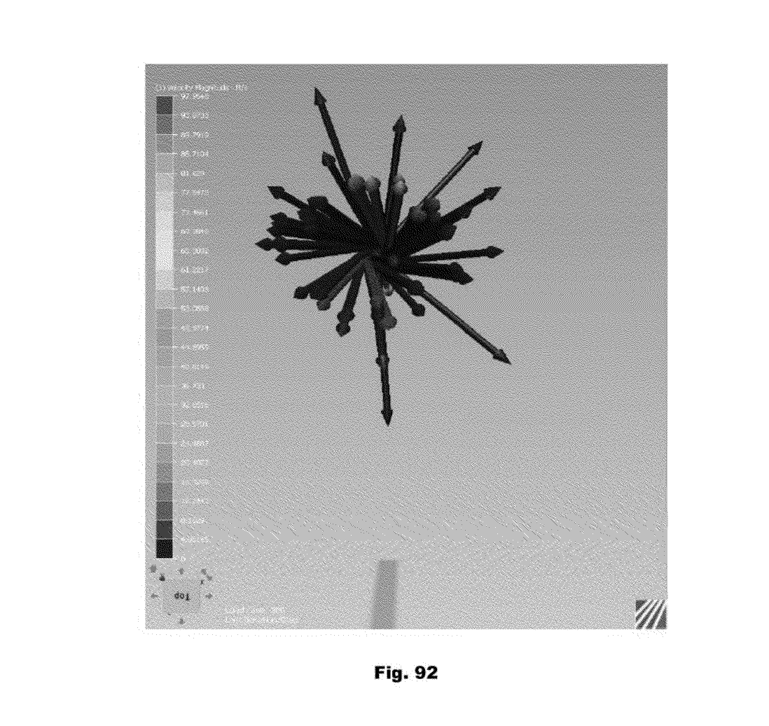

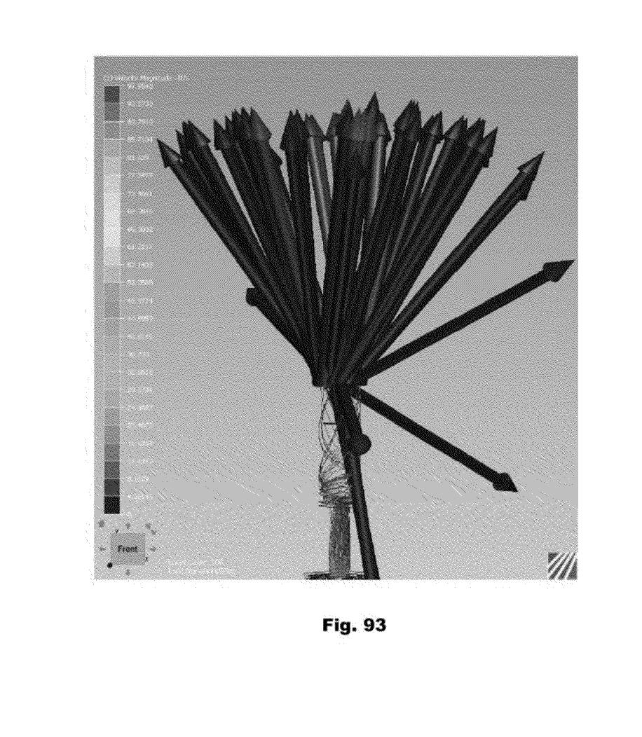

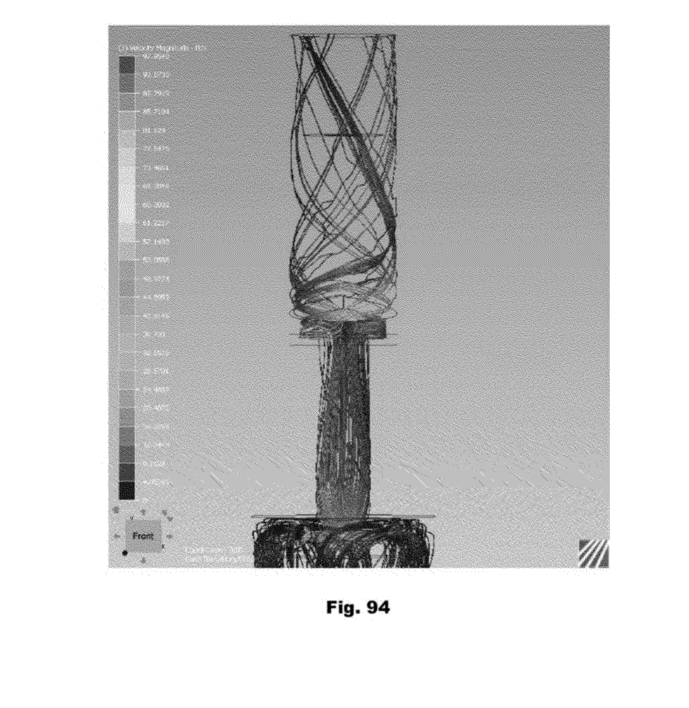

FIGS. 88 through 94 illustrate a further exemplary embodiment of a vortex generating system according to the present disclosure.

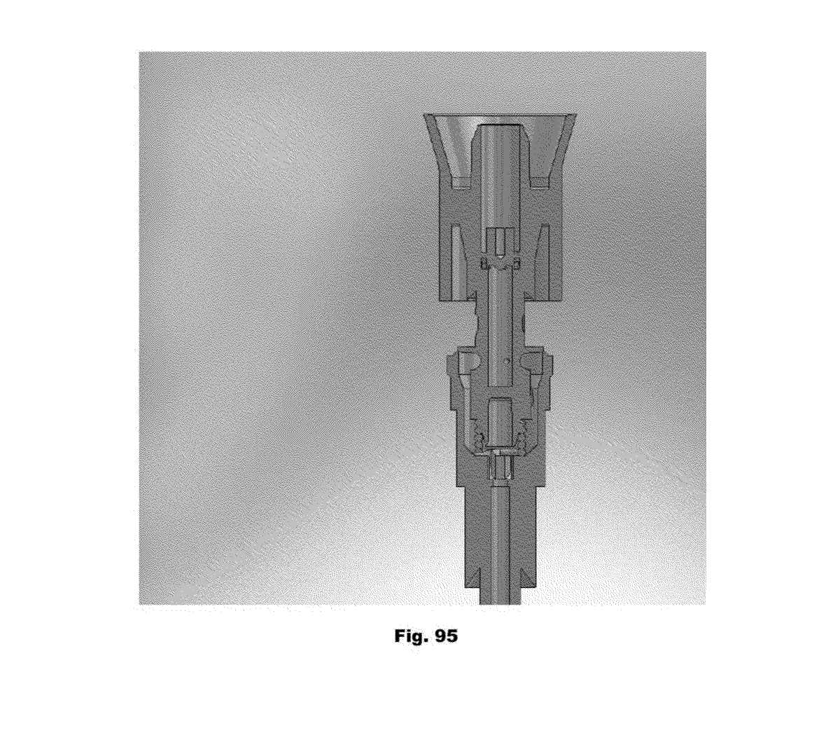

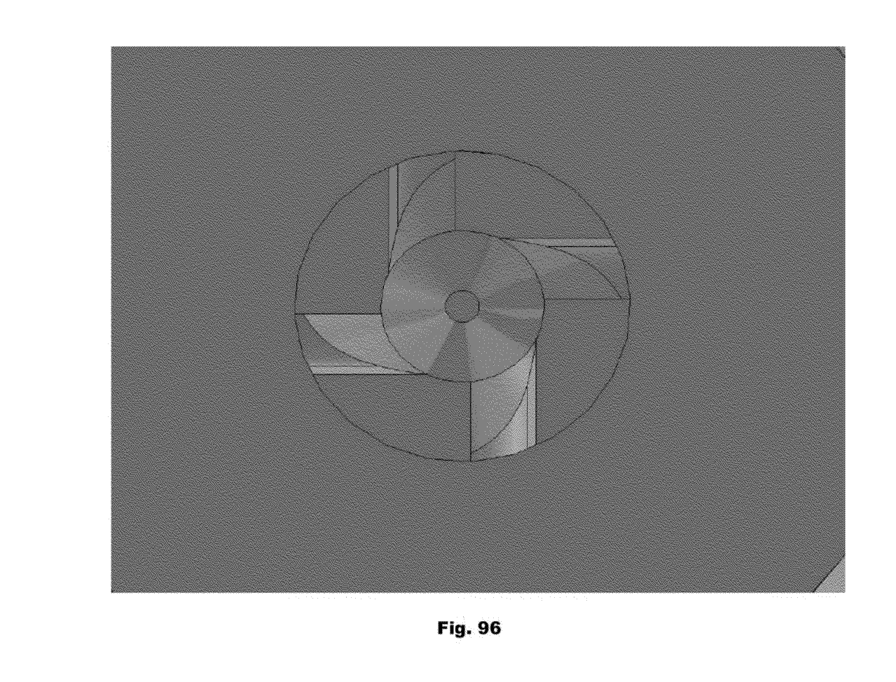

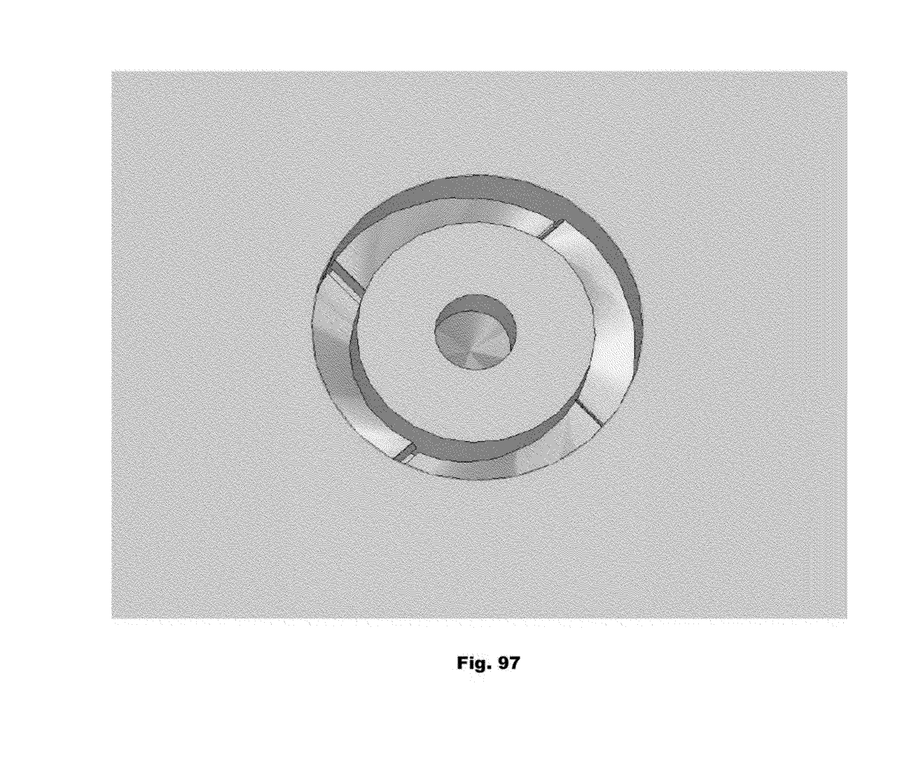

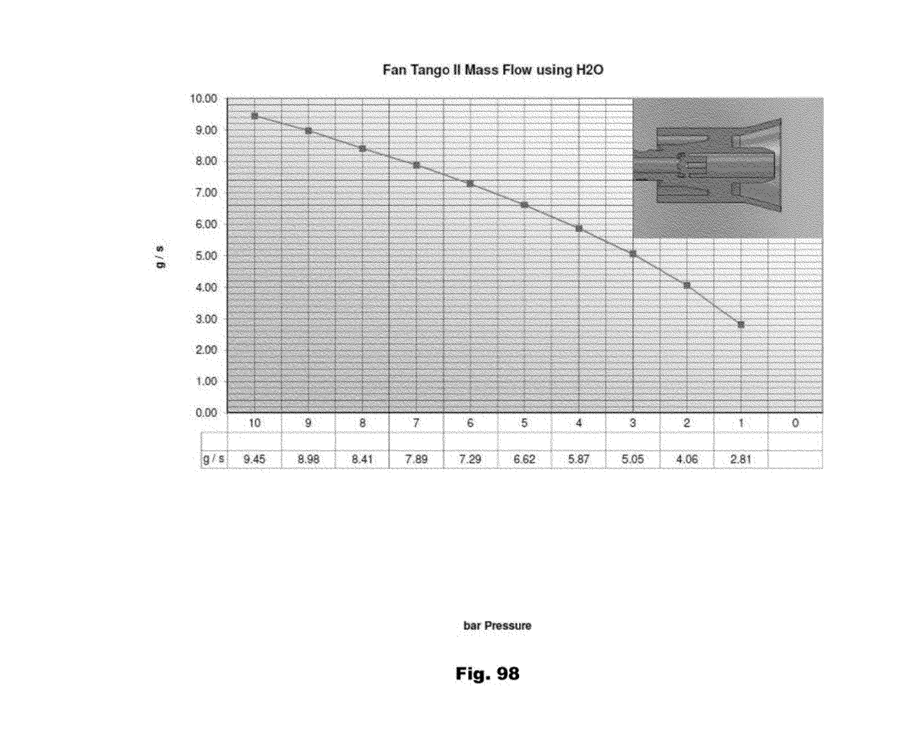

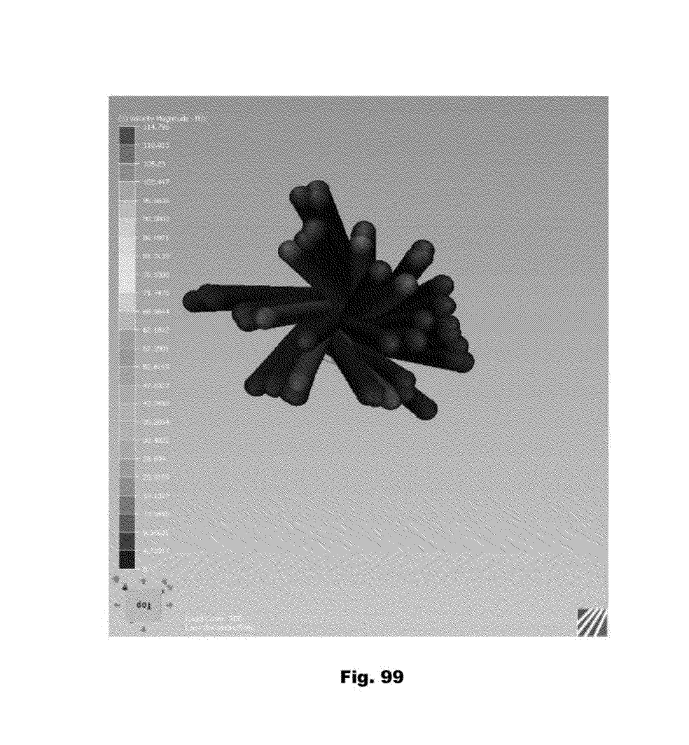

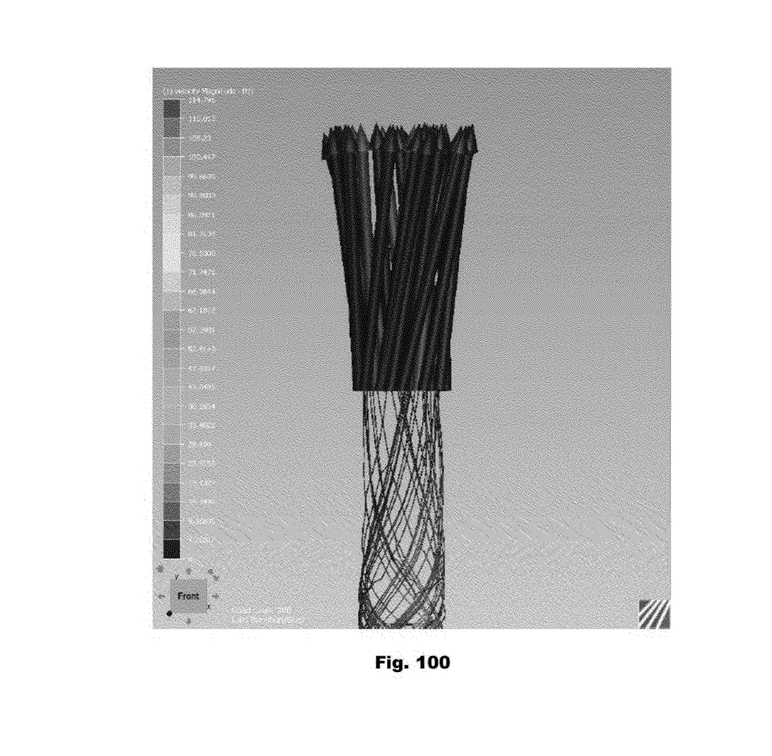

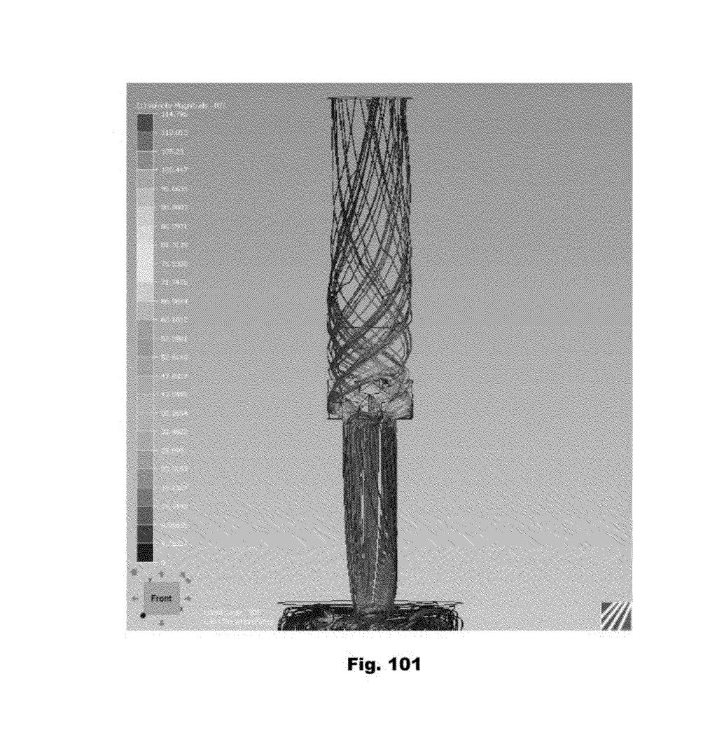

FIGS. 95 through 101 illustrate a still further exemplary embodiment of a vortex generating system according to the present disclosure.

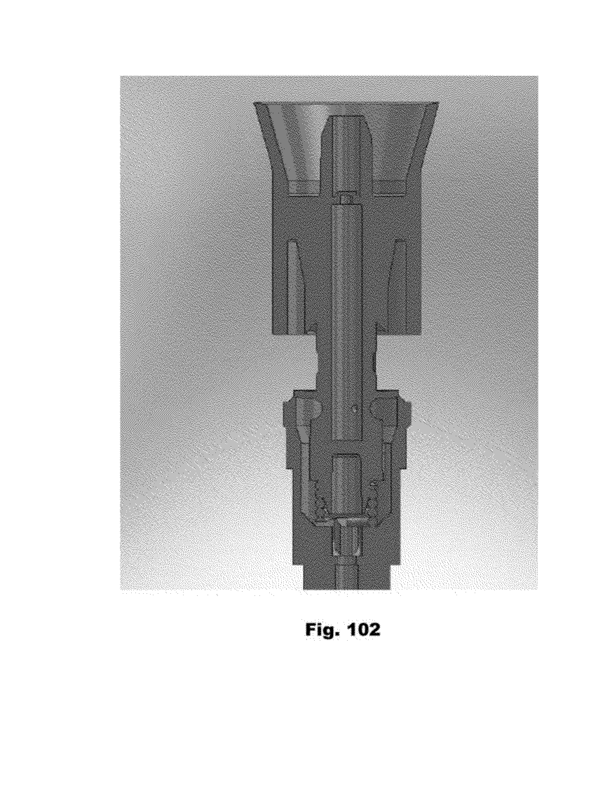

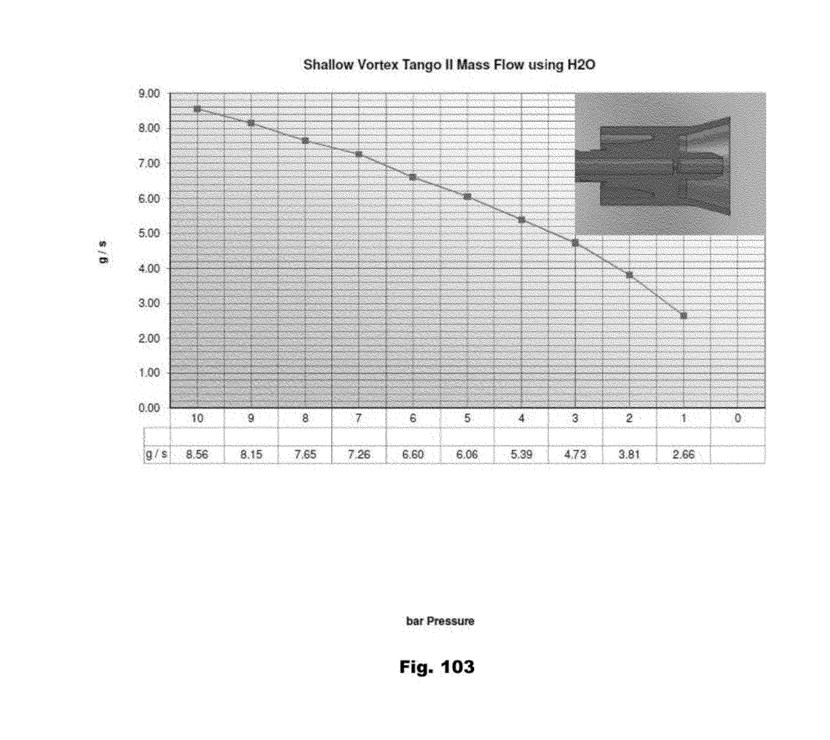

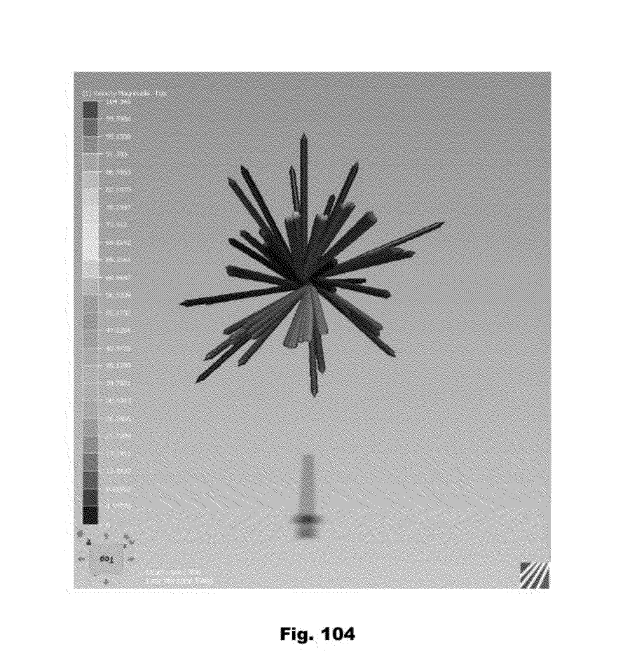

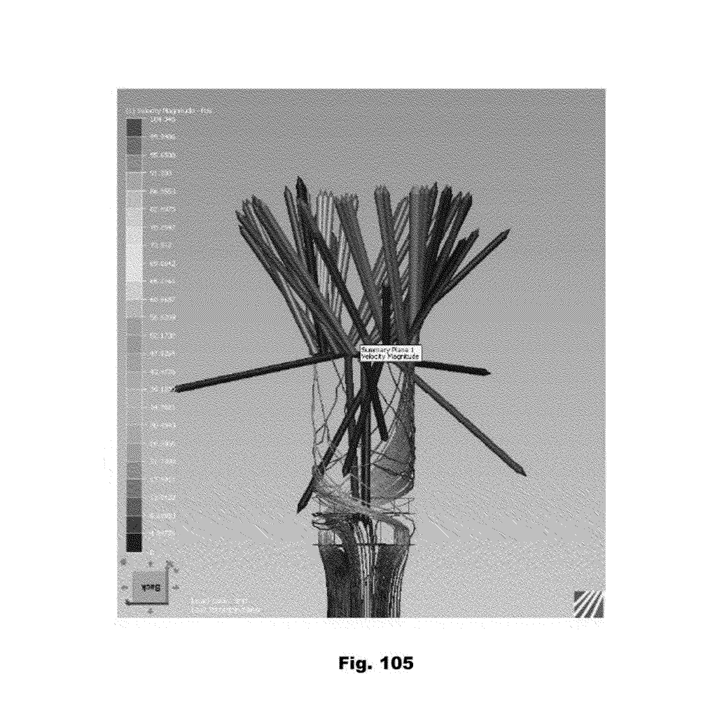

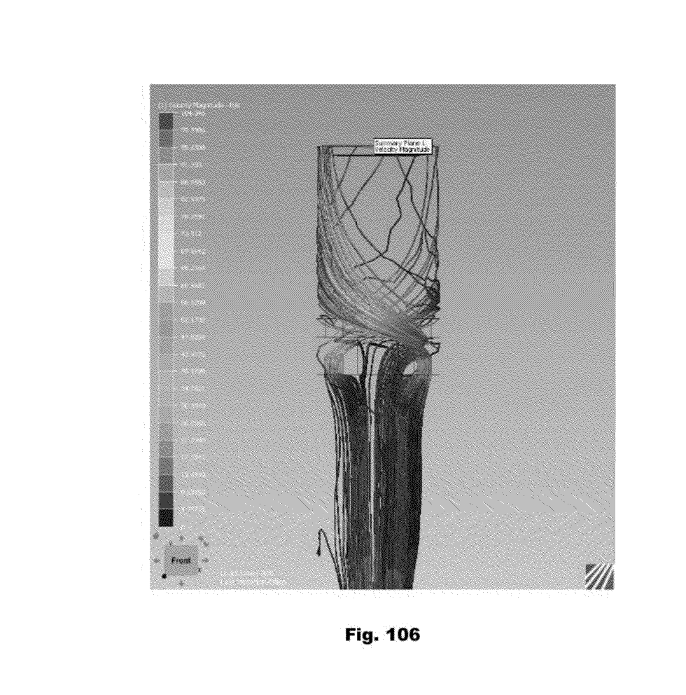

FIGS. 102 through 106 illustrate another further exemplary embodiment of a vortex generating system according to the present disclosure.

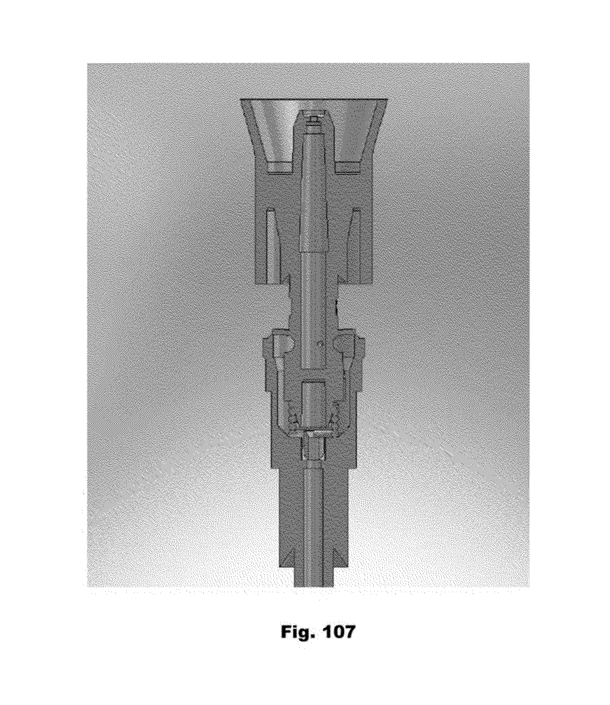

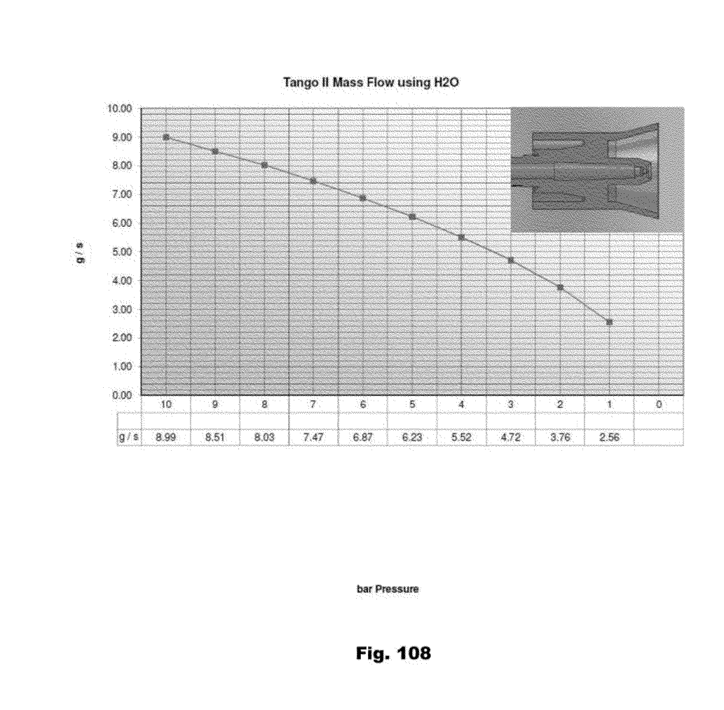

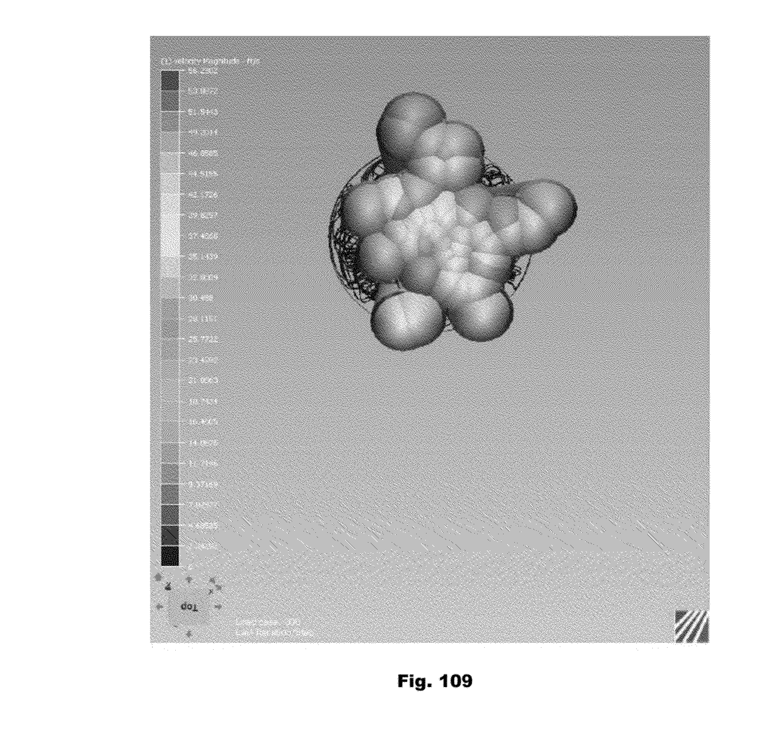

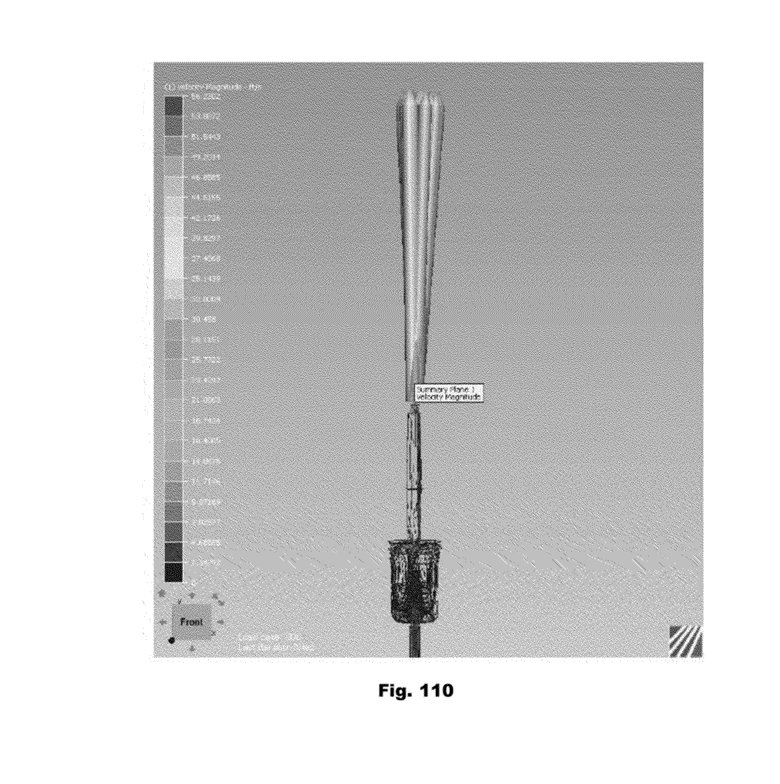

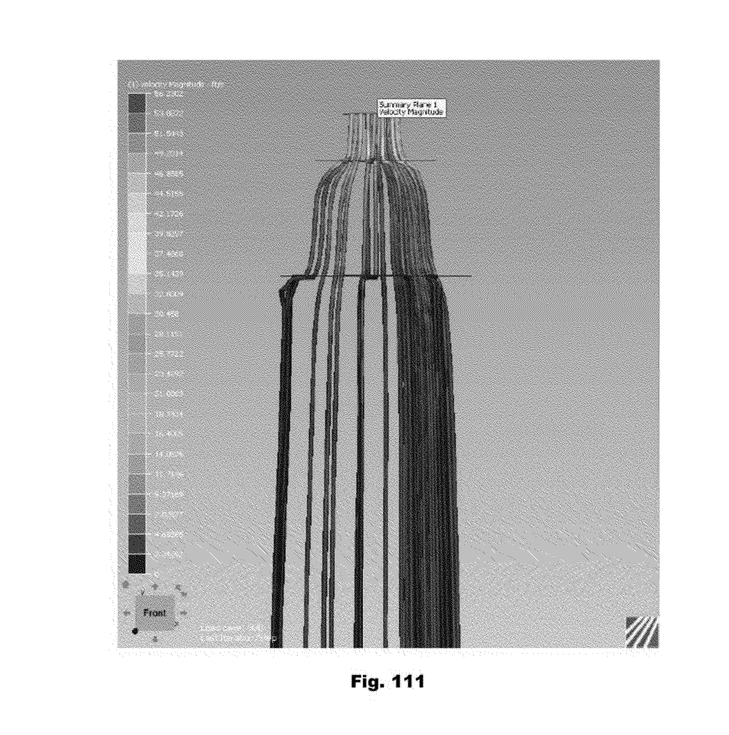

FIGS. 107 through 111 illustrate still another further exemplary embodiment of a vortex generating system according to the present disclosure.

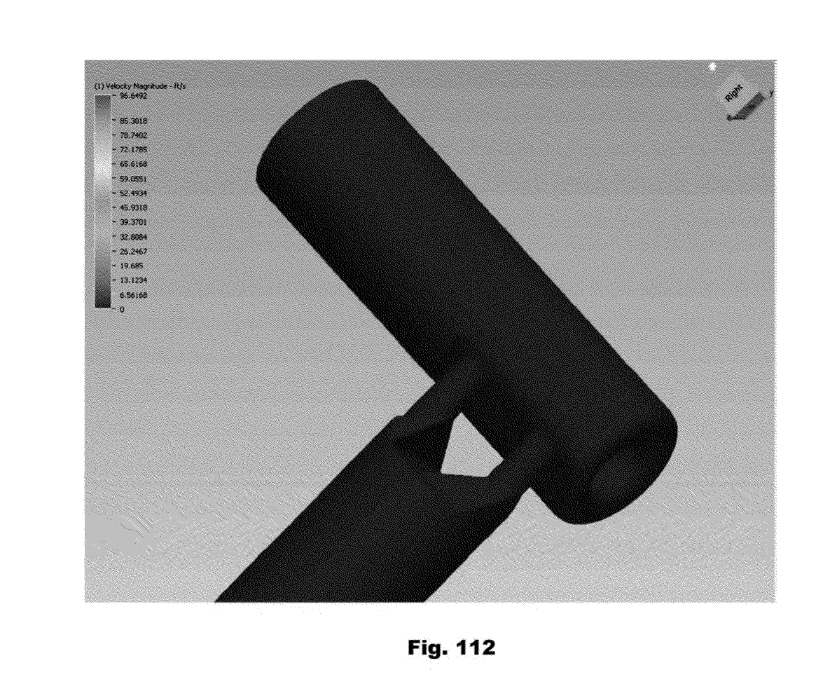

FIGS. 112 through 149 illustrate various embodiments of vortex creating geometric designs according to the present disclosure.

FIGS. 112 through 116 illustrate an exemplary embodiment of a vortex generating system according to the present disclosure. The system includes a discharge channel and a pair of inlet channels. The discharge channel is perpendicular to the pair of inlet channels and the inlet channels provide tangential feed of fluid into the discharge channel to generate the desired vortex and spray pattern.

The discharge channel includes a sump, which is the region of the discharge channel below the lowermost inlet channel. The discharge channel also includes a center guide post that extends the length of the discharge channel.

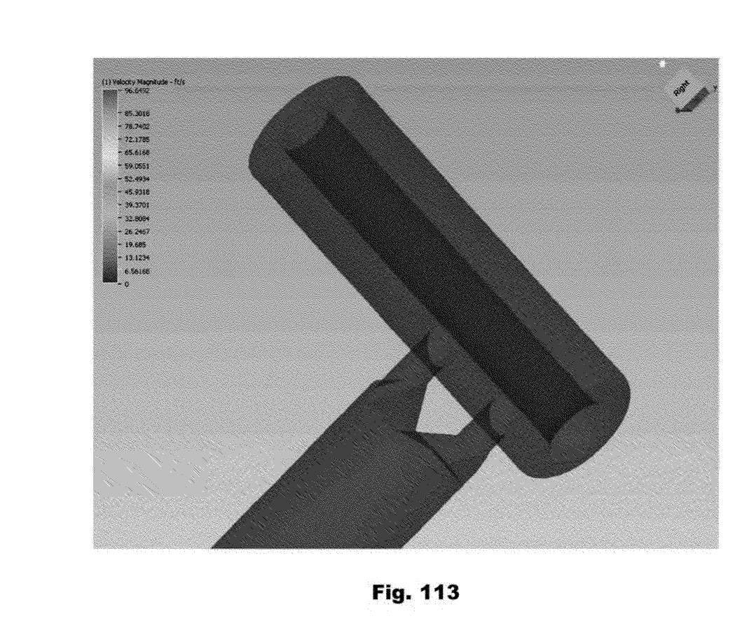

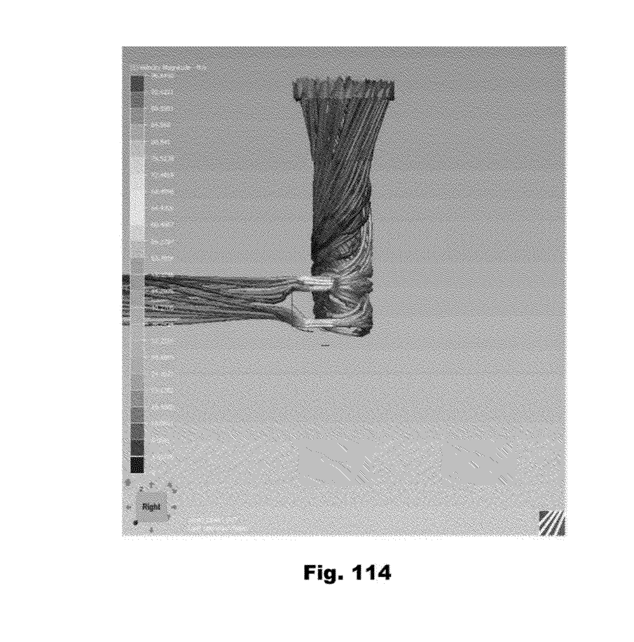

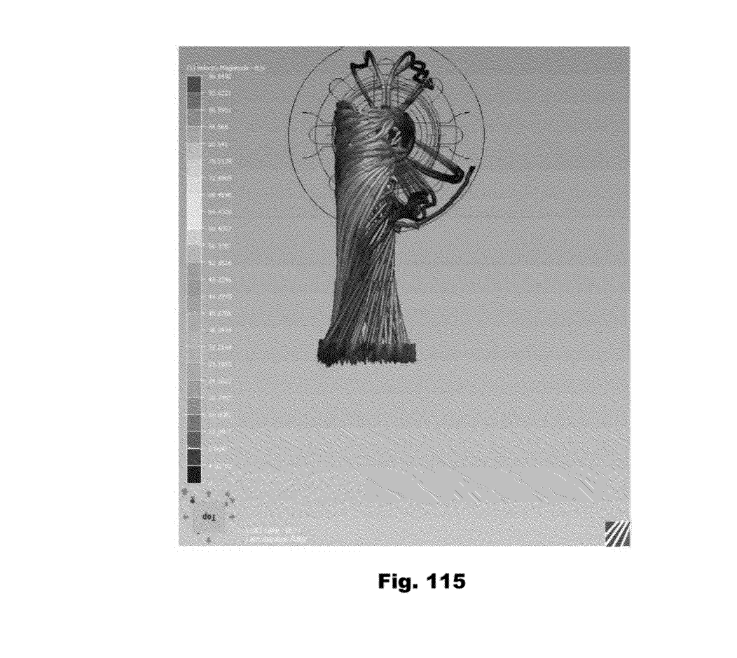

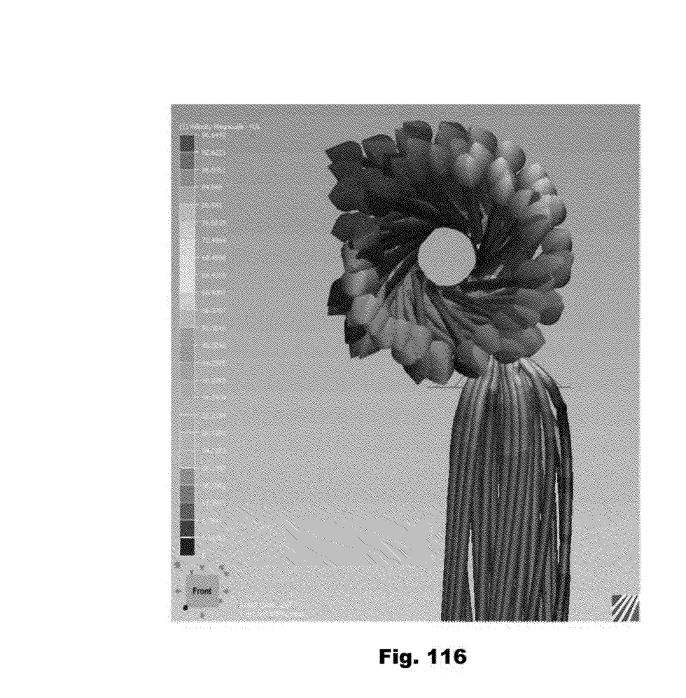

FIG. 112 illustrates the internal volume of a 2-hole horizontal with sump feature and an internal guide post in a CFD study. FIG. 113 illustrates a transparent isometric view of the 2-hole horizontal with sump feature and internal guide post of FIG. 112 in a CFD study. FIG. 114 illustrates a wire frame side view showing the flow of fluid of the 2-hole horizontal with sump feature and internal guide post of FIG. 112 in a CFD study. FIG. 115 illustrates a wire frame top view showing the flow of fluid of the 2-hole horizontal with sump feature and internal guide post of FIG. 112 in a CFD study. FIG. 116 illustrates a wire frame front view showing the flow of fluid of the 2-hole horizontal with sump feature and internal guide post of FIG. 112 in a CFD study.

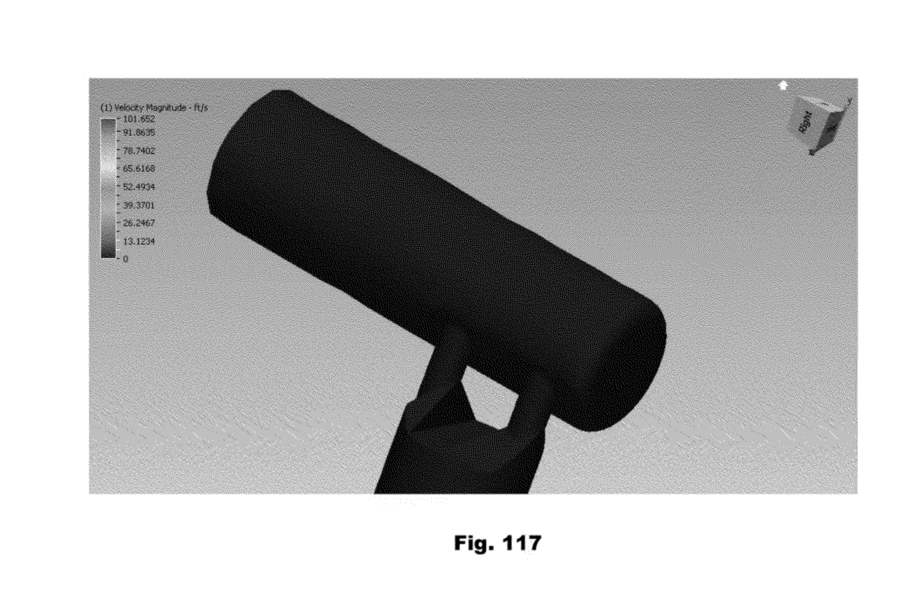

FIGS. 117 through 121 illustrate an alternate exemplary embodiment of a vortex generating system according to the present disclosure. Here, the vortex generating system is substantially similar to the embodiment discussed above with respect to FIGS. 112 through 116, but lacks the center guide post that extends the length of the discharge channel.

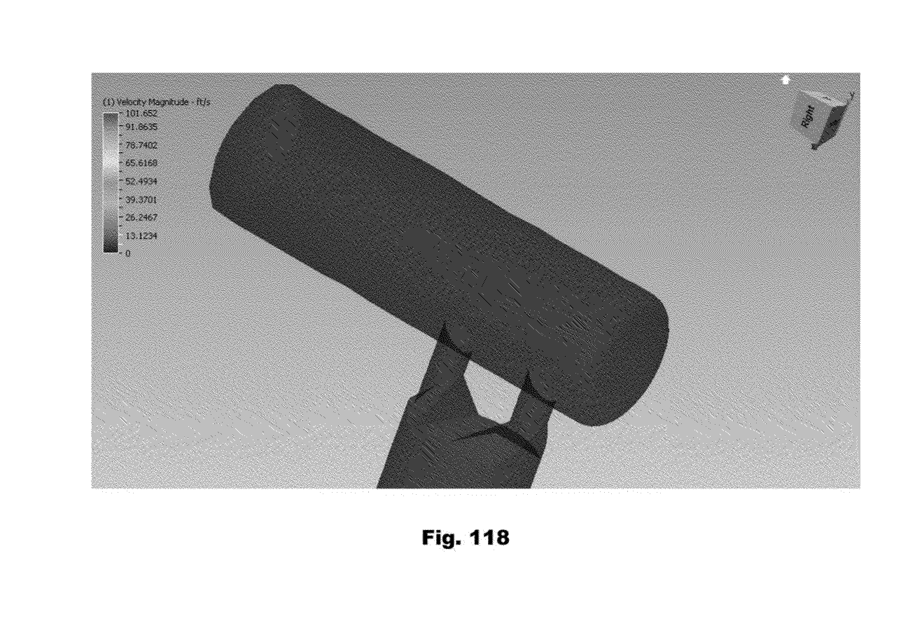

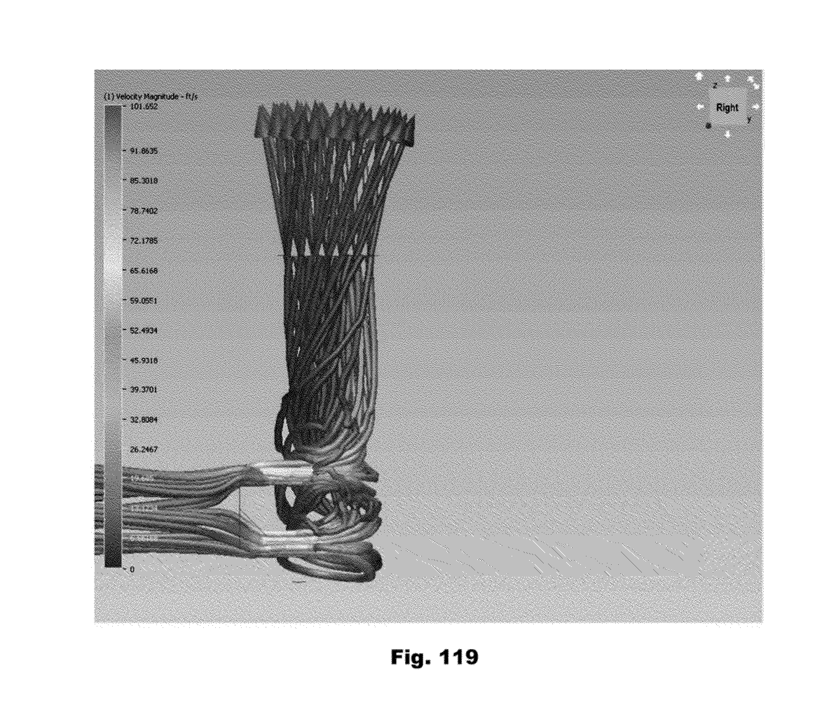

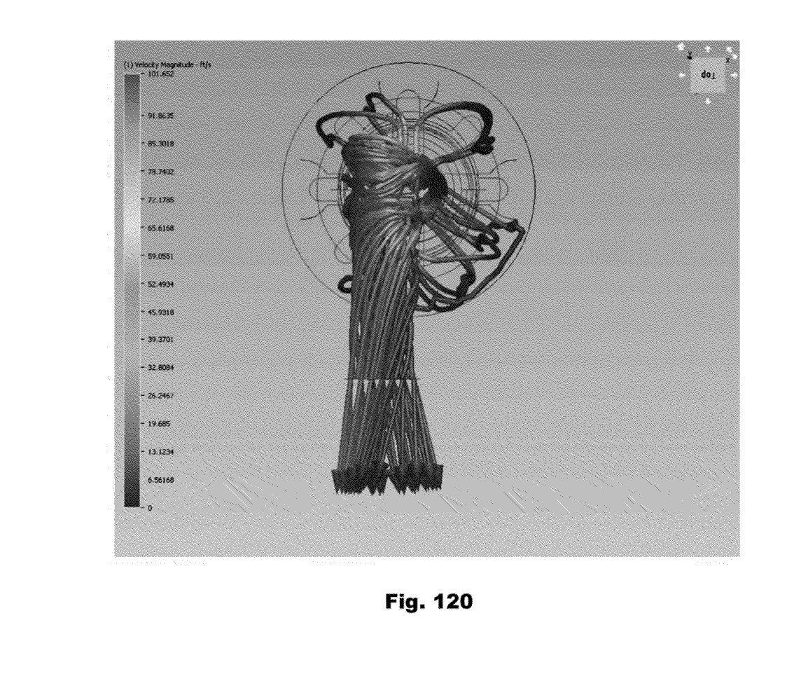

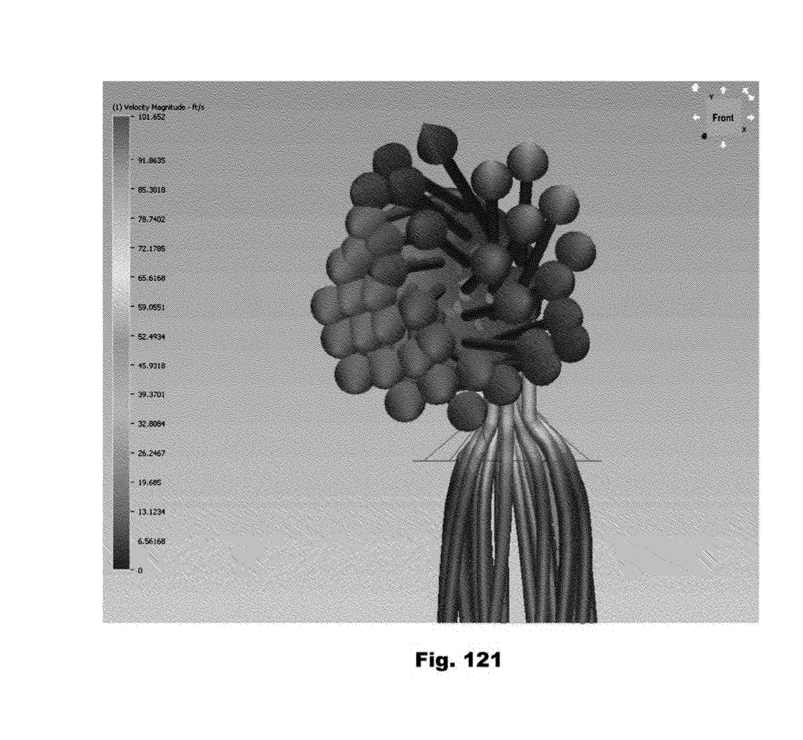

FIG. 117 illustrates the internal volume of the 2-hole horizontal with sump feature and no internal guide post in a CFD study. FIG. 118 illustrates a transparent isometric view of the 2-hole horizontal with sump feature and no internal guide post of FIG. 117 in a CFD study. FIG. 119 illustrates a wire frame side view showing the flow of fluid of the 2-hole horizontal with sump feature and no internal guide post of FIG. 117 in a CFD study. FIG. 120 illustrates a wire frame top view showing the flow of fluid of the 2-hole horizontal with sump feature and no internal guide post of FIG. 117 in a CFD study. FIG. 121 illustrates a wire frame front view showing the flow of fluid of the 2-hole horizontal with sump feature and no internal guide post of FIG. 117 in a CFD study.

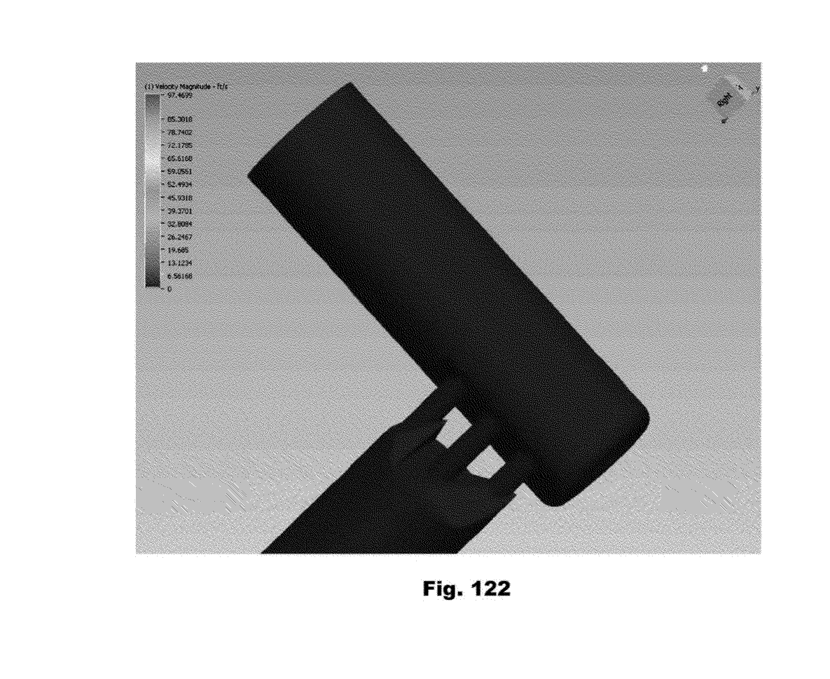

FIGS. 122 through 126 illustrate an alternate embodiment of a vortex generating system according to the present disclosure. The system again includes a discharge channel and an inlet. The discharge channel is perpendicular to an inlet. The inlet has three inlet channels that provide tangential feed of fluid into the discharge channel to generate the desired vortex and spray pattern. The discharge channel includes a sump, which is the region of the discharge channel below the lowermost inlet channel. The discharge channel also includes a center guide post that extends the length of the discharge channel.

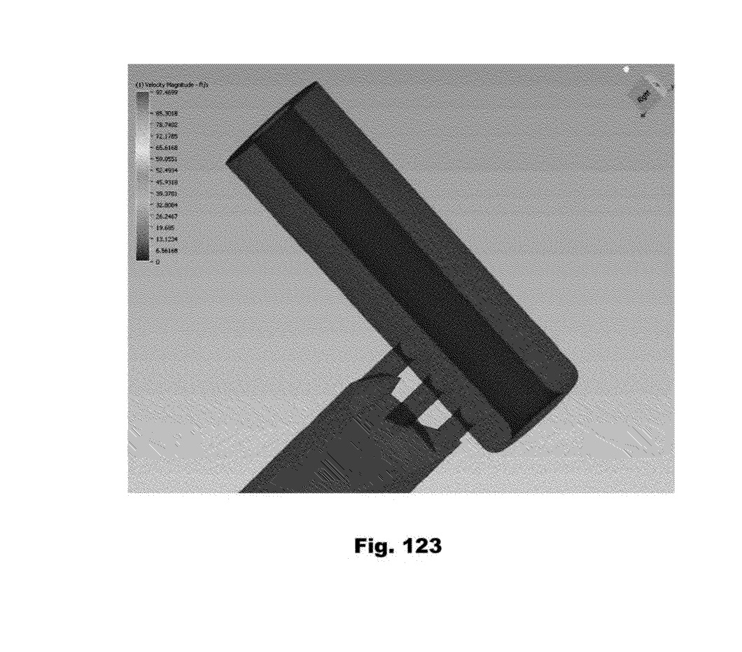

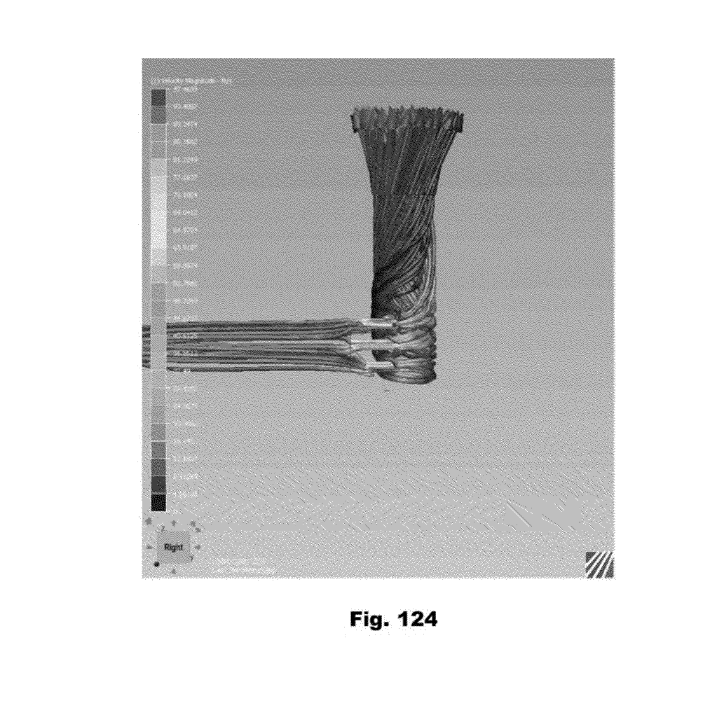

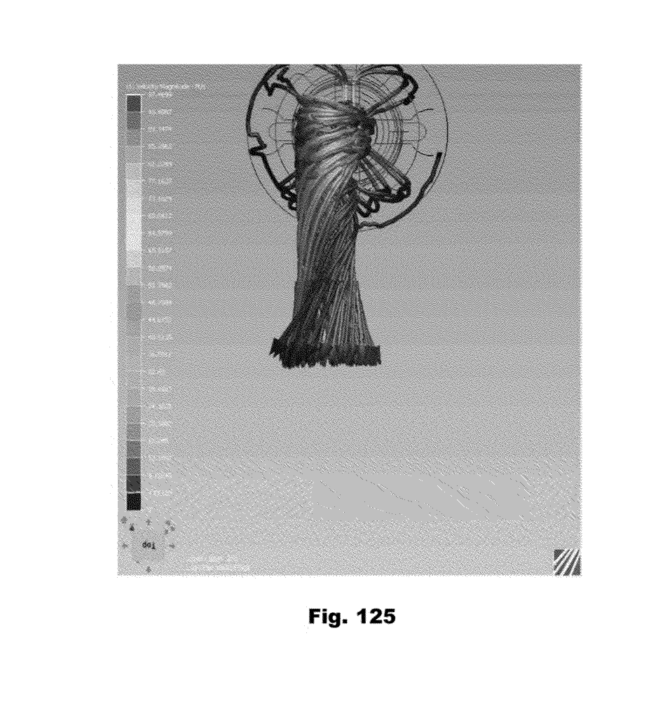

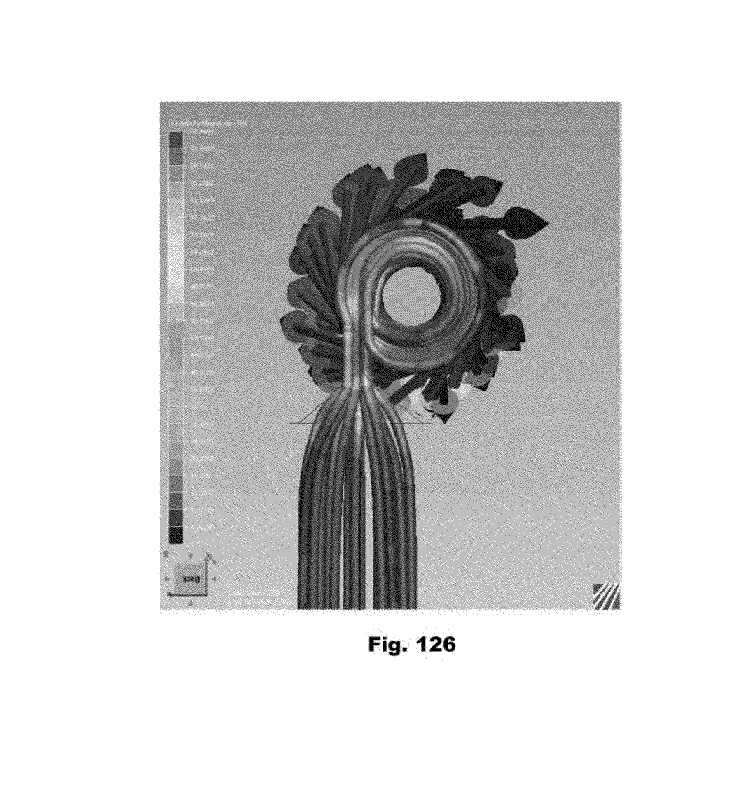

FIG. 122 illustrates the Internal volume of a 3-hole horizontal with sump feature with an internal guide post in a CFD study. FIG. 123 illustrates a transparent isometric view of the 3-hole horizontal with sump feature and internal guide post of FIG. 122 in a CFD study. FIG. 124 illustrates a wire frame side view showing the flow of fluid of the 3-hole horizontal with sump feature and internal guide post of FIG. 122 in a CFD study. FIG. 125 illustrates a wire frame top view showing the flow of fluid of the 3-hole horizontal with sump feature and internal guide post of FIG. 122 in a CFD study. FIG. 126 illustrates a wire frame back view showing the flow of fluid of the 3-hole horizontal with sump feature and internal guide post of FIG. 122 in a CFD study.

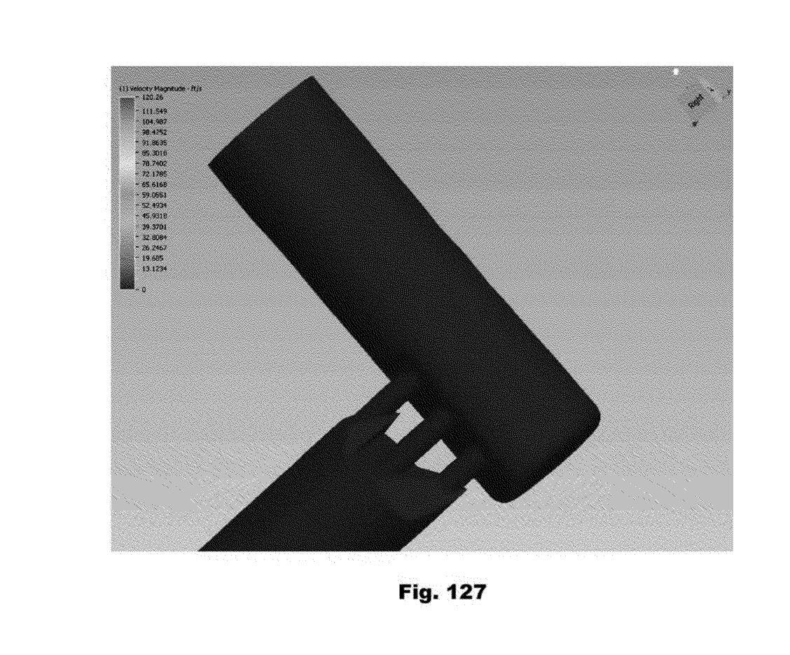

FIGS. 127 through 131 illustrate an alternate exemplary embodiment of a vortex generating system according to the present disclosure. Here, the vortex generating system is substantially similar to the embodiment discussed above with respect to FIGS. 122 through 126, but lacks the center guide post that extends the length of the discharge channel.

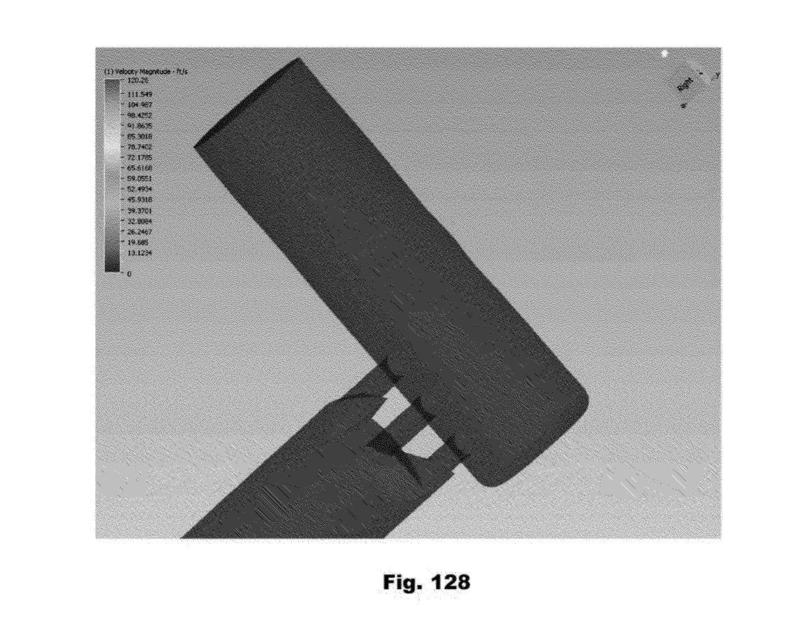

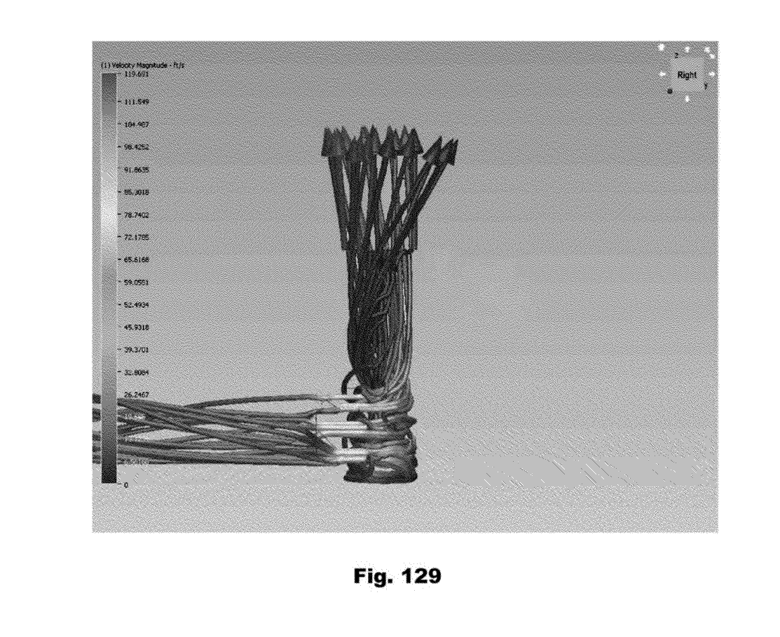

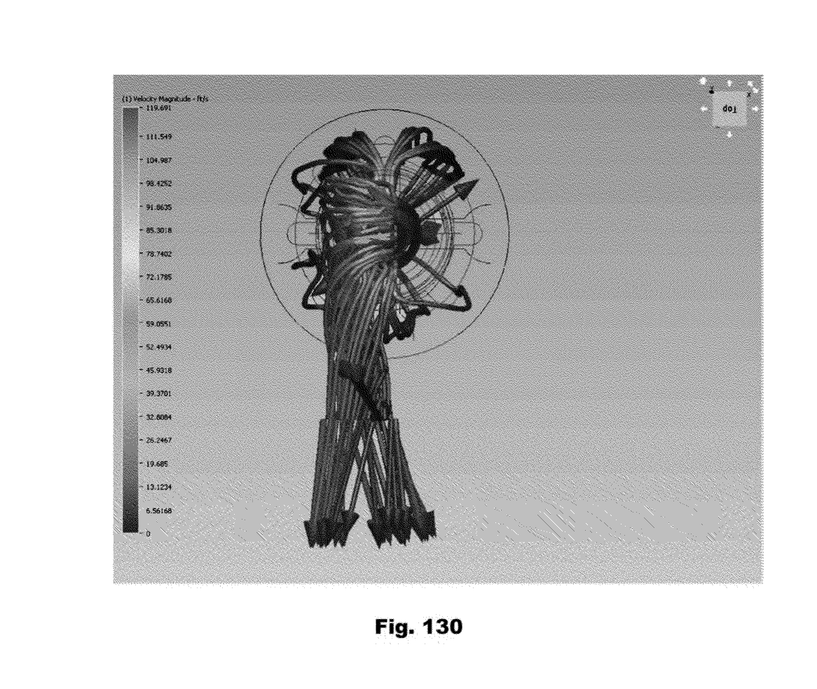

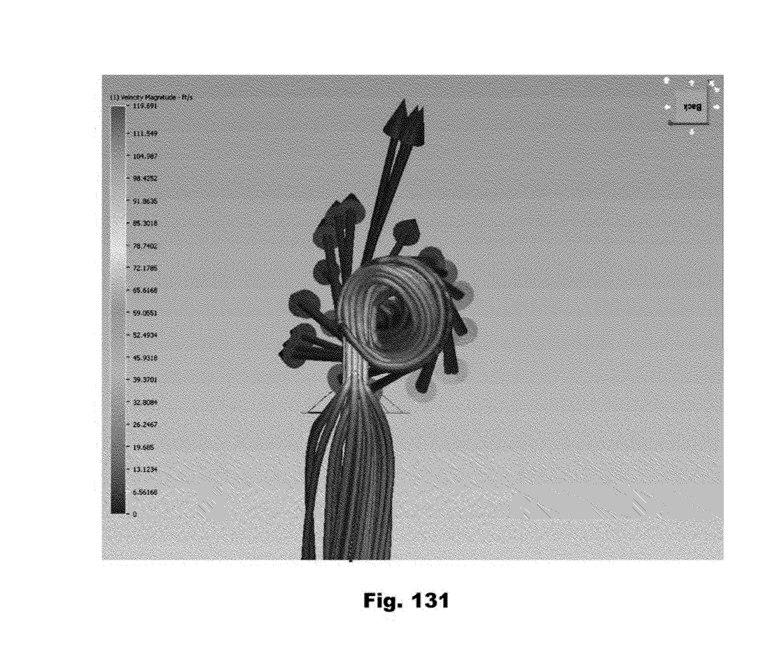

FIG. 127 illustrates the internal volume of a 3-hole horizontal with sump feature and no internal guide post in a CFD study. FIG. 128 illustrates a transparent isometric view of the 3-hole horizontal with sump feature and no internal guide post of FIG. 127 in a CFD study. FIG. 129 illustrates a wire frame side view showing the flow of fluid of the 3-hole horizontal with sump feature and no internal guide post of FIG. 127 in a CFD study. FIG. 130 illustrates a wire frame top view showing the flow of fluid of the 3-hole horizontal with sump feature and no internal guide post of FIG. 127 in a CFD study. FIG. 131 illustrates a wire frame back view showing the flow of fluid of the 3-hole horizontal with sump feature and no internal guide post of FIG. 127 in a CFD study.

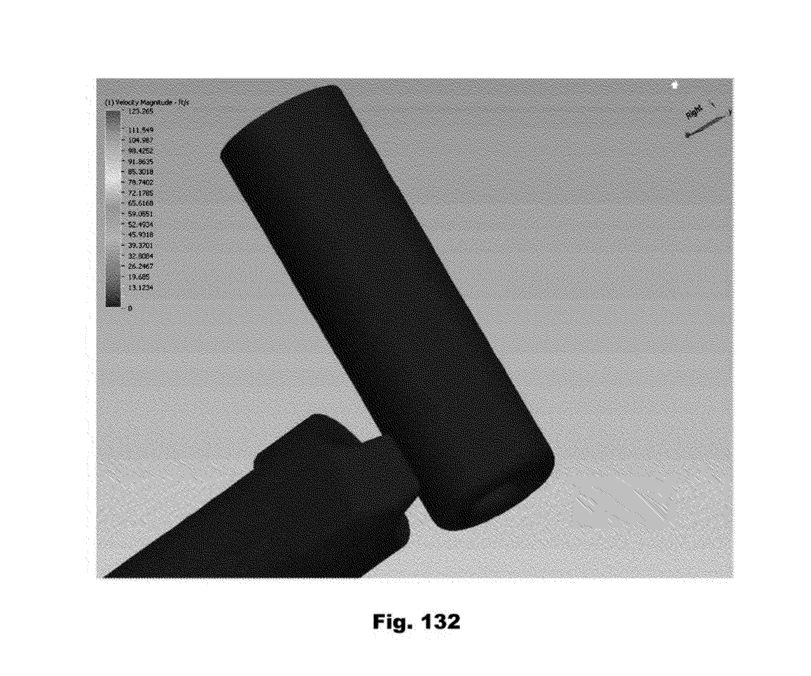

FIGS. 132 through 136 illustrate another alternate embodiment of a vortex generating system according to the present disclosure. System includes a discharge channel that is perpendicular to an inlet, where the inlet is an oval channel that provides tangential feed to generate the desired vortex and spray pattern. The discharge channel includes a sump, which is the region of the discharge channel below the oval inlet channel. The discharge channel also includes a center guide post that extends the length of the discharge channel.

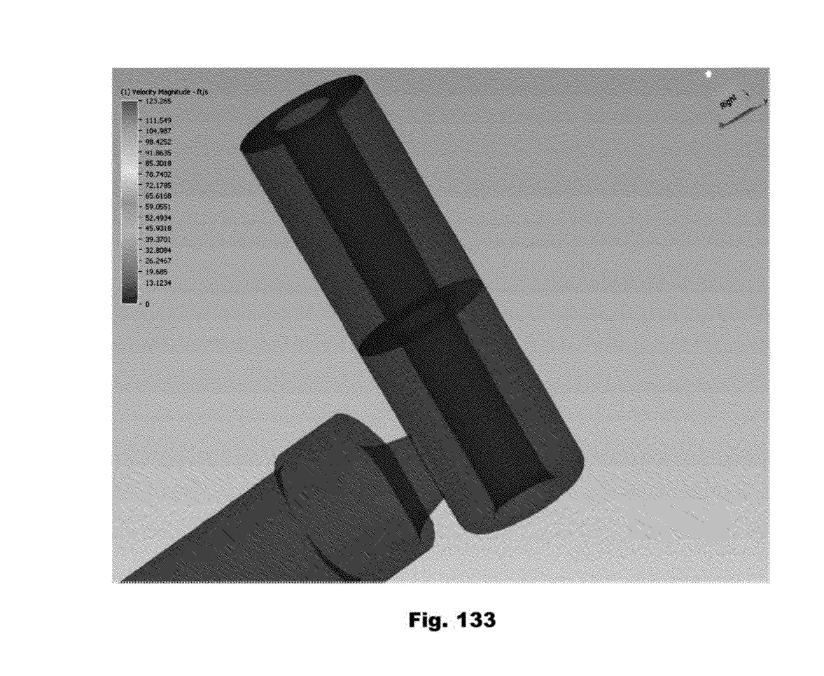

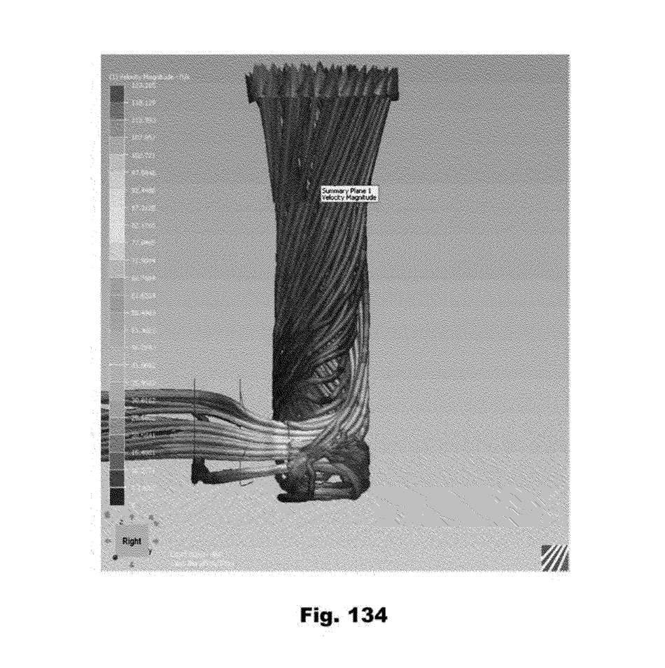

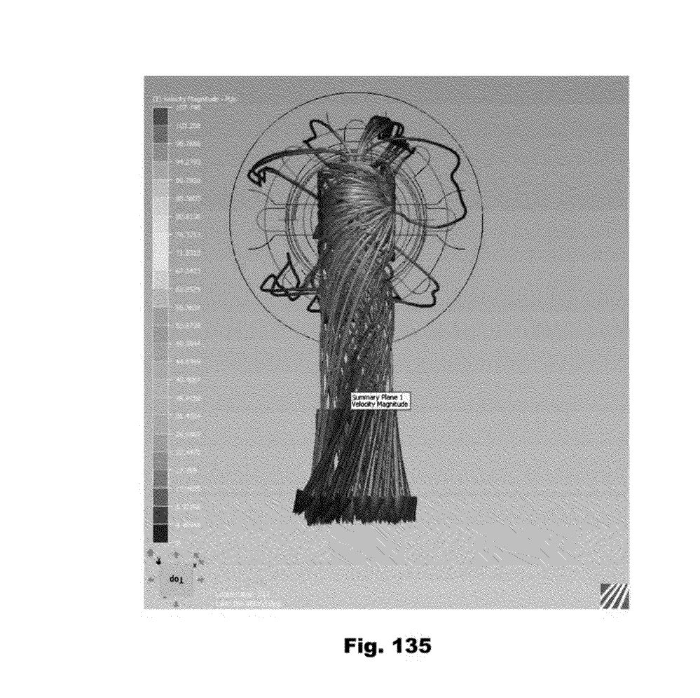

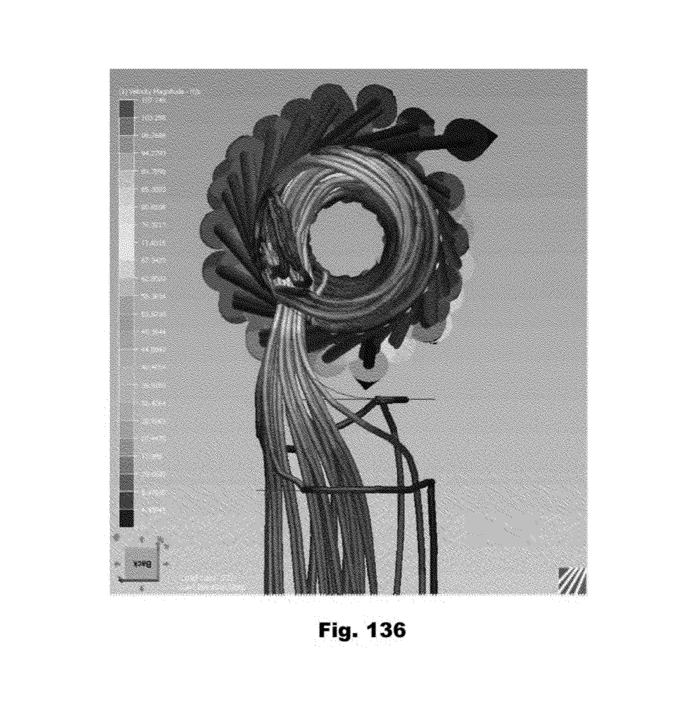

FIG. 132 illustrates the internal volume of an oval horizontal with sump feature in a CFD study. FIG. 133 illustrates the transparent isometric view of the oval horizontal with sump feature of FIG. 132 in a CFD study. FIG. 134 illustrates the wire frame side view showing the flow of fluid of the oval horizontal with sump feature of FIG. 132 in a CFD study. FIG. 135 illustrates the wire frame top view showing the flow of fluid of the oval horizontal with sump feature of FIG. 132 in a CFD study. FIG. 136 illustrates the wire frame back view showing the flow of fluid of the oval horizontal with sump feature of FIG. 132 in a CFD study.

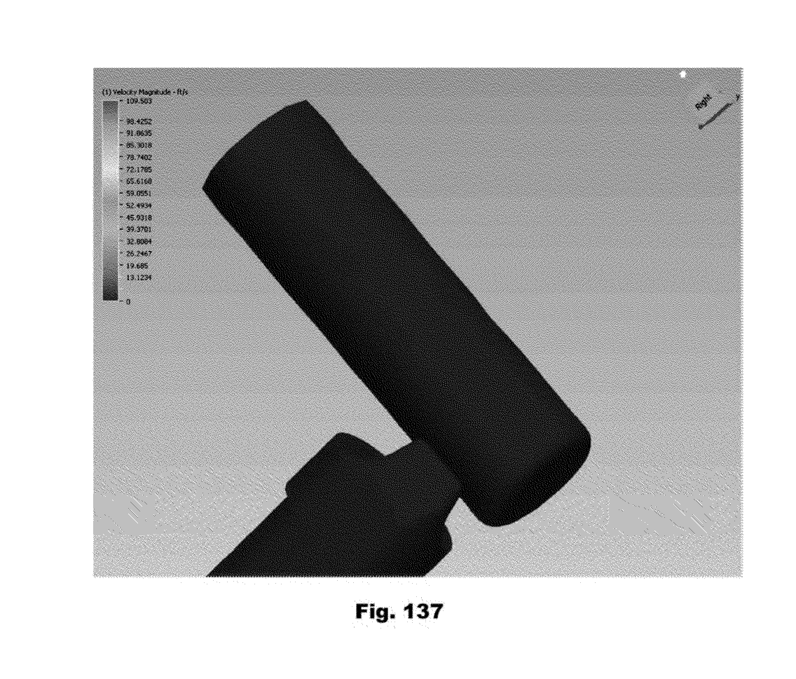

FIGS. 137 through 141 illustrate another alternate exemplary embodiment of a vortex generating system according to the present disclosure. Here, the vortex generating system is substantially similar to the embodiment discussed above with respect to FIGS. 132 through 136, but lacks the center guide post that extends the length of the discharge channel.

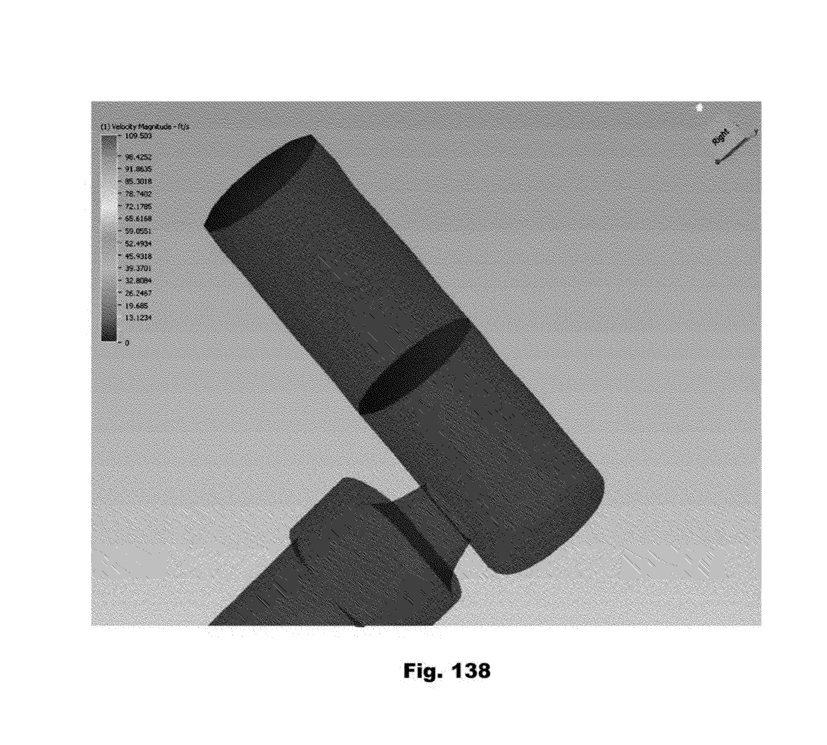

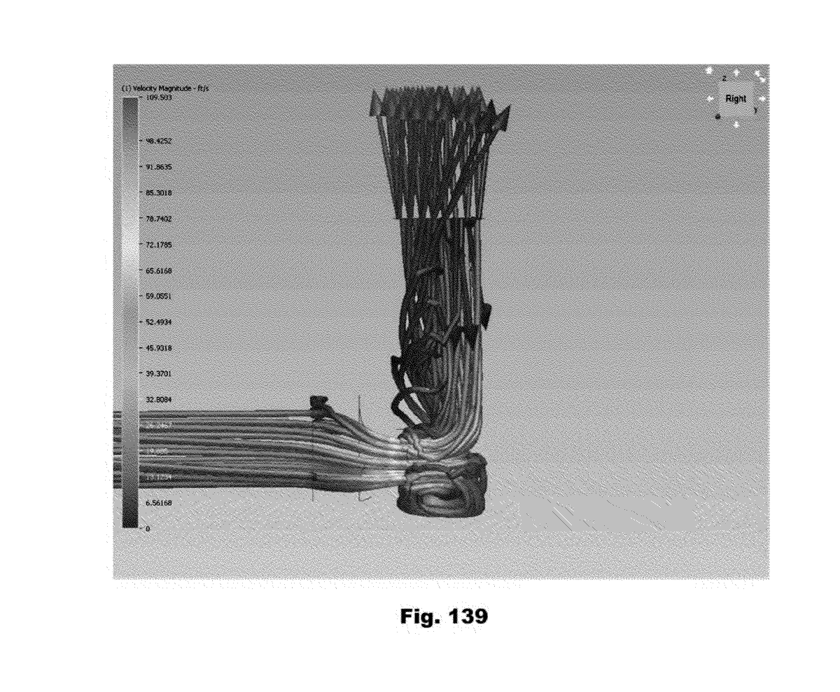

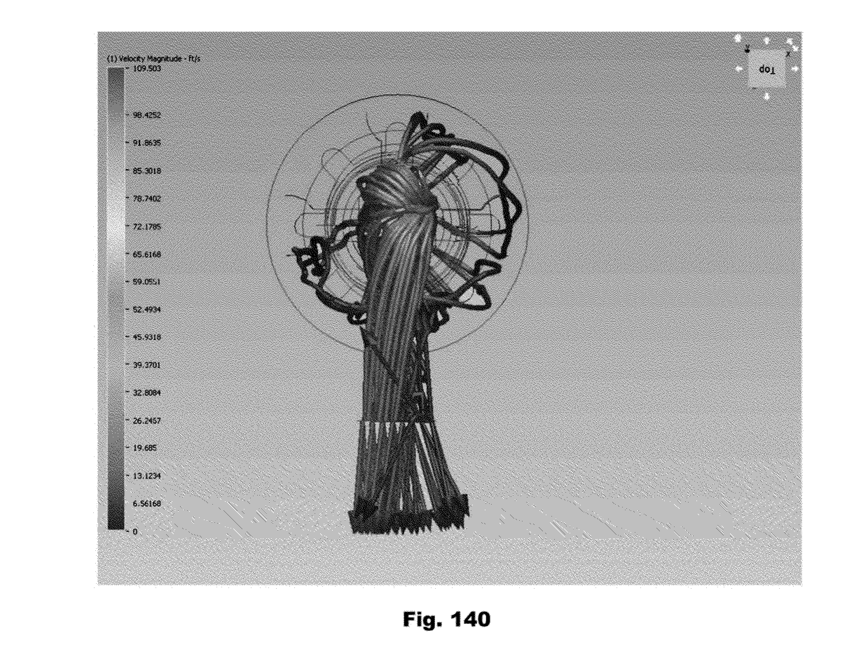

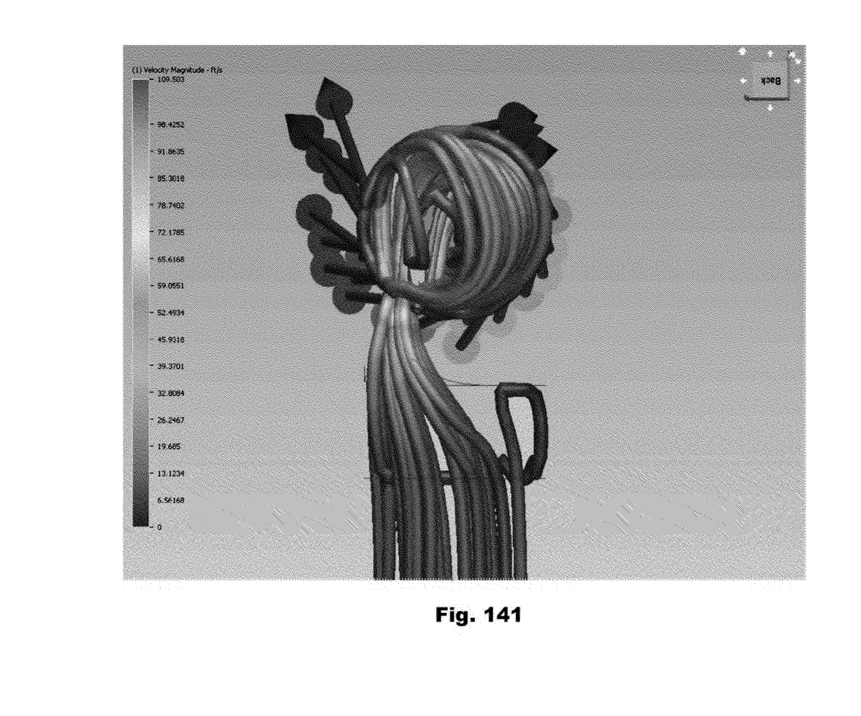

FIG. 137 illustrates the internal volume of an oval horizontal with sump feature and no center guide post in a CFD study. FIG. 138 illustrates a transparent isometric view of the oval horizontal with sump feature and no center guide post of FIG. 137 in a CFD study. FIG. 139 illustrates a wire frame side view showing the flow of fluid of the oval horizontal with sump feature and no center guide post of FIG. 137 in a CFD study. FIG. 140 illustrates a wire frame top view showing the flow of fluid of the oval horizontal with sump feature and no center guide post of FIG. 137 in a CFD study. FIG. 141 illustrates a wire frame back view showing the flow of fluid of the oval horizontal with sump feature and no center guide post of FIG. 137 in a CFD study.

It should be recognized that the vortex generating system according to the present disclosure has been disclosed by way of example only with respect to FIGS. 112 through 141 having the discharge channel and the inlet channel(s) perpendicular to one another. Of course, it is contemplated by the present disclosure for the discharge channel and the inlet channel(s) to be disposed with respect to one another at any desired angle as long as the inlet channel(s) tangentially introduces the fluid into the discharge channel to generate the desired vortex and spray pattern.

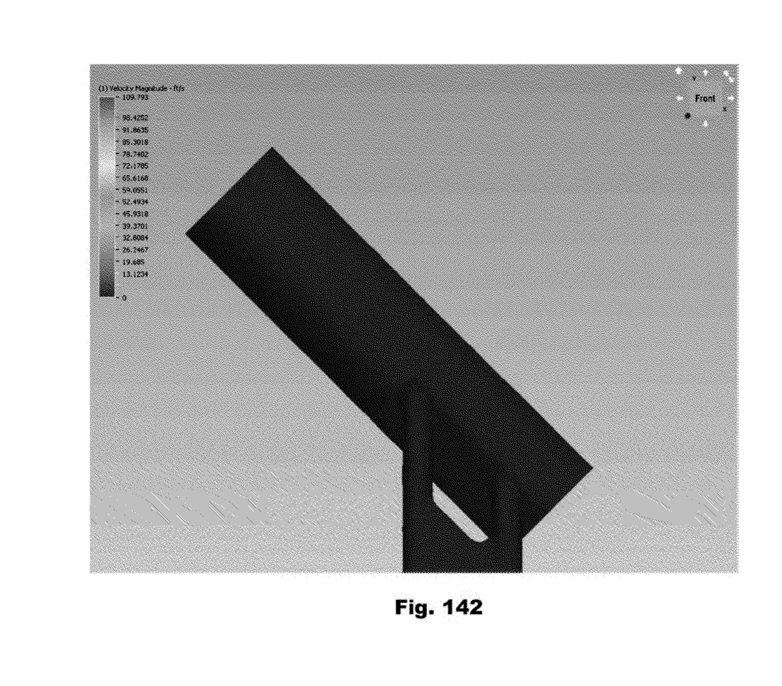

One example of an embodiment of a vortex generating system according to the present disclosure having the discharge channel and the inlet channel(s) angled with respect to one another is illustrated in FIGS. 142 through 145.

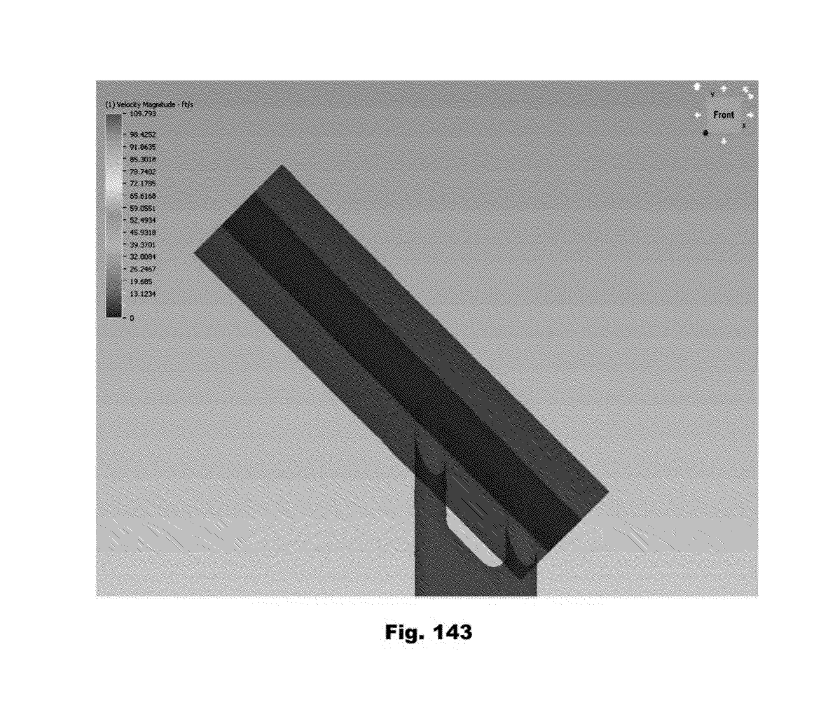

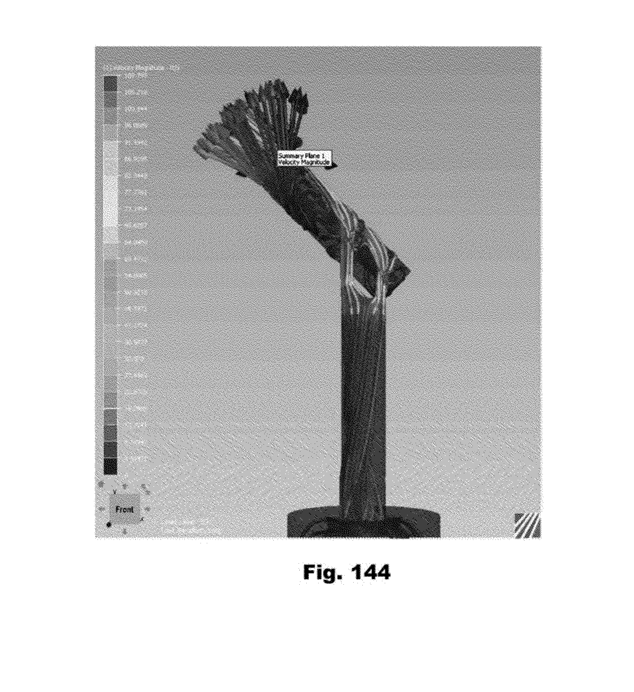

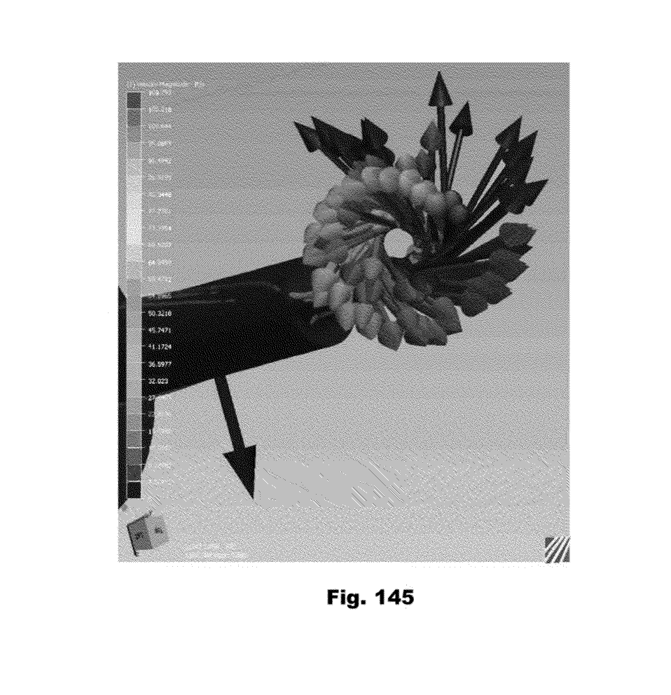

FIG. 142 illustrates the internal volume of a 2-hole 45-degree with sump feature in a CFD study. FIG. 143 illustrates a transparent view of the 2-hole 45-degree with sump feature of FIG. 142 in a CFD study. FIG. 144 illustrates a transparent side view showing the flow of fluid of the 2-hole 45-degree with sump feature of FIG. 142 in a CFD study. FIG. 145 illustrates a transparent front view showing the flow of fluid of the 2-hole 45-degree with sump feature of FIG. 142 in a CFD study.

In this embodiment, system includes a discharge channel and a pair of inlet channels that are angled with respect to the discharge channel by 45 degrees. The inlet channels provide tangential feed to generate the desired vortex and spray pattern. The discharge channel includes a sump, which is the region of the discharge channel below the lowermost inlet channel. The discharge channel also includes a center guide post that extends the length of the discharge channel.

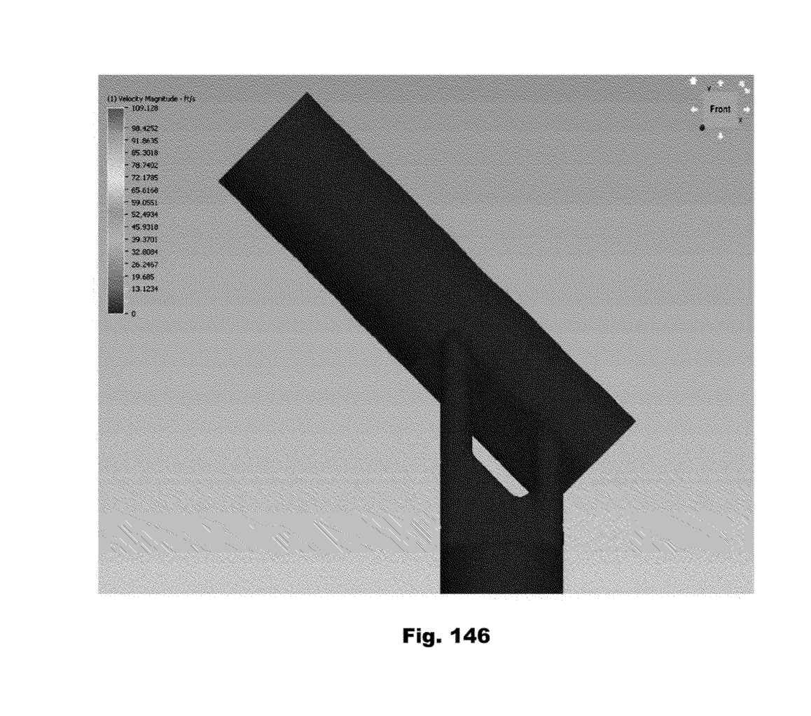

FIGS. 146 through 149 illustrate an alternate exemplary embodiment of a vortex generating system according to the present disclosure. Here, the vortex generating system is substantially similar to the embodiment discussed above with respect to FIGS. 142 through 145, but lacks the center guide post that extends the length of the discharge channel.

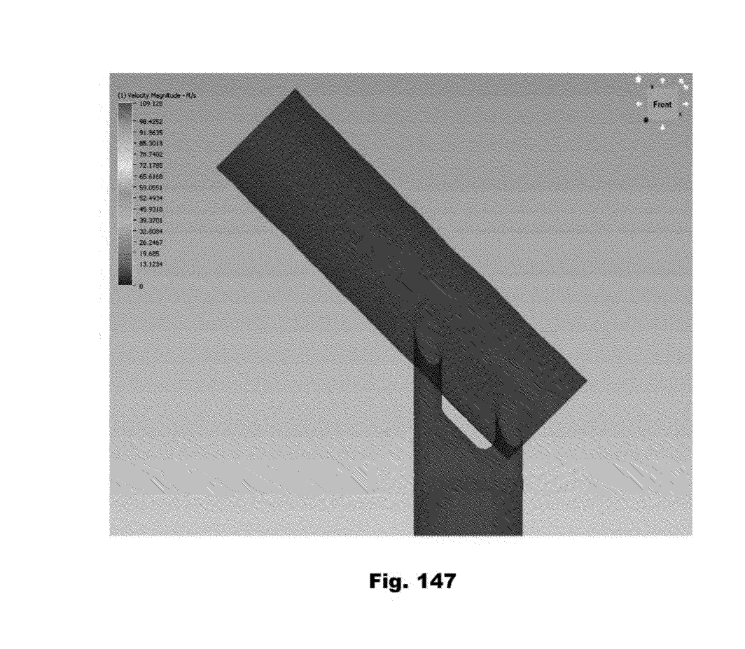

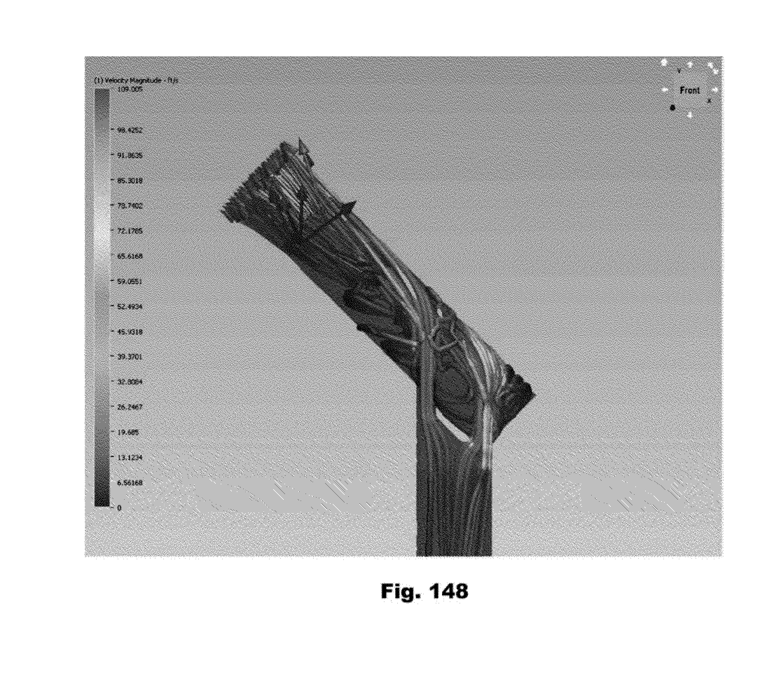

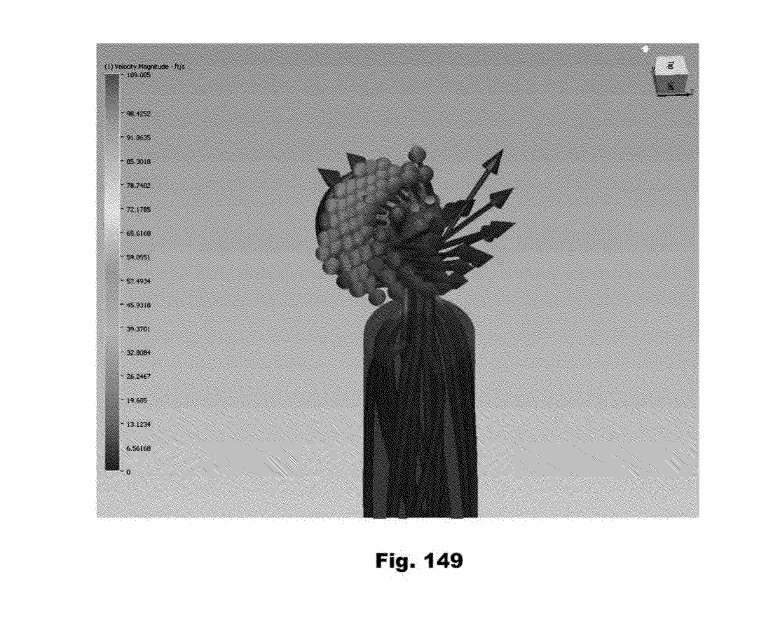

FIG. 146 illustrates the internal volume of a 2-hole 45-degree with sump feature and no center guide post in a CFD study. FIG. 147 illustrates a transparent view of the 2-hole 45-degree with sump feature and no center guide post of FIG. 146 in a CFD study. FIG. 148 illustrates a transparent side view showing the flow of fluid of the 2-hole 45-degree with sump feature and no center guide post of FIG. 146 in a CFD study. FIG. 149 illustrates a transparent front view showing the flow of fluid of the 2-hole 45-degree with sump feature and no center guide post of FIG. 146 in a CFD study.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A vortex spray generating system comprising a discharge channel and at least one inlet channel, wherein the discharge channel and the at least one inlet channel are disposed with respect to one another such that the at least one inlet channel is capable of providing a tangential feed of fluid into the discharge channel sufficient to generate a vortex and spray pattern.

2. The vortex spray generating system of claim 1 comprising: a discharge channel and two inlet channels, wherein the discharge channel and the two inlet channels are disposed with respect to one another such that the two inlet channels are each capable of providing a tangential feed of fluid into the discharge channel sufficient to generate a vortex and spray pattern; a discharge channel and three inlet channels, wherein the discharge channel and the three inlet channels are disposed with respect to one another such that the three inlet channels are each capable of providing a tangential feed of fluid into the discharge channel sufficient to generate a vortex and spray pattern; or a discharge channel and an oval inlet channel, wherein the discharge channel and the oval inlet channel are disposed with respect to one another such that the oval inlet channel is capable of providing a tangential feed of fluid into the discharge channel sufficient to generate a vortex and spray pattern.

3. The vortex spray generating system of claim 1 wherein the discharge channel includes a sump.

4. The vortex spray generating system of claim 3 wherein the sump comprises a region of the discharge channel that is below the lowermost portion of the at least one inlet channel.

5. The vortex spray generating system of claim 1 wherein the discharge channel includes a center guide post that extends the length of the discharge channel.

6. The vortex spray generating system of claim 1 wherein the discharge channel is linear, linear and extended, curved, or curved and extended.

7. The vortex spray generating system of claim 1 wherein the at least one inlet channel is disposed such that it is perpendicular to the discharge channel or angled with respect to the discharge channel.

8. The vortex spray generating system of claim 2 wherein the two inlet channels are disposed such that they are perpendicular to the discharge channel or angled with respect to the discharge channel, or a combination thereof; or wherein the three inlet channels are disposed such that they are perpendicular to the discharge channel or angled with respect to the discharge channel, or a combination thereof; or wherein the one oval inlet channel is disposed such that it is perpendicular to the discharge channel or angled with respect to the discharge channel, or a combination thereof.

9. The vortex spray generating system of claim 1 wherein the at least one inlet channel is disposed such that it is angled with respect to the discharge channel by from about 15° to about 75°, or that it is angled with respect to the discharge channel by from about 30° to about 60°, or that it is angled with respect to the discharge channel by about 45°.

10. The vortex spray generating system of claim 2 wherein the two inlet channels are disposed at offset opposing locations with respect to the discharge channel; or the three inlet channels are disposed at offset opposing locations with respect to the discharge channel.

11. The vortex spray generating system of claim 1 for use in a spray actuator in conjunction with a pressurized aerosol can or valve, a mist or trigger pump, and/or a pressurized sprayer.

12. An apparatus for dispensing a fluid in the form of a spray, said apparatus comprising a discharge channel and at least one inlet channel, wherein the discharge channel and the at least one inlet channel are disposed with respect to one another such that the at least one inlet channel is capable of providing a tangential feed of fluid into the discharge channel sufficient to generate a vortex and spray pattern.

13. A method of generating a vortex in a pressurized fluid so as to deliver the pressurized fluid as a spray, said method comprising:
providing a vortex spray generating apparatus comprising a discharge channel and at least one inlet channel, wherein the at least one inlet channel is disposed such that it is perpendicular to the discharge channel or angled with respect to the discharge channel; and
introducing a tangential feed of fluid through the at least one inlet channel into the discharge channel sufficient to generate a vortex and spray pattern.

14. The method of claim 13 in which the vortex spray apparatus comprises: a discharge channel and two inlet channels, wherein the discharge channel and the two inlet channels are disposed with respect to one another such that the two inlet channels are each capable of providing a tangential feed of fluid into the discharge channel sufficient to generate a vortex and spray pattern; a discharge channel and three inlet channels, wherein the discharge channel and the three inlet channels are disposed with respect to one another such that the three inlet channels are each capable of providing a tangential feed of fluid into the discharge channel sufficient to generate a vortex and spray pattern; or a discharge channel and an oval inlet channel, wherein the discharge channel and the oval inlet channel are disposed with respect to one another such that the oval inlet channel is capable of providing a tangential feed of fluid into the discharge channel sufficient to generate a vortex and spray pattern.

15. The method of claim 13 wherein the discharge channel includes a sump.

16. The method of claim 15 wherein the sump comprises a region of the discharge channel that is below the lowermost portion of the at least one inlet channel.

17. The method of claim 13 wherein the discharge channel includes a center guide post that extends the length of the discharge channel.

18. The method of claim 13 wherein the discharge channel is linear, linear and extended, curved, or curved and extended.

19. The method of claim 13 wherein the at least one inlet channel is disposed such that it is perpendicular to the discharge channel or angled with respect to the discharge channel.

20. The method of claim 14 wherein the two inlet channels are disposed such that they are perpendicular to the discharge channel or angled with respect to the discharge channel, or a combination thereof; or wherein the three inlet channels are disposed such that they are perpendicular to the discharge channel or angled with respect to the discharge channel, or a combination thereof; or wherein the one oval inlet channel is disposed such that it is perpendicular to the discharge channel or angled with respect to the discharge channel, or a combination thereof.

21. The method of claim 13 wherein the at least one inlet channel is disposed such that it is angled with respect to the discharge channel by from about 15° to about 75°, or that it is angled with respect to the discharge channel by from about 30° to about 60°, or that it is angled with respect to the discharge channel by about 45°.

22. The method of claim 14 wherein the two inlet channels are disposed at offset opposing locations with respect to the discharge channel; or the three inlet channels are disposed at offset opposing locations with respect to the discharge channel.
